(19) United States
(12) Patent Application Publication
(10) Pub. No.: US 2010/0039792 A1
(43) Pub. Date: Feb. 18, 2010

(54) Battery Powered Lighting Appliance

(76) Inventors: Thomas I. Meyers, Cayuga, NY (US); Ronald J. Kingston, Syracuse, NY (US); Scott W. Osiecki, Skaneateles, NY (US); Chik Hueng Kwok, Shatin (HK); Richard A. Hudson, Bell, FL (US); David A. Furth, Skaneateles, NY (US); Craig G. Meyer, Fenton, MO (US); David Baggaley, Gainesville, FL (US); Peter F. Hoffman, Avon, OH (US)

Correspondence Address: MICHAEL C. POPHAL;EVEREADY BATTERY COMPANY INC, 25225 DETROIT ROAD, P O BOX 450777, WESTLAKE, OH, 44145, US

(21) Appl. No.: 12/227,725

(22) PCT Filed: May 31, 2007
(86) PCT No.: PCT/US2007/070072

§ 371 Date: Sep. 3, 2009

Related U.S. Application Data
(60) Provisional application No. 60/803,761, filed on Jun. 2, 2006.
(60) Provisional application No. 60/940,279, filed on May 25, 2007.

(30) Foreign Application Priority Data
Jan. 30, 2007 (US) PCT/US2007/061285

(51) Int. Cl. F21V 19/04

(52) U.S. Cl. 362/20; 362/183; 362/253

(57) ABSTRACT

A lighting apparatus includes a first electrical contact (5212) that receives power and a second electrical contact (5304) that provides access to the received external power. An electrical contact support component (5210) is used to configure the orientation of the first electrical contact (5212) with respect to the second electrical contact (5304) and connect the first electrical contact and the second electrical contact. A portable lighting appliance receiving region (5310) receives and provides power to a received portable lighting appliance (5206). An interface (5226) receives an input indicative of a first operation of the received portable lighting device (5206) when the power is available and a second operation of a received portable lighting device (5206) when the power is unavailable.

### BACKGROUND

The present application relates generally to a lighting appliance having a battery powered light. While it finds particular application to floor, desk, lamp, under cabinet, sconce, pendant, and portable lighting appliances having battery powered lighting, it also contemplates other lighting appliances having battery powered lighting.

Lighting appliances that produce ambient lighting can be found in homes, offices and the like to provide everyday lighting. For instance, a ceiling light has been provided in the kitchen to provide ambient lighting during the day, for example, to supplement sunlight, if needed, and especially at night so that humans can see where they are going and what they are doing.

Unfortunately, some lighting appliances are dependent upon power from an alternating current (AC) power source such that when AC power is unavailable, the lighting appliance is unable to produce light. For instance, a floor lamp has included a light that is powered by power received through an electrical connection between the floor lamp and an AC electrical receptacle. When AC power is unavailable, the light of the floor lamp cannot be turned on. As a consequence, the user may be left without light at night during a power outage.

Such lighting appliances have often been semi-fixed or fixed at a location. For example, although the floor lamp noted above may be moved from one location to another, it needs to be close enough to an AC electrical receptacle so that it can be plugged into the AC electrical receptacle to receive power. In addition, when it is moved from one location to another location, it is unplugged and thus does not receive AC power for illuminating the light. In another example, the ceiling light noted above has been fixed in place in that it has been electrically tied into the main power line. As a consequence, such lighting appliances generally are inflexible in that they are geared towards particular applications.

### BRIEF DESCRIPTION OF THE DRAWINGS

The present invention is illustrated by way of example and not limitation in the figures of the accompanying drawings, in which like references indicate similar elements and in which:

FIG. 1A is a perspective view of a first desk lamp.

FIG. 1B depicts operating controls for a desk lamp.

FIG. 2A is a perspective view of a second desk lamp.

FIG. 2B is a cutaway view of the base of a second desk lamp.

FIGS. 3A and 3B show a perspective view of a first table lamp.

FIG. 4A is a perspective view of a second table lamp.

FIG. 4B is a perspective view of a second table lamp.

FIG. 4C is a cutaway perspective view of the base of a second table lamp.

FIG. 5A is a perspective view of a floor lamp.

FIG. 5B is a perspective view of a floor lamp.

FIG. 5C is a cutaway perspective view of the base of a floor lamp.

FIG. 6 is a perspective view showing a lamp having a battery-powered backup lighting device.

FIG. 7A is a perspective view of an under counter appliance including backup power capability.

FIG. 7B is a perspective view of a hand held light.

FIG. 7C is a perspective view showing a battery receiving region.

FIG. 8 is an electrical block diagram of a lamp.

FIG. 9 is an electrical block diagram of a lamp.

FIG. 10A is a perspective view of a battery cartridge.

FIG. 10B is a sectional view of a battery cartridge along direction indicated in FIG. 10A.

FIG. 11 is a perspective view of a lamp which accepts a battery cartridge.

FIG. 12 is an electrical block diagram of a lamp and a battery cartridge.

FIG. 13 is an electrical block diagram of a lamp and a battery cartridge.

FIGS. 14A and 14B are perspective views of a wall adapter having battery backup capability.

FIG. 15 is an electrical block diagram of a wall adapter.

FIGS. 16A, 16B, 16C, and 16D depict a battery powered lighting apparatus.

FIG. 17 is a block diagram of a hybrid battery powered electrical appliance.

FIG. 18 depicts a desk lamp.

FIG. 19 is an exploded view of a portion of a desk lamp.

FIG. 20 depicts a portion of a desk lamp.

FIGS. 21A and 21B depict portable appliances.

FIGS. 22 and 24 depict a fixed appliance.

FIGS. 23A, 23B, and 23C depict a portable appliance.

FIG. 25 is a block diagram of a hybrid battery powered electrical appliance.

FIGS. 26-31 illustrate a family of appliances.

FIGS. 32-34B illustrate alarm clock appliances.

FIGS. 35-37 illustrates sconce lights.

FIGS. 38A and 38B illustrate a motion light.

FIGS. 39-41 illustrate nightlights.

FIGS. 42-46 illustrate bedside lights.

FIGS. 47-49 illustrate pendant lights.

FIGS. 50A and 50B illustrate a light appliance.

FIG. 51 illustrates a portable appliance.

FIGS. 52, 53 and 54 illustrate a lighting appliance.

FIGS. 55A and 55B illustrate an electrical mapping for a lighting appliance.

FIG. 56 illustrates a schematic block diagram of a lighting appliance.

FIGS. 57A and 57B illustrate an implementation of a lighting appliance.

FIG. 58 illustrates a schematic block diagram of a lighting appliance.

FIGS. 59A and 59B illustrate an implementation of a lighting appliance.

FIG. 60 illustrates a schematic block diagram of a lighting appliance.

FIGS. 61A and 61B illustrate an implementation of a lighting appliance.

FIG. 62 illustrates a schematic block diagram of a lighting appliance.

FIGS. 63A and 63B illustrate an implementation of a lighting appliance.

FIG. 64 illustrates an implementation of a lighting appliance.

FIGS. 65 and 66 illustrate lighting appliances.

### SUMMARY

Aspects of the present application address these matters, and others.

In one aspect, a lighting apparatus includes a first electrical contact that receives power and a second electrical contact that provides access to the received external power. An electrical contact support component is used to configure the orientation of the first electrical contact with respect to the second electrical contact and connect the first electrical contact and the second electrical contact. A portable lighting appliance receiving region receives and provides power to a received portable lighting appliance. An interface receives an input indicative of a first operation of the received portable lighting device when the power is available and a second operation of a received portable lighting device when the power is unavailable.

In another aspect, a method includes receiving power from an external power source, providing access to the received external power to an external device, wherein the orientation of a first contact used to receive the external power is configurable with respect to the external power source, using the received power to charge and power a portable lighting appliance, operating a light source of the portable lighting apparatus using the external power, and using power local to the portable lighting apparatus to operate the light source when the external power becomes unavailable.

In another aspect, a lighting apparatus includes an external power interface, an environmental sensor, an output interface, and an interface/control that receives an input indicative of a first mode of operation of the lighting appliance in which external power is conveyed from the external power interface to a portable lighting appliance via the output interface based on the state of the environment. The lighting appliance includes an input interface, a local power source, a light source, and a mode selection control that receives an input indicative of a mode of operation of the light source.

In another aspect, a lighting apparatus includes an external power interface, a lighting appliance includes a base and a portable lighting appliance. The base includes an external power interface, an output interface, and an interface/control for selecting a mode of operation. External power is conveyed from the external power interface to a portable lighting appliance via the output interface based on the mode of operation. The portable lighting appliance includes an input interface, a local power source, a light source, and a mode selection control that receives an input indicative of a mode of operation of the light source, wherein the light source is supplied with external power when the portable lighting appliance is engaged with the base.

In another aspect, a lighting apparatus includes an input interface for receiving external power from a charger, a local power source, a light source, and an environmental sensor. The light source is illuminated with power from the local power source based on a state of the environment.

In another aspect, a lighting apparatus includes a external power interface, a power source, a light source, and a plurality of output interfaces for receiving a plurality of portable lighting appliances. External power is provided to the plurality of portable lighting appliances via the plurality of output interfaces when the external power is available. Power from the local power source illuminates the light source when the external power is unavailable. The portable lighting appliance includes an input interface, a local power source, a light source, and a mode selection control that receives an input indicative of a mode of operation of the light source.

Those skilled in the art will recognize still other aspects of the present application upon reading and understanding the attached description.

### DETAILED DESCRIPTION

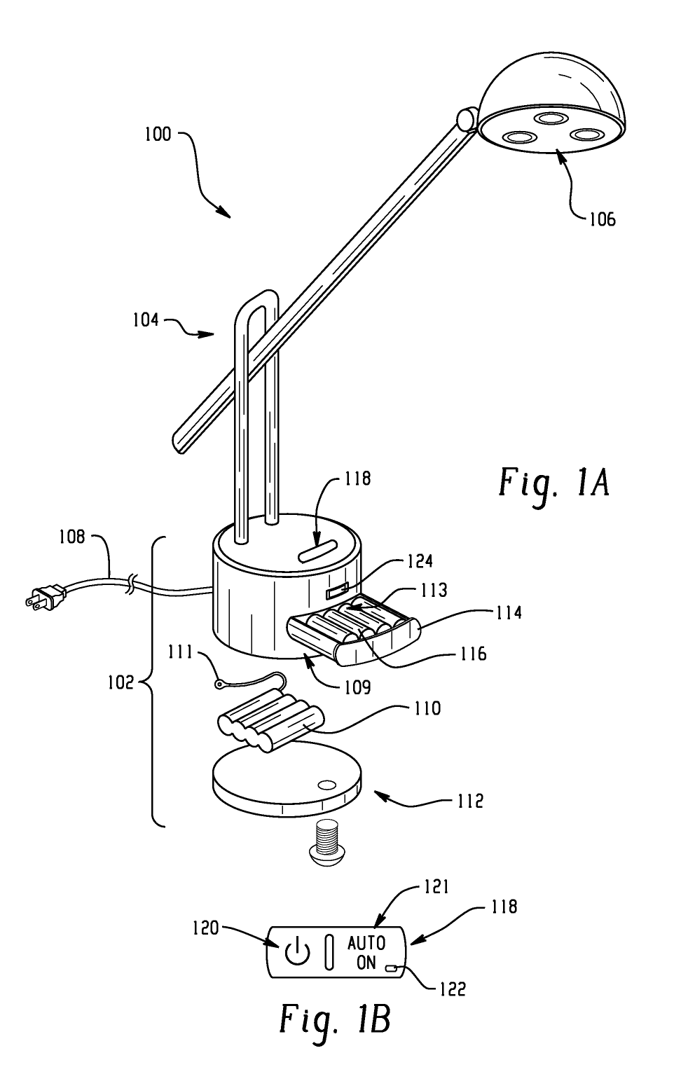

With reference to FIG. 1A, a desk lamp 100 includes a base 102, a lamp supports 104, and a light source 106.

The base 102 is adapted for placement on a generally horizontal surface such as a desk, table, or the like. A conventional line cord and plug 108 allow the lamp 100 to be removably connected to a standard alternating current (AC) power receptacle. Disposed in the base 102 is a secondary battery receiving region 109 adapted to receive a battery pack containing one or more secondary (rechargeable) batteries 110. As an aid to installation and/or replacement, the secondary batteries 110 are connected to circuitry in the base 102 by an electrical connector 111 or by suitable battery contacts.

The battery receiving region 109 and thus the batteries 110 are accessed through a removable cover 112. As depicted in FIG. 1A, the secondary battery receiving region 109 is accessed from the bottom of the base 102, although access may be provided from another desired location such as the top or side. While depicted as being secured by a screw, the cover 112 may also be secured by way of a mechanical tab, thumbscrew, or the like which does not require the use of a tool. The cover 112 may take the form of a sliding, pivoting, or other cover.

The base 102 also includes a primary battery receiving region 113 adapted to receive one or more primary (single use) batteries 116 such as conventional AAA, AA, C, or D size cells, although the use of secondary batteries is also contemplated. The primary batteries 116 are likewise connected to the lamp 100 electrical circuitry by way of suitable battery contacts. As depicted, the primary batteries 116 are received in a tray 114 which is slidably inserted into the base 102. As with the secondary battery receiving region 109, the primary battery receiving region 113 may likewise be accessed from another desired location, or using another suitable cover configuration.

The lamp also includes user controls 118. With reference to FIG. 1B, the user controls 118 preferably include a switch 120 and a human readable indicator 122 such as a light emitting diode (LED), the functionality of which will be described more fully below.

The light source 106 includes an illumination source such as one or more LEDs, low voltage incandescent lamps, electroluminescent (EL) panels, other suitable light sources, or a combination thereof. In the embodiment of FIG. 1A, the light source 106 serves as the primary illumination source during normal AC powered operation as well as a backup illumination source in the event of an AC power loss.

The lamp 100 may also include an additional light emitting diode (LED) or other light source which provides local illumination in the vicinity of the primary battery receiving region 113 and/or the battery tray 114 as an aid to replacing the primary batteries 116 in the event of a power loss. The additional LED is advantageously powered by a lithium ion (Li-ion) coin cell and is automatically illuminated when the user accesses the primary battery receiving region 113, for example through a switch which is activated when the battery tray 114 is opened.

The lamp 100 may also include a universal serial bus (USB) port which provides power to a USB powered device.

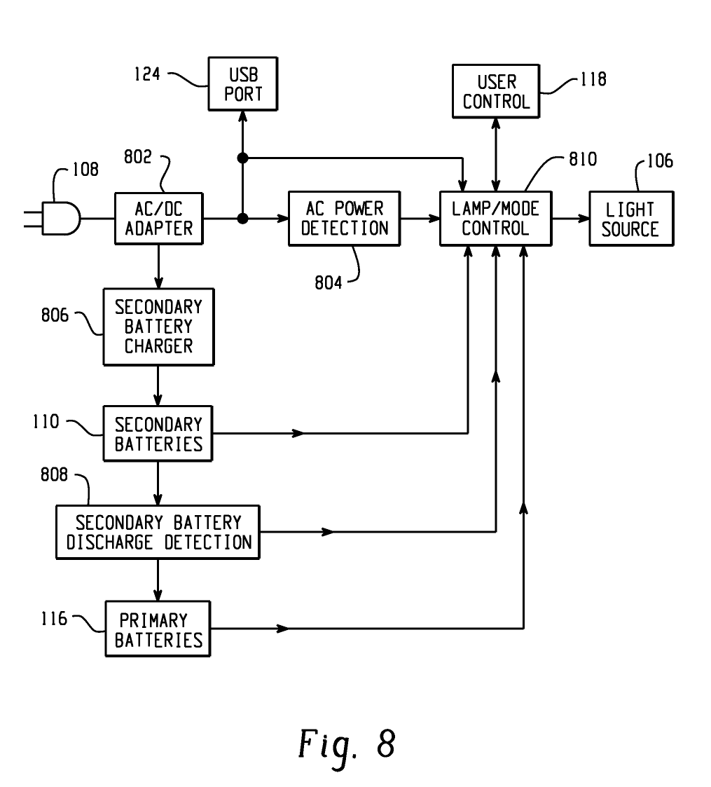

FIG. 8 is a block diagram of the lamp's electrical circuitry. A power supply 802 such as an AC to DC adapter converts the AC power to a voltage level or levels suitable for supplying the electrical circuitry and the light source 106. Note that some or all of the power supply 802 may be located external to the lamp, for example in a conventional receptacle mounted power cube. An AC power detection circuit 804 detects the presence or absence of AC power. Secondary battery charging circuitry 806 receives energy from the power supply 802 and provides electrical energy for charging the secondary batteries 110. Secondary battery discharge detection circuitry 808 detects whether the secondary batteries 110 have become discharged, for example based on the secondary battery 110 voltage.

Lamp control circuitry 810 controls the electrical energy to the light source 106. The lamp control circuitry 810 preferably powers the light source using energy from the AC mains when AC power is available. In the absence of AC power, and as an aid to extending battery life, the light source 106 may be automatically switched a to a low powered or dim state using energy from the secondary 110 or primary 116 batteries. Various techniques may be employed to achieve low powered state. For example, where the light source includes a plurality of individual light sources, only a subset of the light sources 106 may be illuminated. The light sources 106 may also be driven at a reduced duty cycle using a pulse width modulation technique, either alone or in combination with illuminating a subset of the light sources 106.

Note that the USB port 124 may also be powered via the secondary 110 or primary batteries 116 in the event of an AC power loss. In such a case, the USB port 124 may be powered in all cases of an AC power loss, as a function of the lamp 100 operating mode, or via a dedicated on/off and/or mode switch.

Operation of the lamp control circuitry 810 and that of the user controls 118 will now be described with reference to Table 1, where the switch 120 is a three position switch or otherwise allows the user to select between On, Auto, and Off operating modes. The second column depicts the operating state of the light source 106 when AC power is available to the lamp or appliance. The third column depicts the operating state of the light source 106 when AC power is not available, as may occur for example in the case of a power outage or when the lamp or appliance is unplugged.

TABLE 1

Light Source 106 Status

| Switch 120 Position | AC Power On | AC Power Off |
|---|---|---|
| On | On | Off |
| Auto | Off | On/Dim |
| Off | Off | Off |

The foregoing arrangement is well suited to providing normal operation when AC power is available as well as backup lighting in case of an AC power loss. When placed in the Auto mode, the light source 106 is ordinarily not illuminated, although the indicator 122 is illuminated to indicate that the device is in the Auto mode. In the event of an AC power loss, the light source 106 is initially illuminated using energy from the secondary batteries 110. Note that the light source 106 is advantageously illuminated in a dim or reduced power state so as to conserve battery life. The user may then operate the light source 106 at full or otherwise at an increased brightness by placing the device in the On mode.

When in the Off mode, the light source 106 is not illuminated, irrespective of the availability of AC power. When in the On mode, the light source 106 is ordinarily illuminated using power from the AC power source. If AC power is lost, the light source 106 is turned off. Alternately, the light source 106 may be illuminated, preferably in a dim or reduced power state.

The user control 118 may also include a second switch 121. The first switch 120 allows the user to selectively turn on or otherwise vary the brightness of the light source 106, for example between off, on/low, on/medium/, and on/high states. The second switch 121 allows the user to switch the Auto mode on or off. When AC power is available, the light source 106 operates according to the setting of the first switch 120. Upon an AC power loss, the operating state of the light source 106 is a function of the second switch 121. If the Auto mode is turned on, the light source 106 is illuminated, preferably in a reduced power state and subject to further adjustment by the user. If the Auto mode is turned off, the light source 106 is not illuminated.

As noted above, the light source 106 is initially operated using energy from the secondary batteries 110 in the event of an AC power loss. Should the secondary batteries 110 become discharged, as may occur in the case of a relatively extended power outage, the light source 106 is operated using energy from the primary batteries 116. Upon switching to the primary batteries 116, the lamp 100 may be automatically returned to the Auto mode to increase battery life and to indicate that the secondary batteries 110 have become discharged. If desired, the user can then return the light source 106 to full or increased brightness via the switch 120. In the case of an even more extended power outage, the user may replace the primary batteries 116 as needed so that the light source 106 continues to operate. When the primary batteries 116 are replaced, the light source 106 is again preferably returned to the Auto mode.

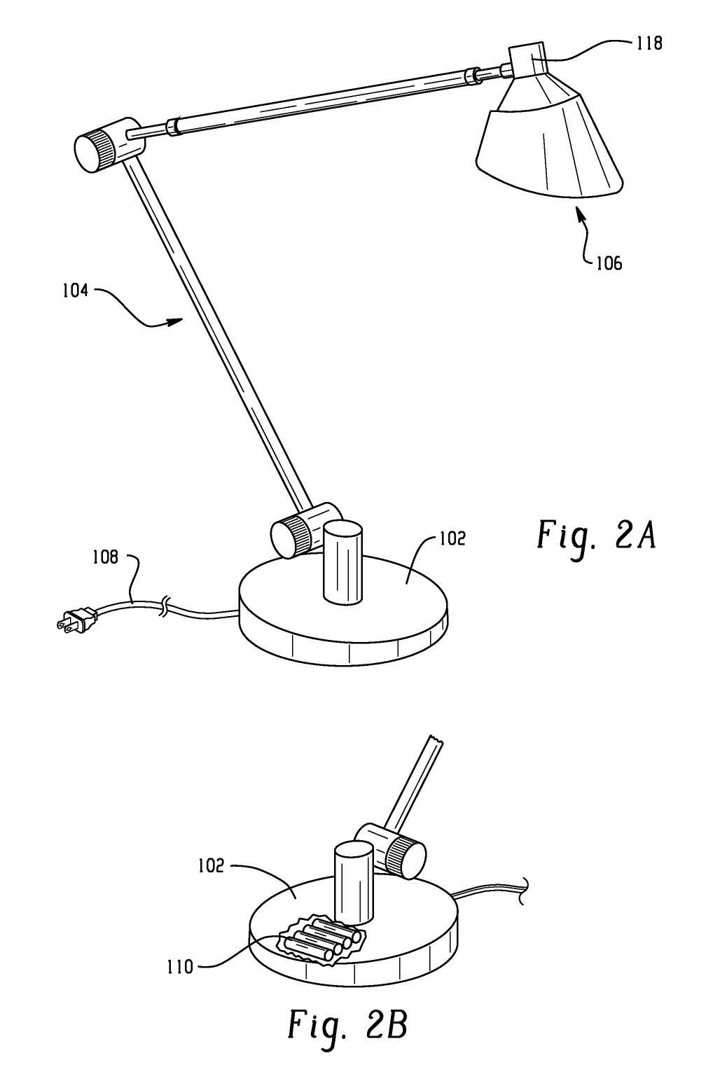

FIGS. 2A and 2B depict an alternate implementation of a desk lamp, where like reference numerals denote features analogous to those described above in connection with FIG. 1. In FIG. 2B, the base 102 is shown in cutaway view to expose the secondary batteries 110 contained therein. Most notably, the primary batteries 116 and USB port 124 are omitted. The secondary battery discharge detection circuitry 808 described in FIG. 8 would likewise be omitted.

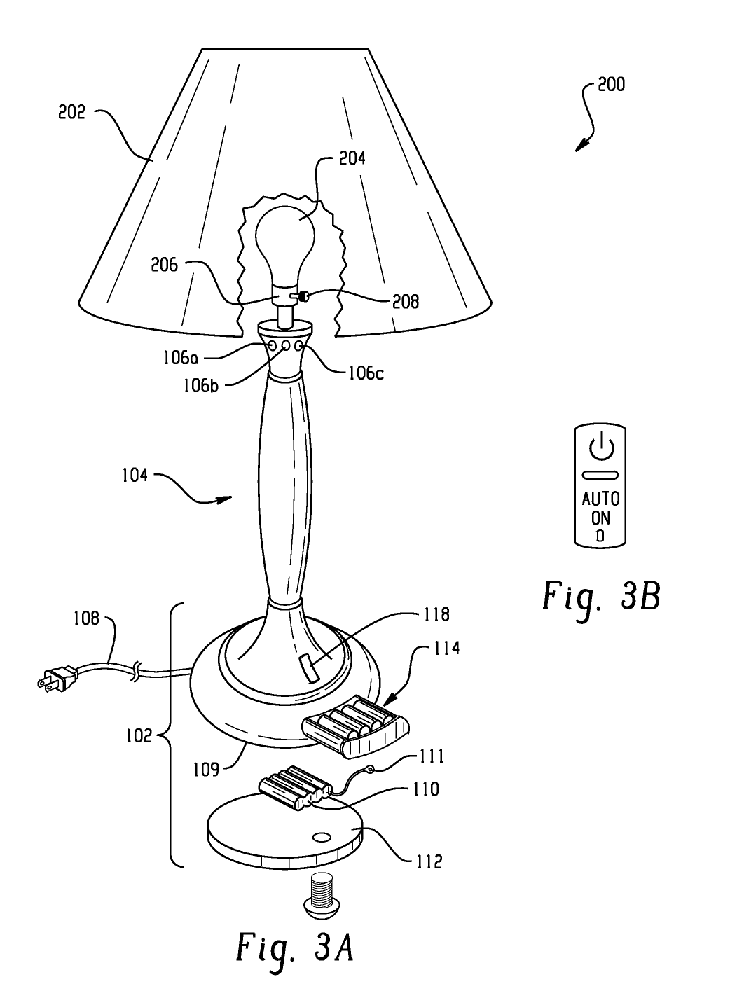

FIG. 3 depicts a table lamp 200, where like reference numerals again denote features analogous to those described above. The lamp 200 includes a lamp shade 202 shown in cutaway view to expose a primary light source 204, a light socket, 206, and a light switch 208. In one implementation, the socket 206 is a conventional light socket and switch adapted to receive a conventional incandescent light bulb, compact fluorescent lamp (CFL), halogen lamp, or the like. The switch 208 is a known light switch such as a turn knob switch which allows a user to selectively turn on or otherwise vary the brightness of the primary light source 204. The primary light source 204 preferably provides the light output typical of a table lamp. The light source 106 may be used to provide additional illumination during normal AC powered operation as well as backup illumination source in the event of an AC power loss.

As illustrated in FIG. 3, the light source 106 includes a plurality of light sources such as LEDs 106a, 106b, 106c which are radially spaced about the lamp portion 104 so as to provide a generally omnidirectional illumination pattern. Other numbers or arrangements of light sources 106 may also be used to provide a unidirectional or other desired illumination pattern; only a single light source 106 may also be provided.

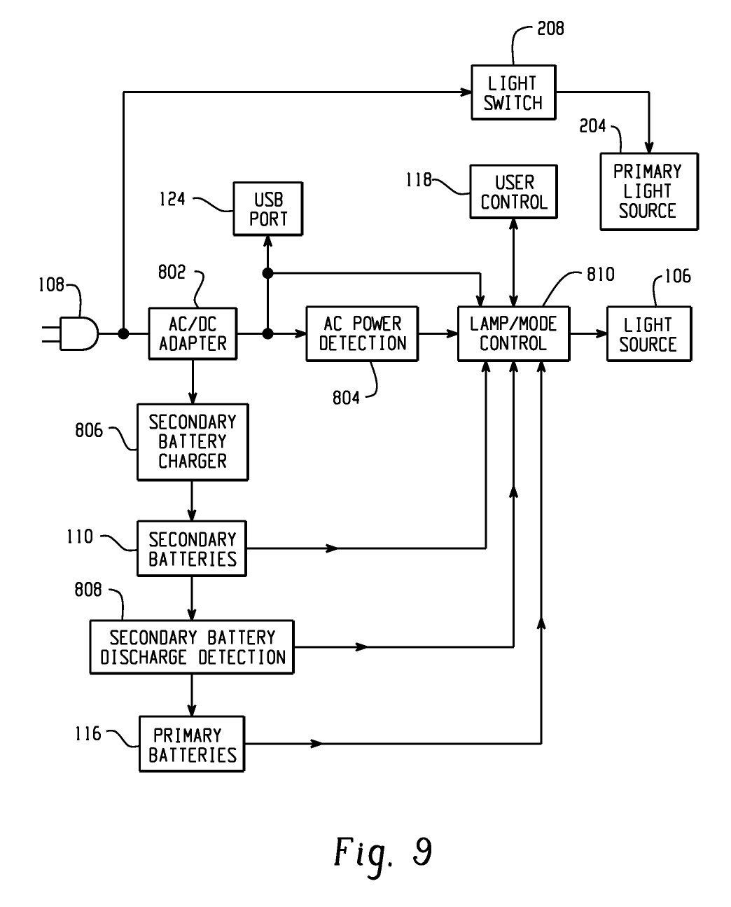

FIG. 9 is a block diagram of the lamp's electrical circuitry. Operation of the electrical circuitry and the light source 106 is as discussed above in relation to FIG. 8 and Table 1. As can be seen in FIG. 9, however, the primary light source 204 is powered from the AC power lines and controlled independently through the light switch 208.

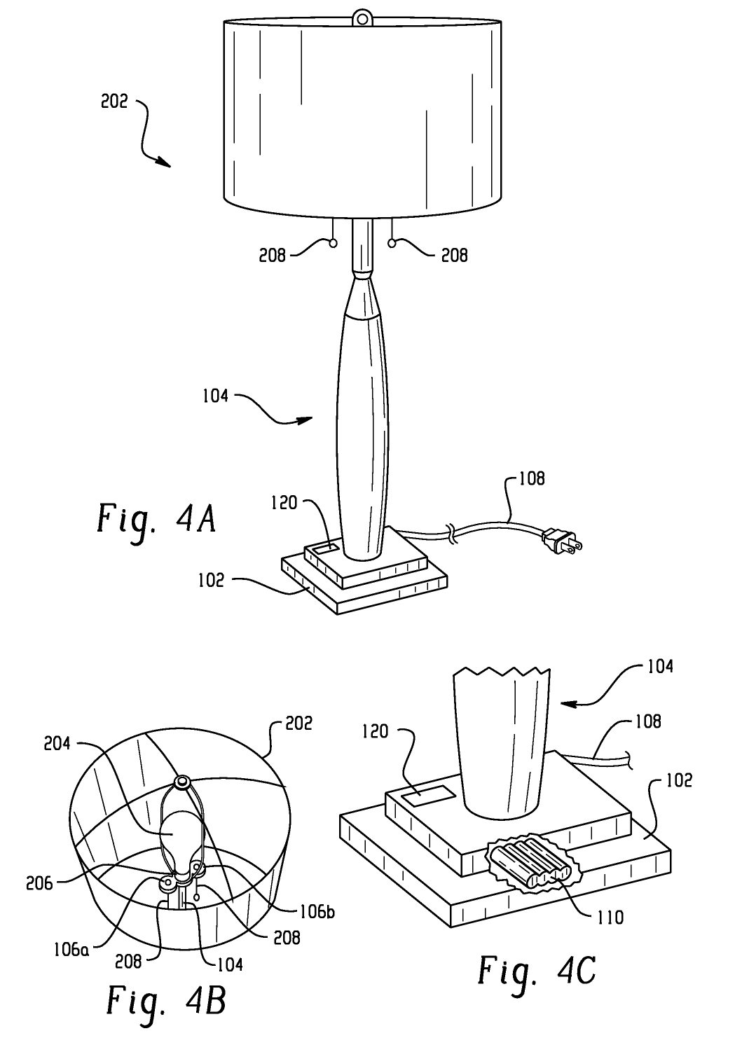

FIGS. 4A, 4B and 4C depict an alternate implementation of a table lamp, where like reference numerals denote features analogous to those described above in connection with FIGS. 1 through 3, although the primary batteries 116 and associated electrical circuitry have been omitted. As shown, the light sources 106a, 106b are disposed in two locations near the second light 204 and shine generally vertically, for example toward the base 102.

Also as illustrated in FIG. 4B, the light switch 208 includes one or more pull switches which are used to control the operation of the primary light source 204 and the light source 106. The light switch 208 allows the user to selectively turn on or otherwise vary the brightness of the lamp. For example, the switch 208 may accommodate four operating states or modes during normal AC powered operation: a first state in which both light source 106 and the second light source 204 are turned off, a second state in which only the light source 106 is illuminated, a third state in which the only the second light source 204 is illuminated, and a fourth state where both the light source 106 and the second light source 204 is illuminated. The switch 120 controls the operating mode of the light source 106 in the event of an AC power loss. In the Auto mode, the light source 106 is illuminated in the case of a power loss, irrespective of the position of the light switch. In the Off mode, the light source 106 is not illuminated in the event of power loss. According to another arrangement, switch 120 may be implemented via a pull switch.

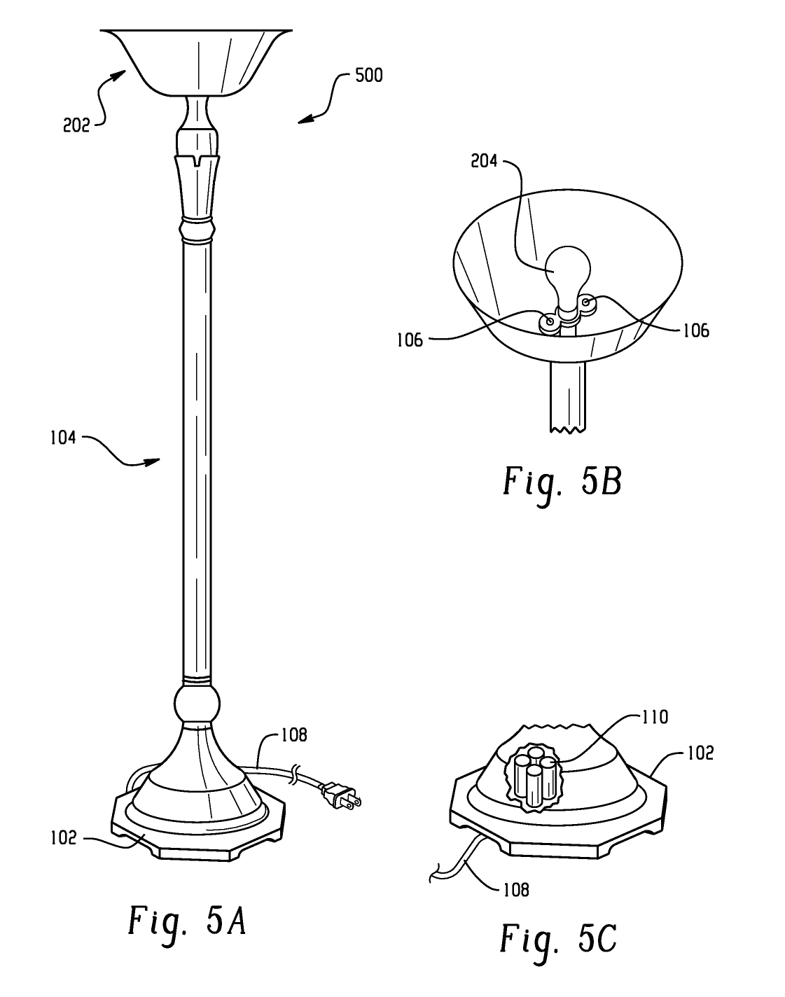

FIGS. 5A, 5B, and 5C depict a floor lamp 500, again with like reference numerals denoting analogous features to those described above.

While the discussion above has focused on desk, table, and floor lamps, it will be appreciated that the form factor of the respective lamps is only exemplary, and other types of lamps such as wall or ceiling mounted lamps may also be implemented. The lamps may also be adapted for mounting and wiring to a conventional electrical box.

Moreover, the desk lamp 100 may include both a primary light source 204 and a light source 106; a table or floor lamp may likewise include only a light source 106. Also, while the secondary 110 batteries, primary batteries 116, and the electrical circuitry have been described as being located in the base, it will be appreciated that some or all of them may be located in another suitable location, for example in the lamp support member 104. As another, the floor lamp 500 may also be configured to accept primary batteries 116 as discussed above with the desk and table lamps. As still another, the primary light source 204 may also be implemented as an LED or other solid state light source, a low voltage lamp, or using other suitable technology.

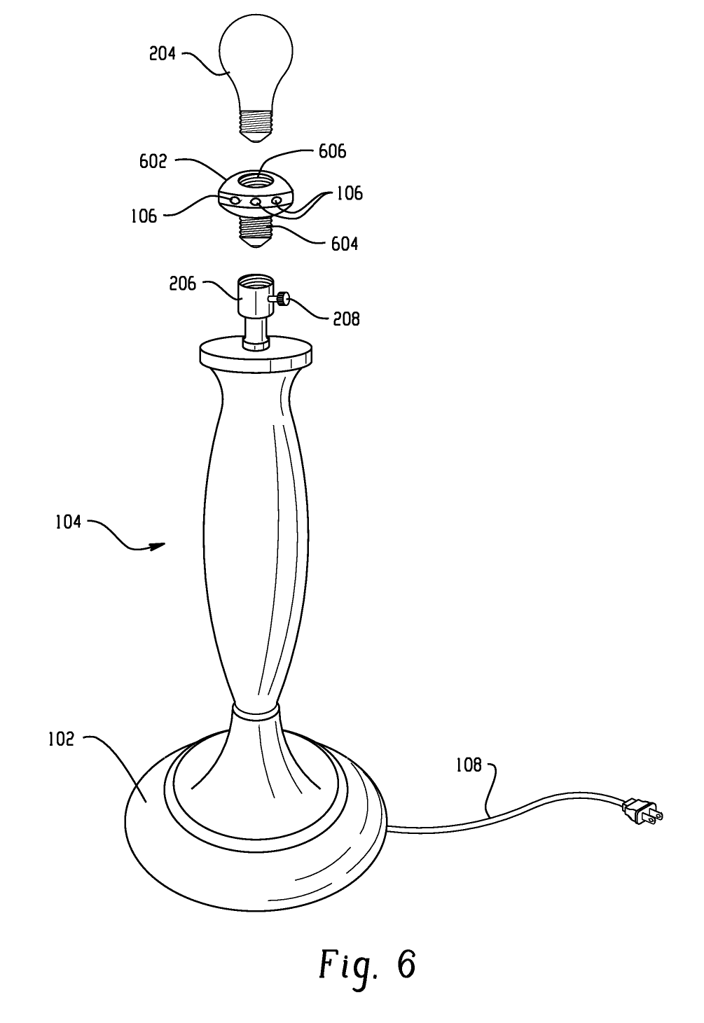

FIG. 6 depicts a battery powered backup lighting device 602 adapted for use with a standard A-lamp or general purpose bulb 204. The device 602 includes a screw in male lamp base 604 and a corresponding, coaxially displaced female lamp socket 606. The device includes one or more lights 106 and one or more secondary batteries 110. Circuitry disposed in the device 602 provides charger functionality to charge the secondary batteries when AC power is available to the lamp, and provides power from the secondary batteries 110 to the lights 106 where AC power is not available to the lamp. The device may also include a user control 118. As another alternative, the device 602 may detect current flow to the second light 204. When the second light 204 is turned off and AC power is available, the lights 106 are powered from energy obtained from the AC line. The precise form factor of the device will vary based on the technology of the bulb 204 and the configuration of it base 604, the number and type of light sources 106 and secondary batteries 110, and the corresponding electrical circuitry.

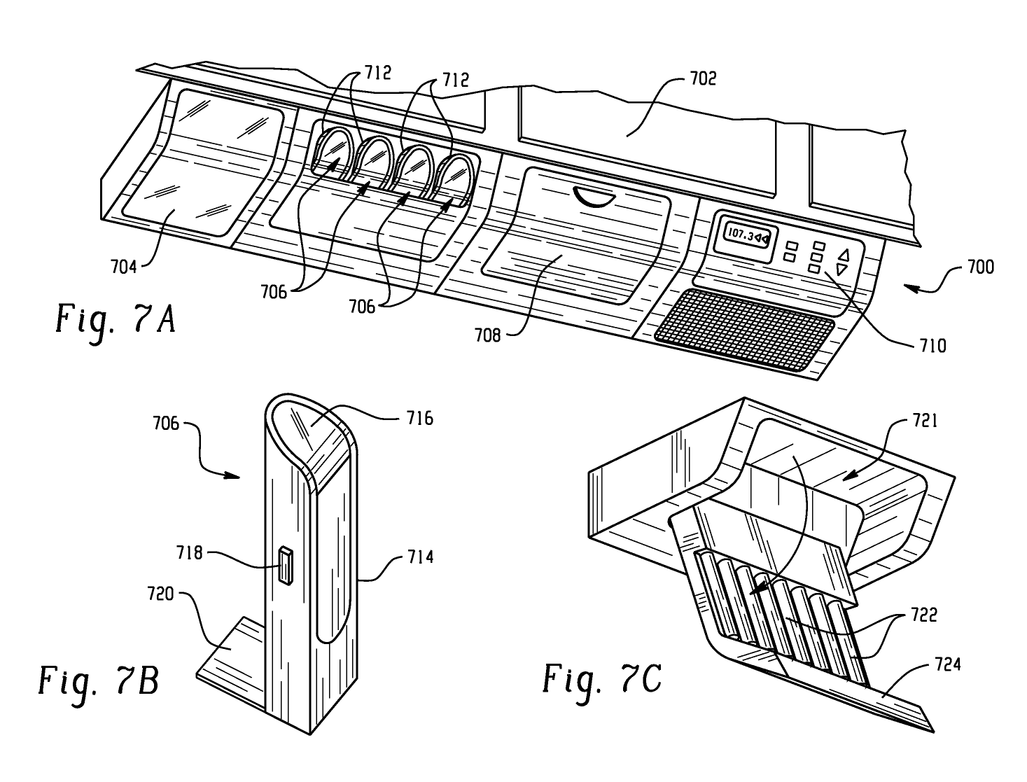

FIG. 7A is a perspective view of an under counter or under cabinet appliance 700 having a battery backup capability. The appliance is configured to be suspended from a horizontal surface such as the underside of a standard kitchen, laundry room, or similar cabinet 702. The appliance includes one or more of fixed lighting 704, an electrical device 710 such as a clock radio, and a battery charger 708, and may also be configured to accept one or more portable lights 706. In normal operation, the appliance 700 receives power from the AC power mains.

The fixed lighting 704 may include one or both of the light source 106 and/or the primary light source 204. In view of the form factor of the appliance 700, conventional fluorescent tubes may be advantageously employed as the primary light source 204.

The appliance 700 also includes the secondary 110 and/or primary batteries 116, together with the desired user control 118, light switch 208, and associated circuitry as discussed above.

One or more receiving regions 712 are adapted to removably receive portable lights 706. Associated with the receiving regions 712 are electrical connections such as electrical contacts or inductively coupled connections for transferring energy to portable lights 706 when disposed in a receiving region 712.

With particular reference to FIGS. 7A and 7B, the portable lights 706 include a housing 714, a battery receiving region adapted to receive one or more secondary batteries and a light source 716 such as an incandescent bulb or LED, and a user operated switch 718 for turning the light source 716 on or off or otherwise controlling its brightness. In one embodiment, the housing includes a substantially flat surface or base which allows the device to be placed on a table or surface when removed from the appliance. As depicted in FIG. 7B, the housing 714 may also be adapted to removably engage a base 720. The portable lights 706 also include suitable electrical connections which correspond to those associated with the battery receiving regions 712 for receiving energy from a secondary battery charger located in the appliance 700. Hence, the portable lights 706 are maintained in a charged state during normal AC powered operation.

With particular reference to FIGS. 7A and 7C, the battery charger 708 can be used to charge secondary batteries to be used in still other appliances. The battery charger 708 includes a battery receiving region 721 adapted to receive one or more secondary batteries 722 for charging. In the illustrated embodiment, a battery holder 724 containing the requisite battery contacts and mechanical supports is pivotally mounted to the underside of the appliance 700. A sliding tray analogous to the battery tray 114, or other desired mechanical arrangements may also be implemented.

While the appliance 700 has been described primarily as an under cabinet device, it may also be configured for placement on a horizontal surface such as a countertop, table, or floor, or on a vertical surface such as a wall. It will also be appreciated that various combinations of the fixed lighting 704, portable lights 706, or electrical appliances 710 may be provided; one or more of them may be omitted.

As still another alternative, the fixed lighting 704 may be disposed in one or more auxiliary housings which are electrically connected to the main appliance 700 via suitable wiring. Still alternately, the portable lights 706 may be so configured. Such an arrangement allows the lighting to be distributed at desired locations along the length of a cabinet or counter so as to provide distributed lighting as well as convenient access to a portable light 706. Advantageously, the auxiliary housings may be provided with suitable connectors which allow multiple auxiliary lights to be daisy chained.

In operation, the fixed lighting 704 operates similarly to that described above in connection with FIGS. 1 through 5 above. One or more of the portable lights 706 may also be powered in the event of an AC power loss, particularly when the appliance 700 is in the Auto mode.

The electrical appliance 710 may also be powered from the secondary 110 and/or primary batteries 116 in the event of an AC power loss. The electrical appliance may also be activated upon a power loss when operated in an Auto mode.

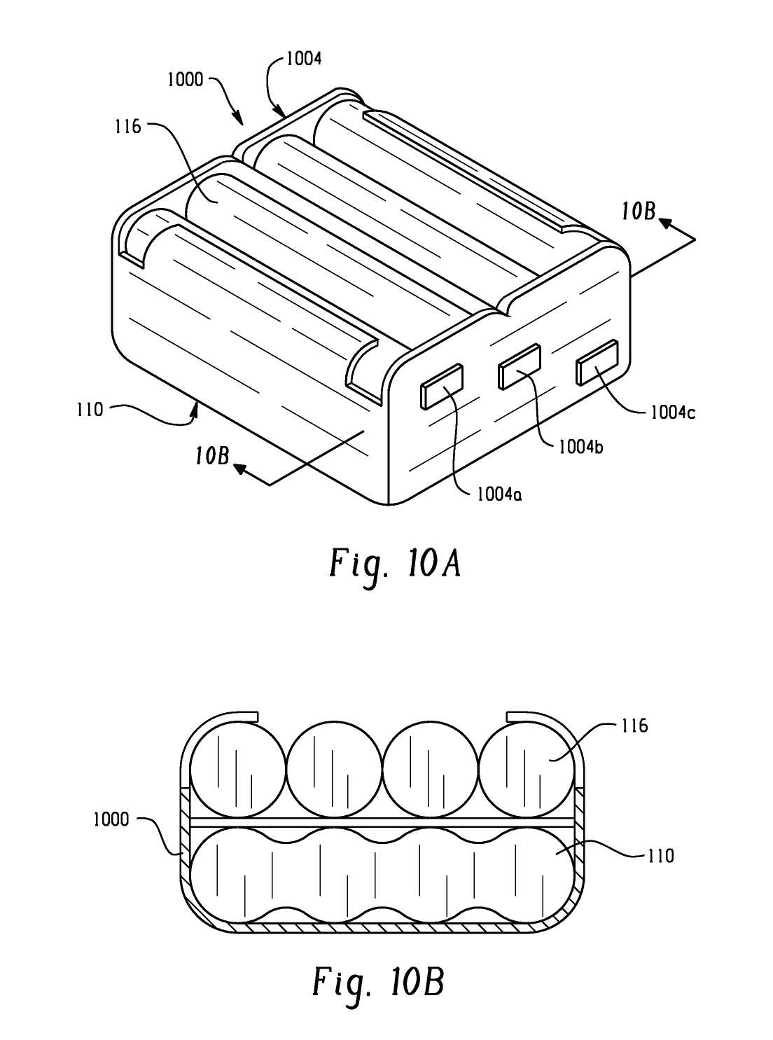

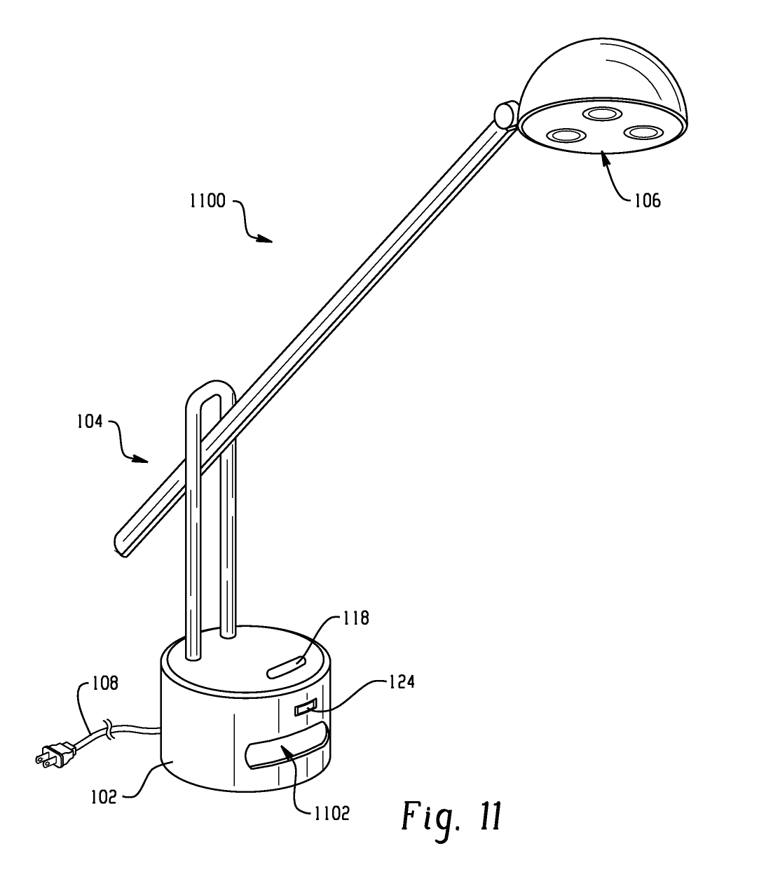

Turning now to FIGS. 10A and 10B, the secondary 110 and primary 116 batteries may also be carried in a cartridge or holder 1000. While FIG. 10 depicts an arrangement adapted to accept 4 AA size primary 116 batteries, the cartridge may be configured to accept other sizes and numbers of batteries.

The cartridge 1000 includes three external electrical contacts 1004a, 1004b, and 1004c. One of the electrical contacts, for example the contact 1004a, is connected to the primary batteries 116 so as to provide a positive voltage connection. A second electrical contact, for the example contact 1004c, is connected to the secondary batteries 110 so as to provide a positive voltage connection. The third electrical contact 1004b is connected to provide a common or negative connection. Of course, the polarities may be reversed.

With reference to FIG. 11, an electrical device such as a lamp 1100 analogous to that discussed above in connection with FIG. 1 includes a receiving region 1102 which receives the battery cartridge 1000 in first and second orientations. The lamp 1100 includes electrical contacts (not shown) corresponding to the contacts 1004. The contacts are arranged so that, when the cartridge 1000 is inserted in the first orientation (for example the orientation shown in FIG. 10A), the secondary batteries 110 are connected to the lamp circuitry. When the cartridge is flipped 180°, the primary batteries 116 are connected to the lamp circuitry.

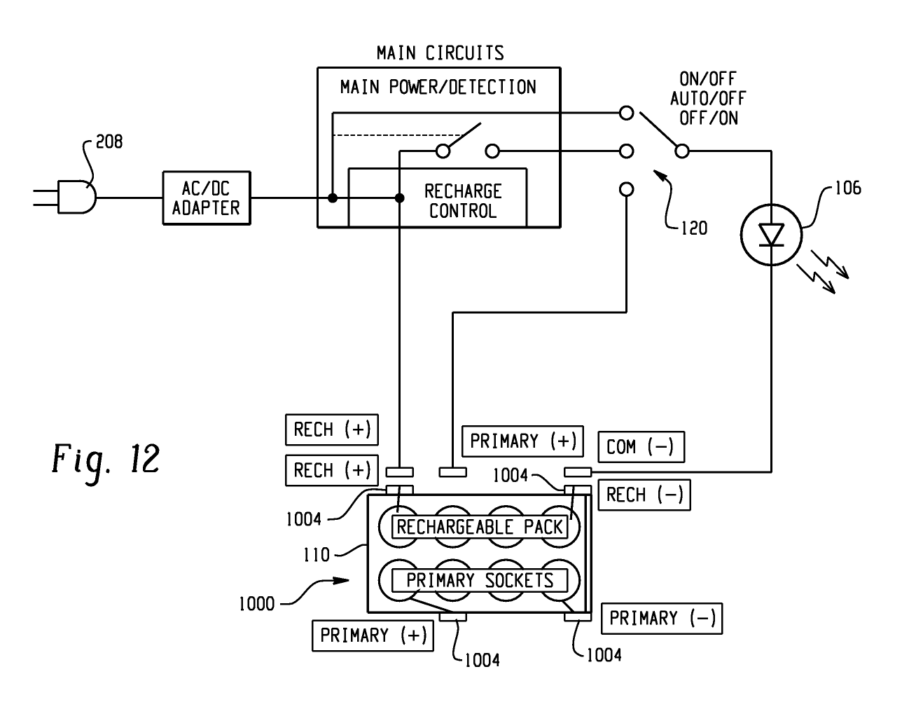

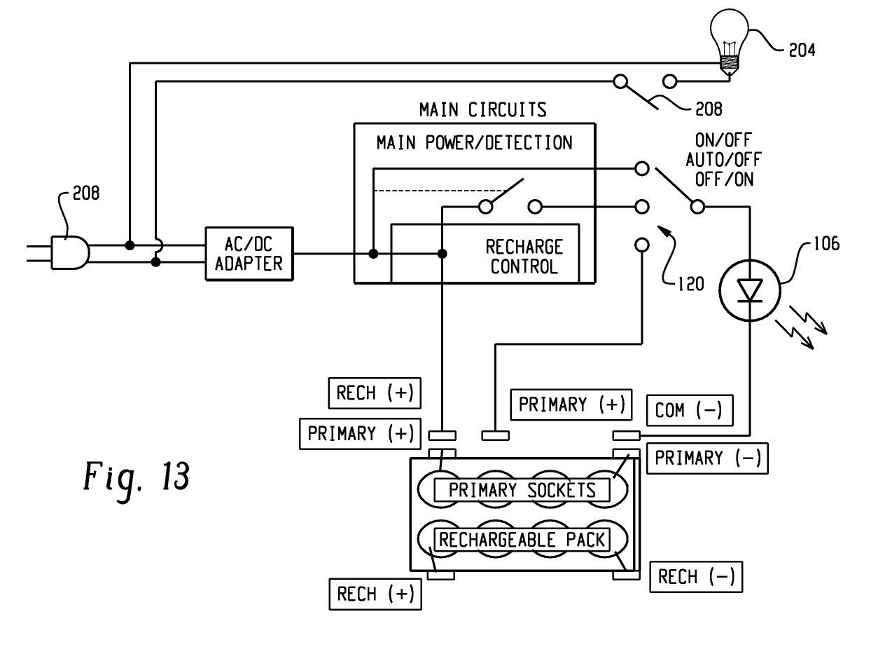

Diagrams of the electrical connections for devices having only the light source 106 and both the light source 106 and the primary light source 204 are shown in FIGS. 12 and 13, respectively. As shown in FIGS. 12 and 13, the cartridge 1000 may also be provided with four (4) electrical contacts, with one pair being connected to the primary batteries 116 and the other to the secondary batteries 110, in which case the contacts in the lamp would be configured accordingly.

Verbiage, symbols, color coding, or other human perceptible indicators for communicating the orientation of the cartridge 1000 may be included on a second 1004 end thereof. Hence, the user is informed whether the secondary 110 or primary 116 batteries are connected to the circuitry. In one indication, the indicator includes color coding which coordinates with colors on the user control 118.

In operation, the user inserts the cartridge in the battery receiving region 1102 in the desired orientation. During normal operation, the cartridge 1000 is inserted in the first orientation. Accordingly, lamp's battery charging circuitry ordinarily maintains the secondary batteries 110 in the charged condition. Upon a loss of AC power, energy from the secondary batteries 110 is used to power the lamp as discussed above. Should the secondary batteries 110 become discharged, the user may elect to remove the cartridge 1000 from the lamp, rotate to the second position, and reinsert it. Energy from the primary batteries 116 is used to power the lamp. Should the primary batteries 116 become discharged, the user may remove the cartridge, replace the primary batteries 116 with fresh batteries, and reinsert the cartridge.

The foregoing arrangement provides the user with direct control over the batteries used to power the lamp while preventing the primary batteries 116 from receiving energy from the charger. The secondary battery charge detection circuitry 808 may also be omitted.

Note also that the cartridge or lamp may also include a user accessible switch which allows the user to switch between the secondary 110 and primary 116 batteries.

While the above discussion has focused on the use of the cartridge 1000 in connection with a desk lamp, it will be appreciated that the cartridge may be used in connection with a floor, desk, or other lamp, with the under cabinet 702 device, or with other devices.

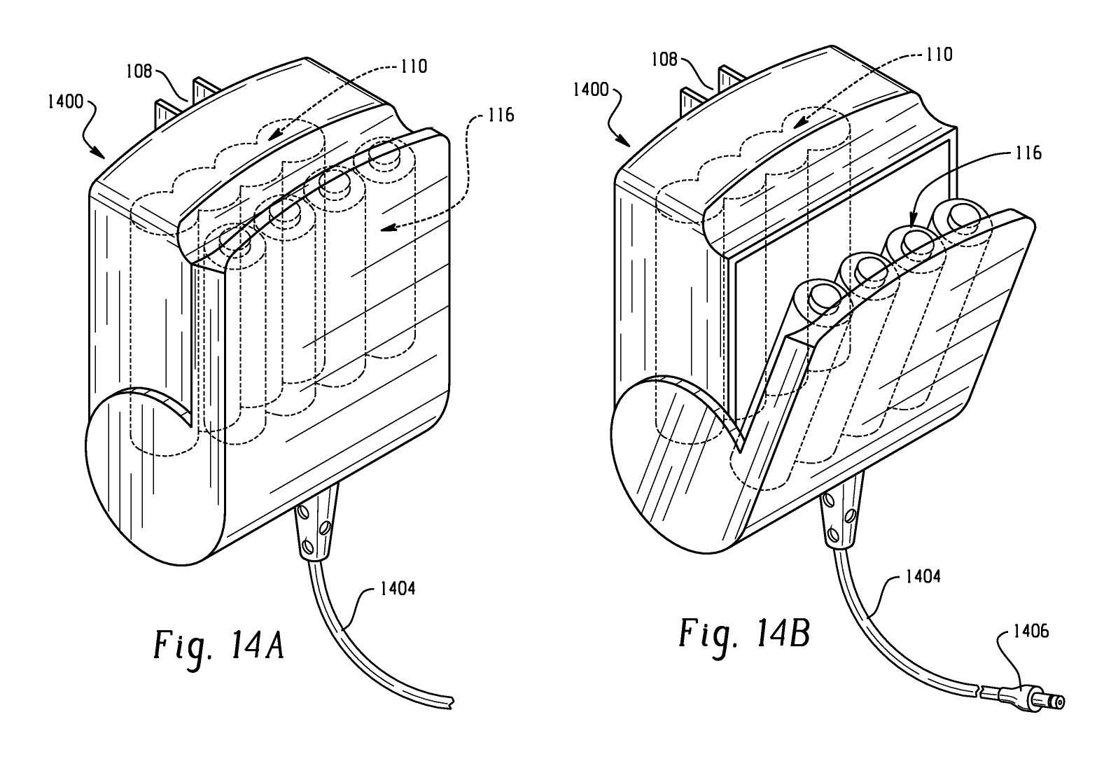

FIGS. 14A and 14B depict a wall plug adapter 1400 which includes battery backup capabilities. The adapter 1400 includes a conventional electrical plug 108 adapted to engage a standard AC power receptacle, receiving region(s) for accepting secondary 110 and/or primary 116 batteries, a power cable 1404, and an electrical connector 1406 adapted to engage the corresponding electrical connector of a battery powered device. Note also that the connector 1406 may be omitted; the adapter 1400 may then be hard wired to the battery powered device.

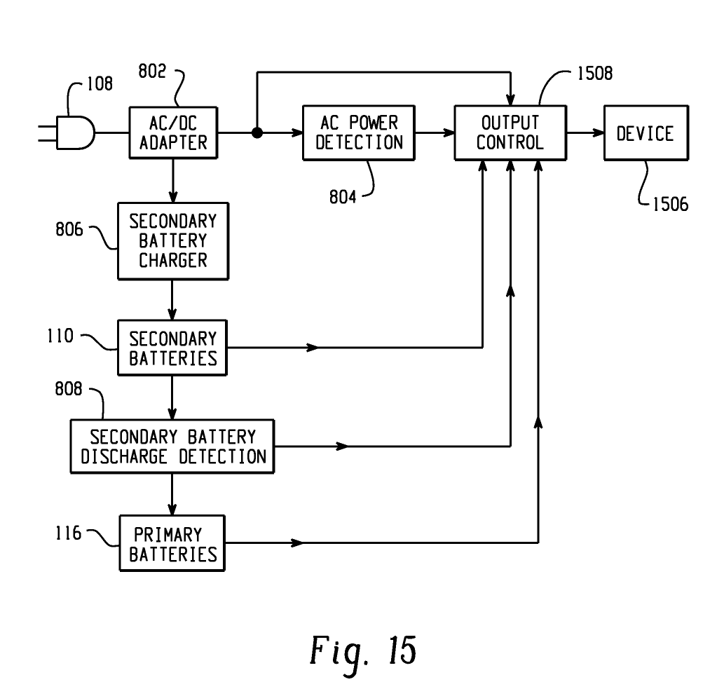

FIG. 15 is an electrical block diagram of an adapter which accepts both secondary 110 and primary 116 batteries. The charger includes output control circuitry 1508 which selects the source of energy provided to the external device 1506. During normal operation, power from the AC lines is used to power the device 1506. In the event of a power loss, the control circuitry 1508 switches to the secondary batteries 110. Should the secondary batteries become discharged, the control circuitry 1508 switches to the primary batteries 116. Again, the user may readily replace the primary batteries 116 should they also become discharged. Note that the adapter 1400 may also include a suitable DC to DC converter(s) to convert the battery 110, 116 output voltage to a desired output voltage. The adapter 1400 may also include a switch which allows a user to selectively de-power the device output during a power interruption. The foregoing device is particularly well suited for use with appliances such as cordless telephones, answering machines, and the like which advantageously remain operational in the event of a power interruption.

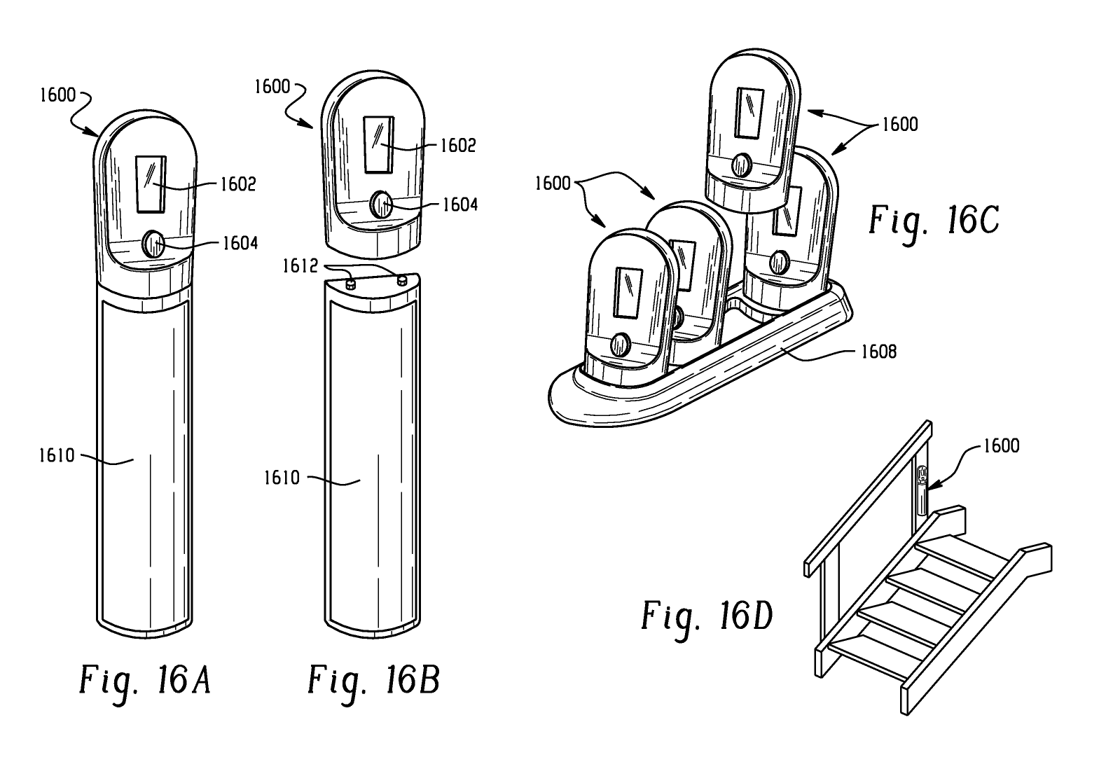

Turning now to FIGS. 16A-D, a portable battery powered lighting device 1600 includes a portable light source 1602, a power switch 1604, and one or more secondary batteries (not shown). The devices 1600 are adapted to be removably mounted to a suitable mount 1610 such as a wall or ceiling mount which may in turn be permanently or semi-permanently mounted in a desired location. The devices 1600 may be mounted to the mounts 1610 using cut and loop fasteners, a mechanical or magnetic coupling, or other suitable fasteners 1612. An AC powered charging base 1608 is adapted to receive one or more lighting devices 1600 for charging. Following charging, the devices 1600 may be returned to a desired mounting base 1610. The portable light sources 1602 may also be adapted to operate with the cabinet appliance 700. As will appreciated, the foregoing device is especially well suited for providing lighting in locations which are not otherwise located near a suitable AC power outlet, for example near a stairwell as shown in FIG. 16D.

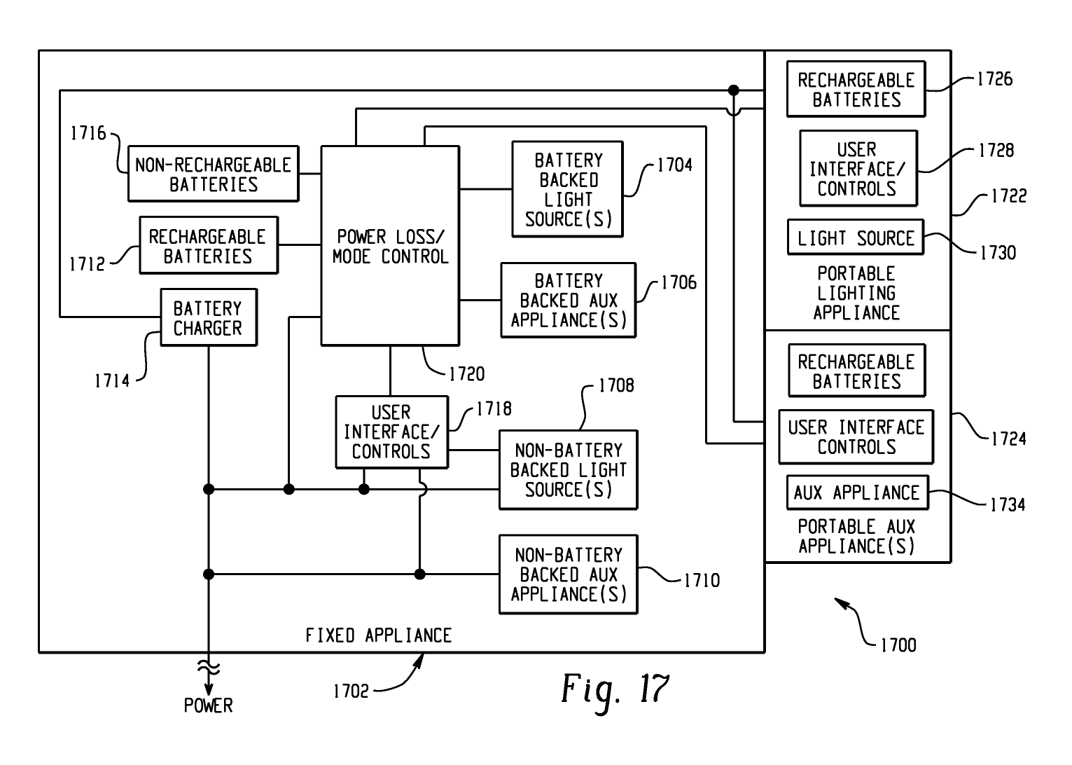

More generally, a functional block diagram of a hybrid battery powered appliance 1700 is shown in FIG. 17. As can be seen, the appliance includes a fixed appliance 1702. In this sense, fixed should be understood to mean that the fixed appliance 1702 is connected to the AC power mains or other suitable power source during normal operation. The fixed appliance 1702 may be readily portable, or may be permanently or semi-permanently affixed in a particular location. It should also be noted that the connection to the power source may be made through an external power supply such as a conventional power cube. Some or all of the power supply functionality may also be incorporated into the fixed appliance 1702.

The fixed lighting appliance 1702 includes one or more battery backed light sources 1704. The fixed lighting appliance 1702 may also include one or more battery backed auxiliary appliances 1706, one or more non-battery backed light sources 1708, and one or more non-battery backed auxiliary appliances 1710.

The fixed appliance 1702 also includes rechargeable (secondary) batteries 1712. A battery charger 1714 operatively electrically connected to the rechargeable batteries 1712 and the power source maintains the charge state of the batteries 1712. The fixed appliance may also include non-rechargeable (primary) batteries 1716. A user interface 1718 includes one or more user operable switches, input devices, remote control inputs, or other user operable controls which allow the user to control the operation of the various light source(s) and/or auxiliary appliance(s) associated with the appliance 1700. Where the user interface includes a remote control input, the appliance 1700 may be supplied with a suitable remote control device. The user interface 1718 may also include one or more human readable status indicators which indicate an operating status or mode of the appliance 1700 or its various components.

A power loss/mode controller 1720 controls the operation of the battery backed lights source(s) 1704 and/or the battery backed light auxiliary appliance(s) 1706 based on the user controls 1718 and the status of the power source. When power is available from the power source, the power loss/mode control circuitry 1720 allows the battery-backed light source(s) 1704 and appliance(s) 1706 to function normally as specified by the user controls 1718.

In the case of a power failure, or when the external power source is otherwise unavailable, the power loss/mode control circuitry 1720 automatically controls the operation of the various battery-backed devices according to desired priority rules. Where the fixed appliance 1702 includes both rechargeable 1712 and non-rechargeable 1716 batteries, the rechargeable batteries 1712 are used first. Should the rechargeable batteries 1712 become discharged, operation switches to the non-rechargeable batteries 1716. The various devices 1704, 1706 may also be automatically turned on in a low power mode or, if operating, placed into a power saving operating state. In one embodiment, the user may elect to over-ride the automatically determined mode and thus cause a desired device to turn off or to operate in a full power mode.

Operation of the non-battery backed light sources 1708 and/or auxiliary appliances 1710, where provided, is also controlled via the user interface 1718. While the FIG. 17 shows the relevant controls as controlling the power provided to the non-battery backed devices 1708, 1710, it will be appreciated that other controls may also be provided depending on the nature of the auxiliary device and the desired degree of control. Of course, the non-battery backed devices 1708, 1710 will ordinarily not function in case of a power loss.

One advantage of including non-battery backed devices 1708, 1710 is that devices which operate at relatively high power levels may readily be incorporated in the appliance 1700. In the case of a lamp, for example, the non-battery backed light source 1708 may be implemented as one or more conventional, AC powered electric lights which provide a relatively high light output. The battery backed devices may be implemented using relatively lower power, higher efficiency light sources such as LEDs. While such sources can generally be used to provide reasonable light levels during normal operation, their relatively lower power requirements are better-suited to battery powered operation than are conventional electric lights.

The hybrid appliance 1700 may also include one or more portable battery backed light sources 1722 and/or one or more portable battery backed auxiliary appliances 1724. The portable devices include rechargeable batteries 1726 and a suitable user interface 1728. During normal operation, the battery charger 1714 maintains the charge state of the various batteries 1726. The portable devices 1722, 1724 also include removable covers or housings which allow the user to replace the batteries 1726 in the case of an extended power outage.

When configured as a portable light source 1722, the portable device includes one or more light sources 1730. A portable appliance 1724 includes one or more battery powered auxiliary appliances 1734. When installed on the fixed appliance 1702, the portable devices 1722, 1724 are advantageously operated via the user controls 1718 and the power loss/mode controller 1720 in a manner similar to those of or otherwise in coordination with the battery backed devices 1704, 1706. Even more advantageously, the portable devices may be configured to contribute to or complement the day-to-day function of the fixed appliance 1702.

In one implementation, the priority rules are such that the portable devices 1722, 1724 are automatically turned off in the case of a power loss as an energy conserving measure. In any case, the portable devices 1722, 1724 are advantageously configured to be readily removable from the fixed appliance as desired by the user.

Various configurations of the hybrid battery powered appliance 1700 are contemplated. As described above in relation to FIGS. 1 through 5 above, for example, the appliance can take the form of a lamp suitable for home or office use. More particularly, the lamps have a form factor, aesthetics, and operating characteristics similar to those of conventional AC powered lamps, but have additional utility in case of a power failure. As described in relation to FIG. 7, the appliance 1700 takes the form of an under cabinet mounted device. Of course, the various lamps may be provided with portable devices 1722, 1724; the under cabinet appliance may be provided without portable devices 1722. Of course, still other configurations, whether suitable for home use, office use, or otherwise, are also contemplated. Still additional examples are provided below.

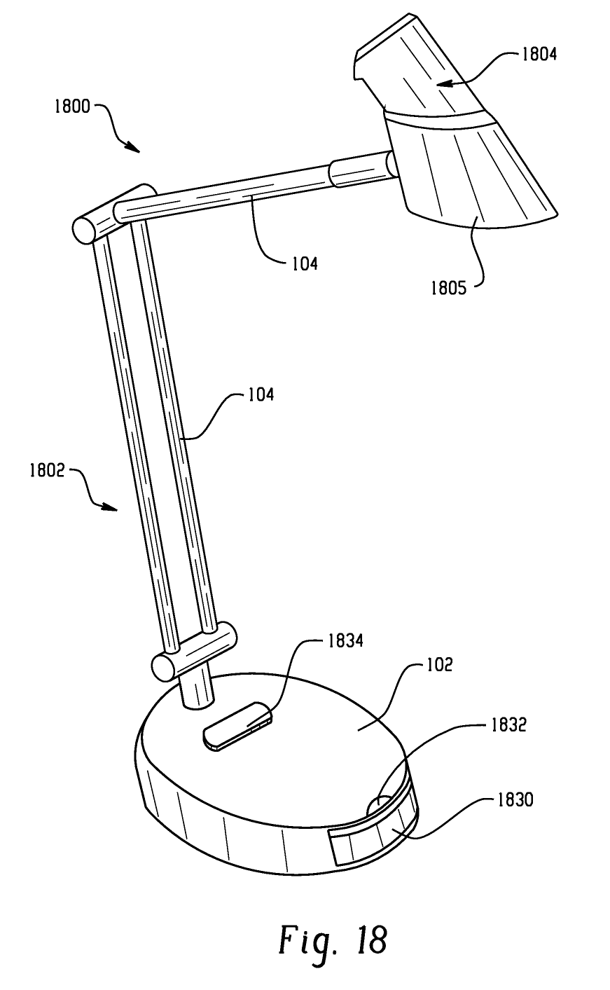

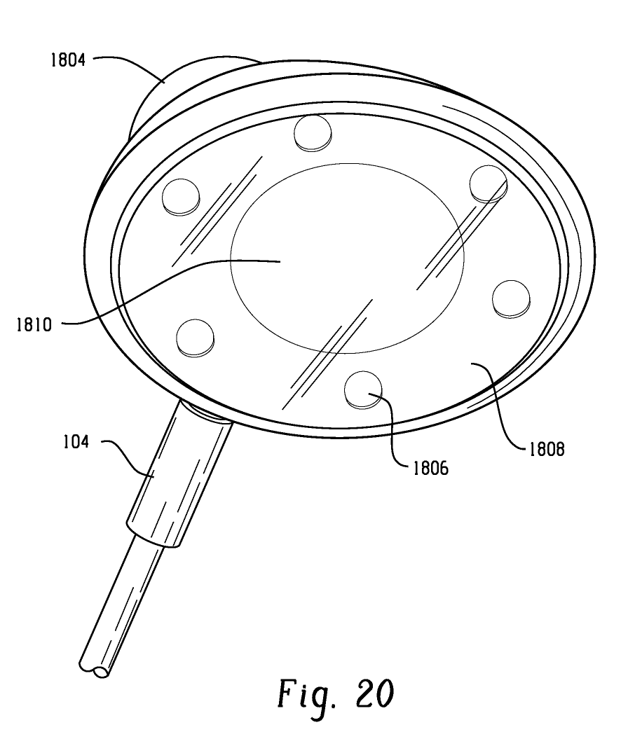

Turning now to FIGS. 18, 19, and 20 an exemplary desk lamp 1800 includes both a fixed appliance 1802 and a portable appliance 1804. The portable appliance 1804 can be readily removed from the lamp 1800 for use as a flashlight.

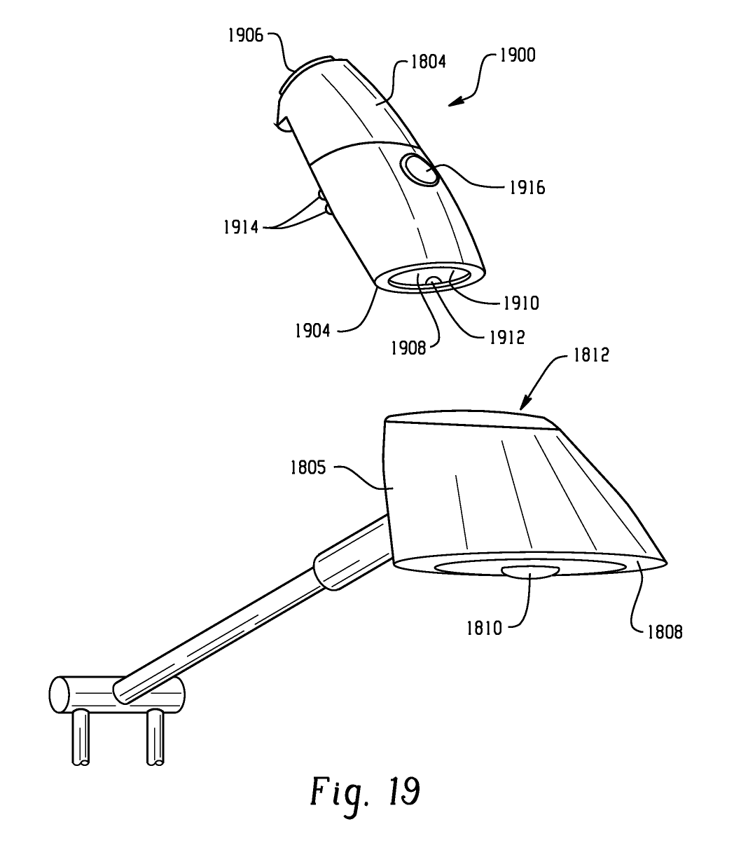

The fixed appliance 1802 includes a base 102 and support arms 104 analogous to those described above in relation to FIGS. 1 and 2. With additional reference to FIG. 19, the fixed appliance 1802 includes shroud or head 1805.

The shroud 1805 carries a battery backed light source 1806 such as a plurality of LEDs disposed in a generally circular arrangement for illuminating the surface of a desk or other desired area. The light from the light source 1806 shines through a protective cover 1808 which, in the vicinity of the LEDs, is substantially non-diffuse. A central portion of the cover 1808 includes an optical diffuser 1810 such as an etched, frosted, or translucent portion which serves to diffuse or soften light shining therethrough. The shroud 1805 also includes a generally cylindrical material free region 1812 which selectively receives the portable lighting appliance 1804. The material free region 1812 generally aligns with the diffuser 1810.

The portable lighting appliance 1804 includes a generally cylindrical housing 1900 having proximal 1904 and distal 1906 ends. The housing 1900 can be opened by the user to access a battery receiving region which selectively receives a plurality of batteries, for example three (3) AA or AAA size nickel metal hydride (NiMH) batteries, although other numbers, sizes, or chemistries (including primary and secondary batteries) are also contemplated.

Disposed at the proximal end 1904 of the portable lighting appliance 1804 is a light source 1908 such as an LED, a reflector 1910, and a lens 1912. In one implementation, the reflector 1910 and lens 1912 are configured to provide a relatively narrow spot or beam light similar to that of a conventional flashlight beam. In such a configuration, the lens 1912 would ordinarily be substantially clear or otherwise non-diffuse.

A user operable switch 1916 such as a pushbutton on-off switch allows the user to turn the light source 1908 on and off as desired. Electrical connectors 1914 such as positive and negative contacts engage corresponding electrical connectors disposed in the shroud 1805 to provide power to the portable lighting appliance 1804 when it is installed in the shroud 1805.

As illustrated, the portable lighting appliance 1804 has a generally cylindrical form factor similar to that of a conventional flashlight. The housing exterior advantageously has a somewhat asymmetrical cross section or is otherwise keyed so that the portable lighting appliance 1804 is received in the shroud 1805 proximal end 1904 first and in a defined angular orientation.

The base 102 contains a user-operable switch 118, batteries, and circuitry as generally described above. In one implementation, the base 102 receives four (4) AA or AAA size rechargeable batteries. Using batteries of the same size as those in the portable lighting appliance 1804, while not essential, is generally more convenient for the user. As illustrated, the base 102 also includes a slide-out battery tray 1830 which holds a plurality of primary batteries (e.g., four (4) AA or AAA size batteries). A user operable latch 1832 controls opening or closing of the tray 1830.

In one implementation, the user controls include a multiple position slide, rotary, or other switch 1834, the operation of which is shown in relation to Table 2:

TABLE 2

| | Light Source Status | | | |
|---|---|---|---|---|
| | External Power On | | External Power Off | |
| Switch | Battery | Portable | Battery | Portable |
| 1834 | Backed Light | Light Source | Backed Light | Light Source |
| Position | Source 1806 | 1908 | Source 1806 | 1908 |
| On/High | On | On | On | Off |
| On/Low | On | Off | On | Off |
| Auto/Off | Off | Off | On | Off |
| Off | Off | Off | Off | Off |

In the event of a power failure, the lamp 1800 automatically assumes the operating state set out in the External Power Off Column. Optionally, the user may be permitted to override the operating state, for example, by returning the switch 1834 to the off position, and then back to the desired position. Note that one or more intermediate operating modes (e.g. On/Med) may also be provided.

In case of a power failure, the fixed light source 1806 may also be operated in a dim mode (e.g., by operating only a subset of the LEDs and/or by operating the LEDs at a reduced duty cycle). The light source 1806 may also be operated for a limited period of time, for example on the order of several minutes, whereupon the light source 1806 is automatically turned off to conserve battery life. In still another implementation, the portable light source 1908 is illuminated, either alone or in combination with the battery backed light source 1806. The operating controls may also include a dimmer which allows the user to selectively vary the brightness of the fixed 1806 and/or the portable 1908 light sources.

Of course, the operating controls described in relation to the desk lamp 1800 can be applied to the various devices described herein. Similarly, the various operating controls described herein can be applied to the desk lamp 1800.

In operation, the user installs the portable lighting appliance 1804 in the fixed portion 1802 by inserting the proximal end 1904 in the material free region 1812. The relatively narrow light beam provided by the portable lighting appliance 1804 is diffused by the diffuser 1810 so as to soften or disperse the light. The degree of diffusion provided by the diffuser 1810 is advantageously selected so that the area illuminated by the light source 1908 is approximately coextensive with the area illuminated by the fixed light source 1806. Thus, the area illuminated by the lamp 1800 is illuminated relatively more evenly, with the light intensity varying as selected by the user. The diffuser 1810 may also be omitted.

The user may at any time remove the portable lighting appliance 1804 from the lamp 1800 for use as a flashlight, with its operation controlled by the on-off pushbutton switch 1912. When removed from the lamp 1800, however, the portable lighting appliance 1804 provides the illumination characteristics typical of a flashlight beam. To recharge the portable lighting appliance 1804 batteries, the user reinstalls the portable lighting appliance 1804 in the lamp 1800. In case of an extended power outage, the user may replace the portable lighting appliance 1804 batteries and/or the batteries contained in the base 102 as needed.

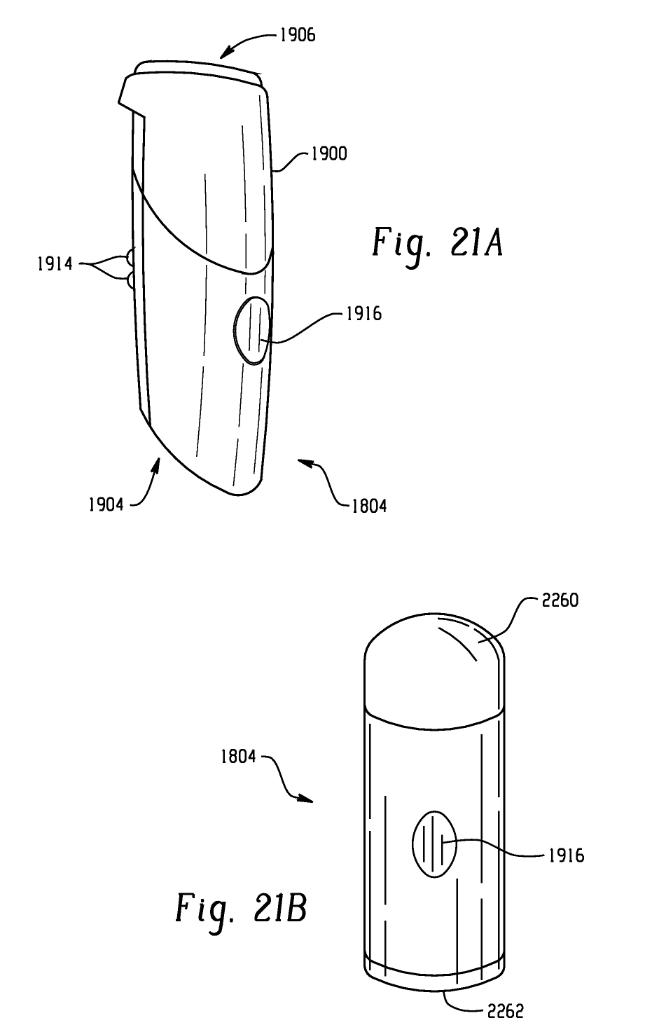

Other variations are contemplated. For example, and as illustrated in FIG. 21B, the portable lighting appliance 1804 may be configured to provide an area flashlight. As illustrated, the portable lighting appliance 1804 includes a dome shaped, translucent cover 2260 so that the portable lighting appliance 1804 provides a substantially omnidirectional lighting pattern. Also as illustrated, the portable lighting appliance 1804 includes a substantially flat bottom surface 2262 so that the light source 1804 may be stood upright. The light source 1804 may also be provided with a flat side surface so that the portable lighting appliance 1804 may be placed on its side.

In another variation, the portable lighting appliance 1804 is installed in the lamp 1800 distal end 1906 first so that it shines in a direction opposite that of the light source 1806 (e.g., upward). In still another variation, the portable lighting appliance 1804 may be inserted in the lamp 1800 either proximal end 1904 or distal end 1906 first as desired by the user. The portable lighting appliance 1804 may also carry two light sources, for example a first light source disposed at the proximal end 1904 and a second light source disposed at the distal end 1906, with operation controlled by a suitable switch or switches. The light sources may be configured as beam sources, area lights, or a desired combination thereof (e.g., one beam source and one area light). The lamp 1800 may also be provided with a non-battery backed light source, either in addition to or in lieu of the battery backed light source 1806. The portable lighting appliance 1804 may also have a non-cylindrical form factor.

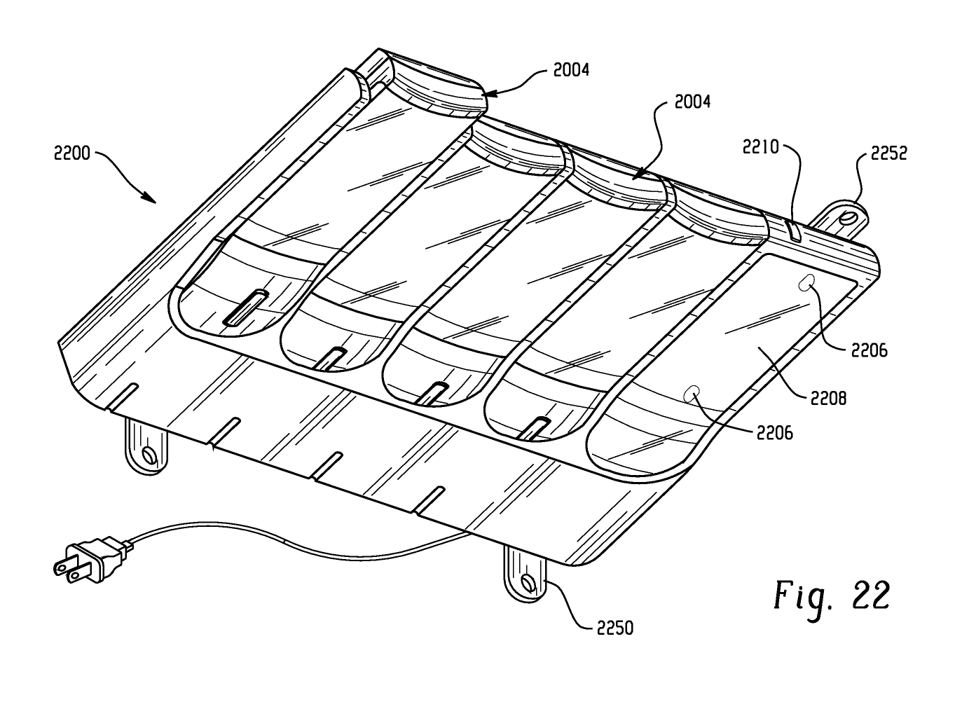

Turning now to FIG. 22, a hybrid battery powered lighting appliance 2200 includes a fixed portion such as a base 2202 and a plurality of portable lighting appliances 2204 which also function as area lights.

The base 2202 includes a battery backed nightlight 2206 which includes two (2) LEDs disposed behind a diffuser 2208 such as cylindrical light pipe diffuser and/or a translucent panel. A user operable switch 2210 includes off, on/high, on/low, and auto/off operating positions which function as described above in relation to Table 2 above, where the nightlight 2206 is analogous to the battery backed light source 1806 and the plurality of portable lighting appliances 2204 are analogous to the portable lighting appliance 1804. The switch 2210 may also include one or more intermediate positions where one, two, or three of the portable lights sources 2204 are illuminated, or other desired positions.

The portable lights sources 2204 ride on rails in their respective receiving regions and are held in place by corresponding spring latch mechanisms. To remove a portable lighting appliance 2204, a user pushes inwardly to release the spring latch mechanism, whereupon the unit is pushed out far enough to be grasped and slid out along the rails. Other mounting techniques may also be used.

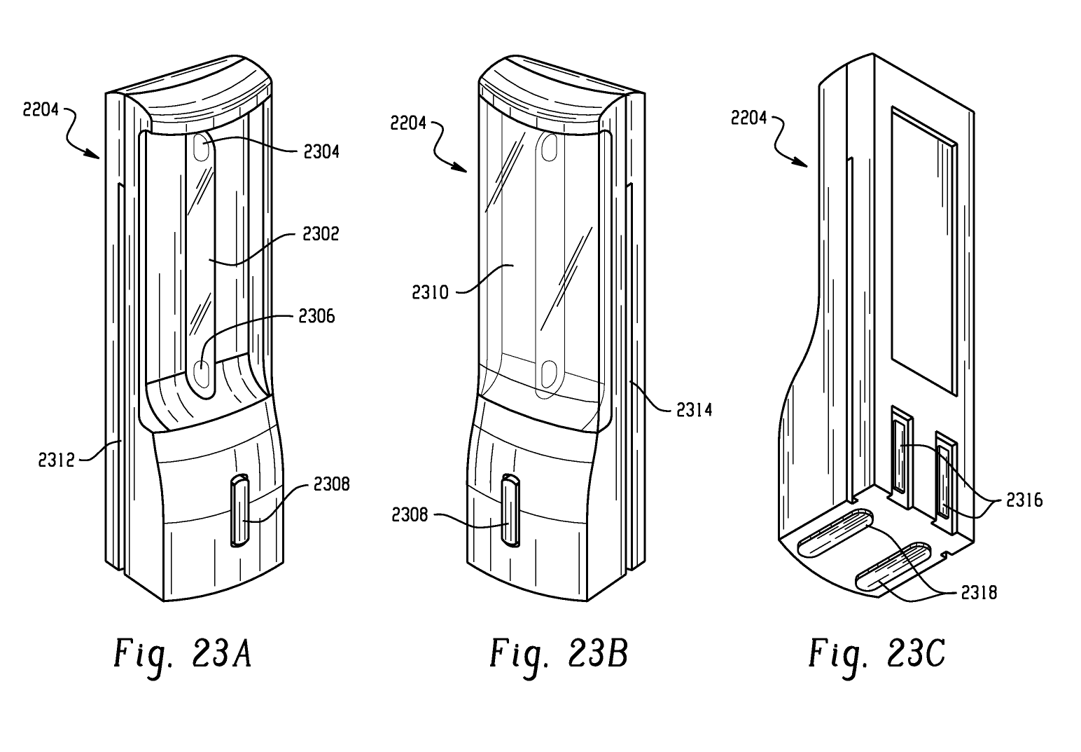

Turning now to FIGS. 23A, 23B, and 23C, the portable lighting appliances 2204 include a light source such as two (2) LEDs 2304, 2306 disposed at the opposite ends of a generally cylindrical light pipe diffuser 2302. The diffuser 2302 is in turn disposed behind a translucent cover 2310 (rendered transparent in FIG. 23A for ease of illustration). In the illustrated embodiment, the translucent cover extends along the sides of the portable lighting appliances 2204 so that an approximately 270 degree illumination is provided. A pushbutton switch 2308 allows a user to operate the light source as desired. Fully depressing the switch 2308 turns the light source 2204 on and off.

The switch also includes an intermediate position. When in the intermediate position, the light source illumination is governed by the power provided by the base 2202. With reference to FIG. 22, the switches 2308 engage a corresponding surface of the base 2202 and are thus maintained in the intermediate position when inserted therein. Longitudinally extending grooves or channels 2312, 2314 ride on the corresponding rails in the respective receiving regions. Electrical contacts 2316 provide electrical contact to the base unit 2202.

The portable lights sources 2204 may be placed vertically or horizontally on a desired surface. Rubberized feet 2318 may be provided on the bottom and/or rear surfaces to facilitate placement on a countertop or other desired surface. Magnets, hooks, clasps, or other desired fasteners may be provided.

While portable lighting appliances 2204 have been described as area lights, one or more of the devices may also be configured to provide a flashlight beam or other desired light output, either addition to or in place of the area light. In one such configuration, the flashlight beam shines downwardly (when the appliance is oriented as shown in FIG. 22A) through a based mounted diffuser, so that the portable lighting appliances 2204 provide a relatively more diffused light when installed in the base.

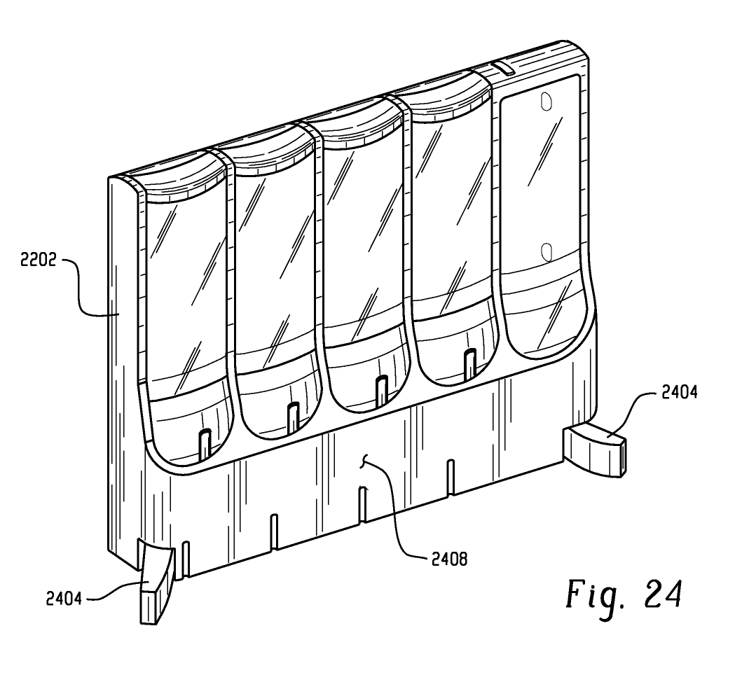

The base 2202 may be configured to facilitate placement or mounting of the appliance 2200 in a plurality of positions, for example suspended underneath a cabinet, placed on a countertop, or mounted to a wall. To this end, the rear side of the base may contain a plurality of mounting bosses or rubberized feet 2252 which facilitate fastening to or placement on a desired surface. Feet 2250 may also be provided to support the base 2202 in a vertical orientation for placement on a horizontal surface. FIG. 24 provides another example of vertical support feet for the base 2202. In FIG. 24, feet 2404 are pivotally mounted to the base 2202 so that they pivot away from a surface 2408 of the base 2202 to provide such support. When not being utilized for support, the feet 2404 can be pivoted towards the surface 2408 of the base 2202.

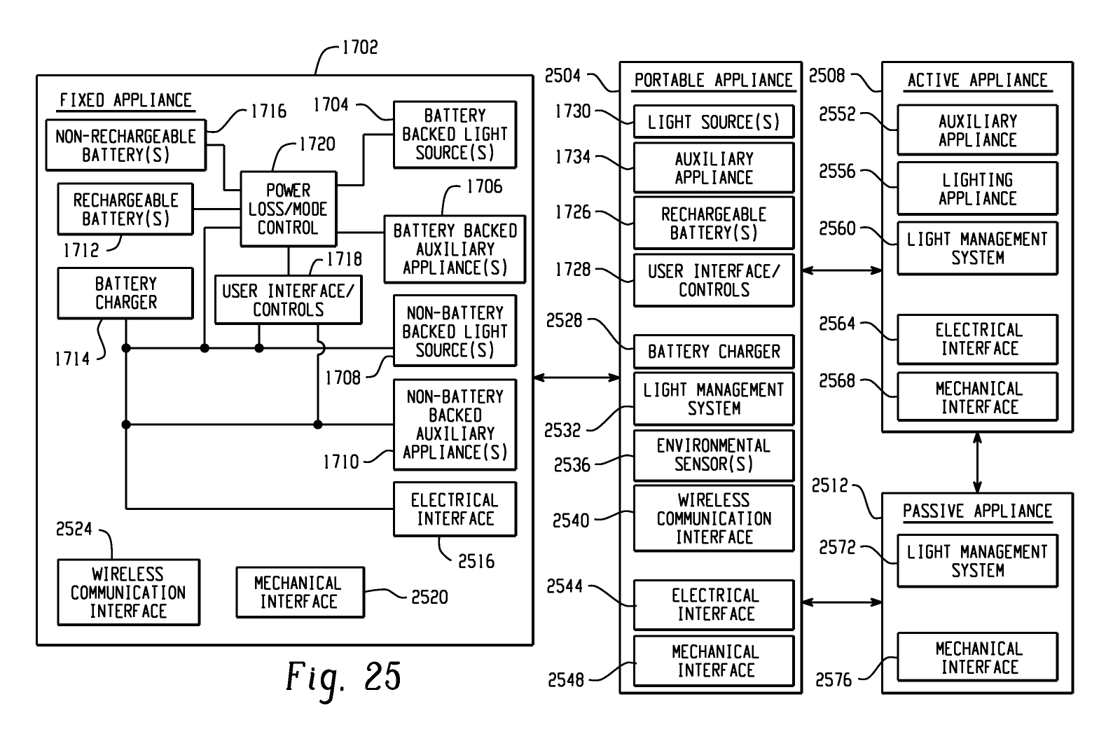

FIG. 25 illustrates a block diagram of a family of appliances including one or more of the fixed appliance 1702, a portable appliance 2504, an active appliance 2508, and a passive appliance 2512.

The fixed appliance 1702 is generally discussed above in connection with FIG. 17. FIG. 25 additionally expressly shows electrical and mechanical interfaces 2516 and 2520 of the fixed appliance 1702. The electrical interface 2516 provides electrical communication with the AC power main and the portable lighting appliance 2504, for example, through an electrical contact(s), inductive coupling, or the like. The mechanical interface 2520 is used for physical placement or mounting of the fixed appliance 1702 to an external physical structure. The mechanical interface 2520 also receives or otherwise mechanically engages the portable appliance 2504. The fixed appliance 1702 optionally further includes one or more optional environmental sensors 2536 and a wireless communication interface 2524. Examples of suitable environmental sensors 2536 include a light sensor, a temperature sensor, and a motion sensor that respectively sense a state of the environment surrounding the fixed appliance 1702. The wireless communication interface 2524 provides one or two way wireless communication with a wireless communication interface of the portable appliance 2504, a wireless remote control, a wireless network, as well as other devices and/or systems having a suitable wireless communication interface. Examples of suitable wireless communication include radio frequency (RF), visible light, and infrared (IR) wireless communication as well as other wireless communication.

The portable appliance 2504 includes one or both of the light source(s) 1730 and the auxiliary appliance 1734. The user interface/controls 1728 provide user operable controls that allow the user to control the operation of the light source(s) 1730 and/or the auxiliary appliance 1734 and may also include one or more human readable status indicators as described above in connection with FIG. 17. The rechargeable battery(s) 1726 provides power that illuminates the light source(s) 1730 and powers the auxiliary appliance 1726 as described above in connection with FIG. 17. An optional battery charger 2528 maintains the charge state of the rechargeable battery(s) 1726 when the portable appliance 2504 is supplied with AC power from the fixed appliance 1702.

The portable appliance 2504 may also include a light management system 2532 that diffuses or otherwise optically influences light emitted by the light source(s) 1730. One or more optional environmental sensors 2536 sense a state of the environment surrounding the portable appliance 2506. An optional wireless communication interface 2540 wirelessly communicates with the wireless communication interface 2524 of the fixed appliance 1702, the remote control, the wireless network, and the other devices and/or systems having a suitable wireless communication interface.

An electrical interface 2544 provides complementary electrical communication with the electrical interface 2516 of the fixed appliance 1702 and receives AC power for powering the various components of the portable appliance 2506 therefrom. The electrical interface 2544 may also receive power from an AC power main. The electrical interface 2516 further provides electrical communication with the active appliance 2508 such as via an electrical contact(s), inductive coupling, or the like. A mechanical interface 2548 2544 provides complementary communication with the mechanical interface 2520 of the fixed appliance 1702, as well as mechanical communication with the active and passive appliance 2508 and 2512 and various surfaces. For instance, the mechanical interface 2548 of the portable appliance 2504 can be placed on or affixed to an external physical structure.

An active appliance 2508 includes one or more of an auxiliary appliance 2552 and a light source(s) 2556 and a light management system 2560. The auxiliary appliance 2552 and the light source(s) 2556 are substantially as described in connection with the auxiliary appliance 1734 and the light source(s) 1730 of FIG. 17, the light management system 2556 is substantially as described in connection with the light management system 2532. An electrical interface 2564 electrically engages the active appliance 2508 with the electrical interface 2544 of the portable appliance 2504 and receives AC power therefrom. The received power powers the auxiliary appliance 2552 and the light source(s) 2528. A mechanical interface 2568 mechanically engages the mechanical interface 2548 of the portable appliance 2508. Where a passive appliance 2512 is used in conjunction with the active appliance 2508, the mechanical interface 2568 mechanically also engages the passive appliance 2508. The mechanical interface 2568 may also be used to physically place or affix the active appliance 2508 on an external physical structure.

A passive appliance 2508 includes a light management system 2572 as substantially as described in connection with the light management system 2532. A mechanical interface 2576 mechanically engages one of the mechanical interface 2548 of the portable appliance 2504 and the mechanical interface 2568 of the active appliance 2508. The mechanical interface 2576 also allows the passive appliance 2508 to be physically placed or affixed to an external structure such as a wall or table.

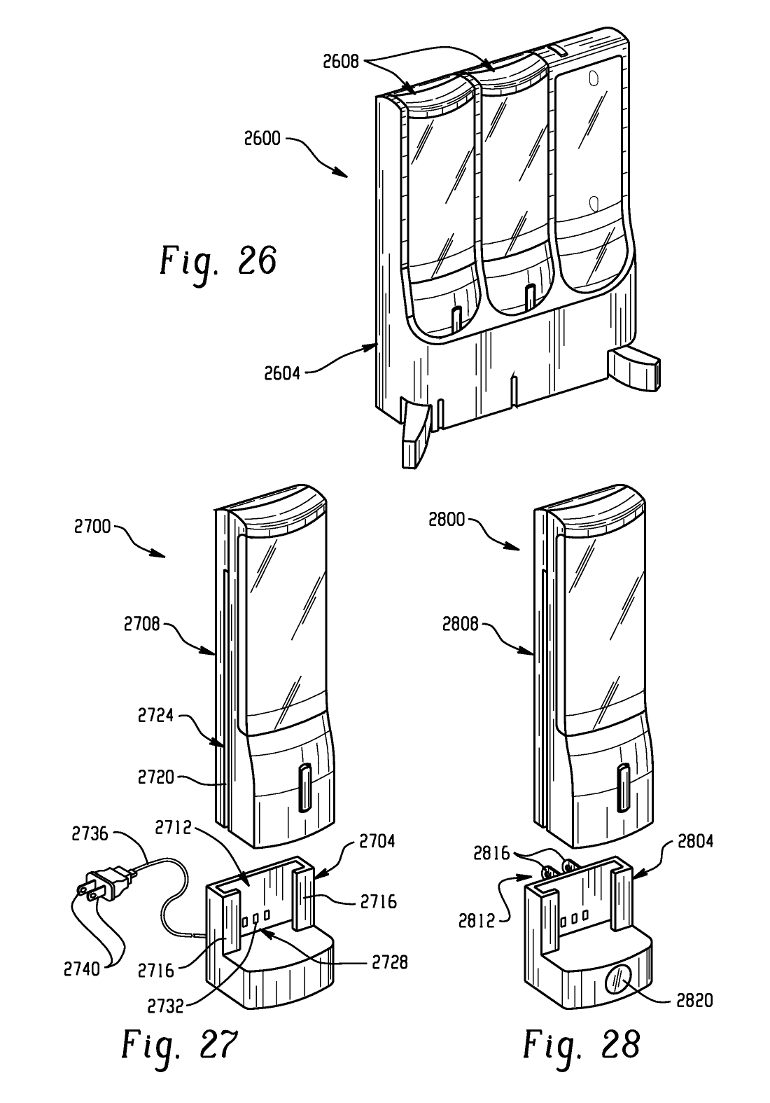

Various configurations are now discussed. A family of appliances are described in relation to FIGS. 26-31. Initially referring to FIG. 26, a hybrid battery powered lighting appliance 2600 includes a fixed appliance 2604 and portable appliances 2608. The fixed appliance 2604 is substantially as described above in connection with the fixed appliance 2202 of FIG. 22. However, in this example the fixed appliance 2604 has two portable appliance receiving regions for respectively receiving and holding two portable appliances 2608. Configurations with less than four, with five, and with more than six receiving regions are also contemplated. The portable appliances 2608 are analogous to the portable appliance 2204 of FIGS. 22 and 23.

Turning to FIG. 27, a removable table top light 2700 includes a fixed appliance 2704 and a portable appliance 2708. The fixed appliance 2704 has a mechanical interface 2712 that receives the portable appliance 2708. As shown, the mechanical interface 2712 includes rails 2716 for receiving complementary slots 2720 of a mechanical interface 2724 of the portable appliance 2708. The fixed appliance 2704 also includes an electrical interface 2728 such as electrical conductive contacts 2732 that engage and electrically communicate with electrical conductive contacts of the portable appliance 2708. The fixed appliance 2704 also includes a battery charger and an electrical cord 2736 having electrical contacts 2740 that receive power from a standard AC receptacle. The portable appliance 2708 is analogous to the portable appliance 2204 of FIGS. 22 and 23.

The removable table top light 2700 is well suited for placement on a horizontal surface such as a counter, table, or desk top. When the portable appliance 2708 is received in the fixed appliance 2704, the battery charger charges the rechargeable battery(s) of the portable appliance 2708 using the power received from the AC receptacle. The portable appliance 2708 may also automatically illuminate in the case of a power failure as described above. The user may also remove the portable appliance 2708 from the fixed appliance 2704, in which case the portable appliance 2708 may be used as a portable light source that is powered by power form the rechargeable battery(s). The user may also place the portable appliance 2708 on a horizontal surface or insert the portable appliance 2708 into one of the portable appliance receiving regions of either of the fixed appliances 2202 or 2604.

Turning next to FIG. 28, a removable night light 2800 includes a fixed appliance 2804 and a portable appliance 2808. The fixed appliance 2804 has an electrical interface 2812 that includes electrically conductive contacts 2816. The electrically conductive contacts 2816 physically plug into a standard AC receptacle and receive AC power therefrom. The fixed appliance 2808 also includes an environmental sensor such as a light sensor 2820 that senses ambient light.

When plugged into an AC receptacle, the fixed appliance 2804 is adjacent and mounted to the AC receptacle. When the portable appliance 2808 is engaged with the fixed appliance 2804, the sensor 2820 senses ambient light, and the light source(s) of the portable appliance 2808 operate based on the sensed ambient light. The portable appliance 2808 may alternatively be manually turned on so that the light source(s) emits light regardless of ambient light.

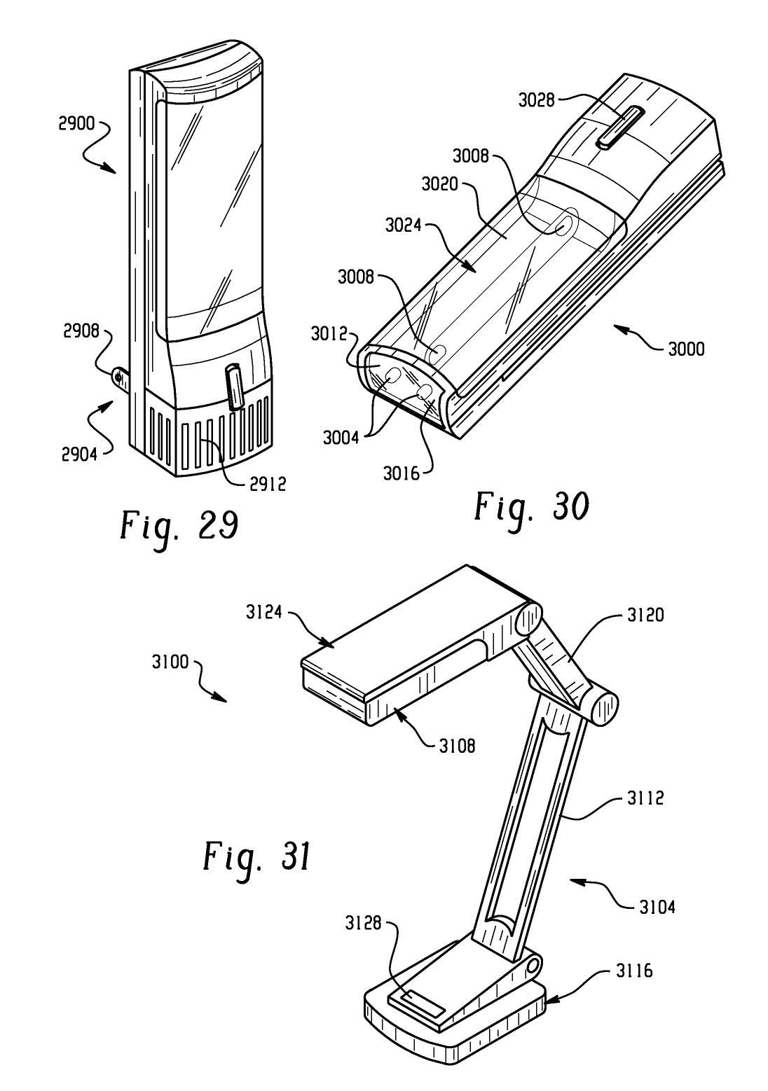

FIG. 29 illustrates a night light portable lighting appliance 2900 having the fixed appliance 1702 and the portable appliance 2504 incorporated within a single unitary device. The portable appliance 2900 includes an electrical interface 2904 such as electrical contacts 2908 that plug into and receive power from a standard AC receptacle. The electrical contacts 2908 are pivotably attached and may be pivoted so that the portable appliance 2900 can be mechanically engaged with a fixed appliance such as one of the fixed appliances 2202, 2504, 2704, and 2804. The night light portable lighting appliance 2900 also includes an environmental sensor such as a motion sensor 2912 that detects motion. The light source(s) of the portable appliance 2900 operate based on the sensed motion. Alternatively, the portable appliance 2900 may alternatively manually turned on to emit light.

FIG. 30 illustrates a portable appliance 3000 having a first light source 3004 and a second light source 3008. The light source 3004 is disposed behind an optical element 3012, and a reflector 3016 directs the light to produce a light beam similar to that of a conventional flashlight. The light source 3008 is disposed behind an optical element 3020, and a diffuser 3024 spreads the emitted light to form an area light. User interface/controls 3028 such as a multi-position switch allow a user to turn on and off the light source 3004, the light source 3008, or both the light sources 3004 and 3008 concurrently.

FIG. 31 illustrates a desk lamp 3100 having a fixed appliance 3104 and a portable appliance 3108. The fixed appliance 3104 includes a first arm 3112 pivotably coupled to a base 3116 of the fixed appliance 3104. A second arm 3120 is pivotably coupled to the first arm 3112 and to a portable appliance-receiving region 3124. The portable appliance 3108 physically and electrically engages the portable appliance-receiving region 3124 through respective electrical and mechanical interfaces. The fixed appliance 3104 further includes user interface/controls 3128.

The desk lamp 3100 is suited for placement on a surface such as a desk or table. When the portable appliance 3108 is engaged with the fixed appliances 3104, the user variously pivots the arms 3112 and 3120 and the portable appliance-receiving region 3124 to direct the light emitted by the light source(s). A user employs the user interface/controls 3128 to operate the portable appliance 3108.

It is to be appreciated that the portable appliances 2708, 2808, 2900, 3000, and 3108 discussed in connection with FIGS. 26-31 are interchangeable in that each can be used with any of the fixed appliances 2202, 2604, 2704, 2804, and 3104. As such, a user may install different fixed appliances in various locations and/or similar fixed appliance at different locations. For example, the user may elect to put a first fixed appliance such as the fixed appliance 2708 in a first location such as a kitchen, another fixed appliance such as the fixed appliance 2808 in a second location such as a basement, and another fixed appliance such as the fixed appliance 3104 in a third location such as a bedroom, as well as other fixed appliances in other locations. The user can then use a desired portable appliance in connection with a desired fixed appliance.

Each of the fixed appliances described above may be provided without a portable appliance. For instance, the four bay fixed appliance 2204 described in connection with FIG. 22 may be sold without any portable appliances. In another example, a replacement four bay fixed appliance 2204 may be obtained without any portable appliances. Likewise, each of the portable appliances described above may be provided without a fixed appliance. For example, a portable appliance 2202 may be sold or obtained without a fixed appliance. Therefore, a user may obtain a fixed appliance based on desired features and install the fixed appliance in a desired location, and obtain a portable appliance based on desired features and use the portable appliance with the fixed appliance. For example, the user may desire an under the counter lighting appliance and a portable appliance having a spot light and an area light. In this case, the user may obtain the fixed appliance 2200 and the portable appliance 3000.

A fixed appliance(s) and a portable appliance(s) may also be provided together. When packaged as such, the number of portable appliances provided with the fixed appliance(s) may represent a number of portable appliances for partially populating the fixed appliance(s) or fully populating the fixed appliance(s), with or without one or more spare portable appliances. The number and type of portable appliances and fixed appliances packaged together may be a default configuration or customized configuration based on a user preference.

By way of example, the four bay fixed appliance 2204 may be provided with one, two, three, four, five or more portable appliances. The portables appliances may all be the same type of portable appliance such as the portable appliance 2204 or include one or more of the portable appliances 2204 and one or more of the portable appliances 2804, as well as one or more of other portable appliances. A second fixed appliance such as another four bay fixed appliance 2204 or a different fixed appliance such as the table top fixed appliance 2704 may also be included with the four bay fixed appliance 2204 and portable appliances.

It is to be appreciated that the fixed appliances 700, 1608, and 1800, which are respectively described above in connection with FIGS. 7A, 16C, and 18 may be adapted for use with the portable appliances 2204, 2608, 2708, 2808, 2900, 3000, and 3104, or vice versa. Furthermore, the passive appliances 720 and 1610, which are respectively described above in connection with FIGS. 7B, 16A, and 16B may be adapted for use with the portable appliances 2204, 2608, 2708, 2808, 2900, 3000, and 3104, or vice versa. It is also to be appreciated that the lamps 100, 200, 500, and 602 described in connection with FIGS. 1A, 2A, 3, 4A, 5A, and 6 may be adapted to receive the portable appliances 2204, 2608, 2708, 2808, 2900, 3000, and 3104, or vice versa.

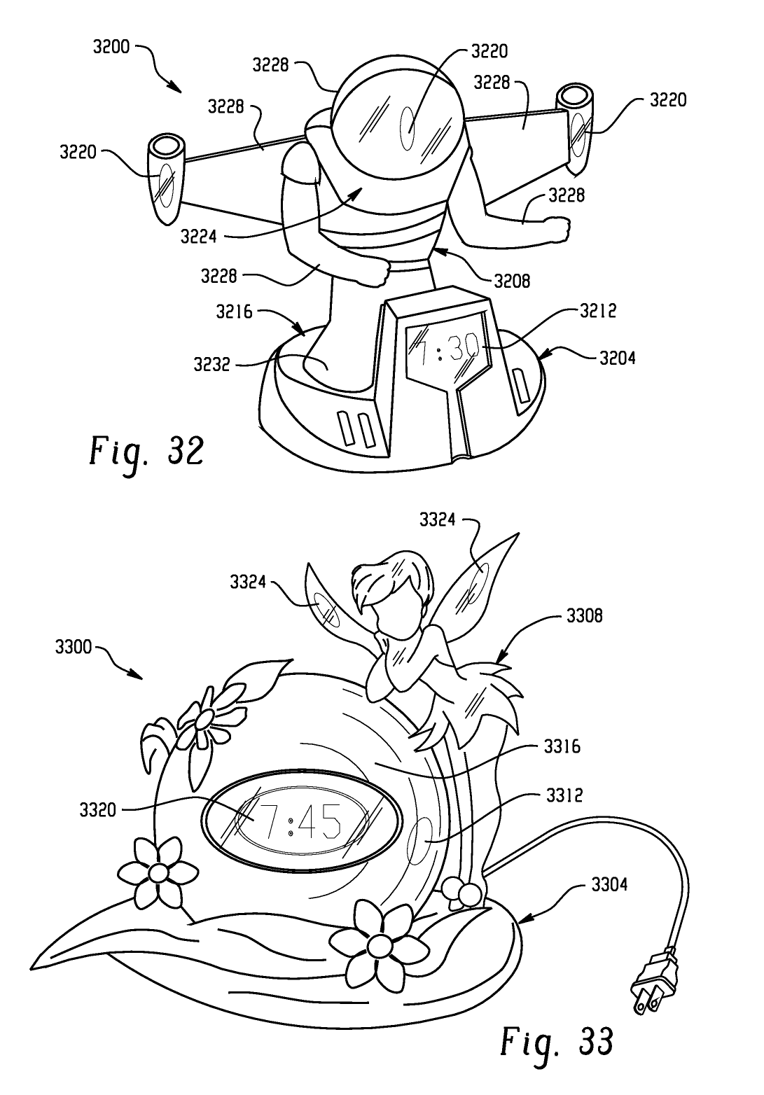

FIGS. 32-34 illustrate alarm clock appliances. The alarm clock appliances are shown as children's fantasy characters. It is to be appreciated that the illustrated characters are provided for explanatory purposes and are not limiting.

Initially referring to FIG. 32, an alarm clock appliance 3200 that includes a fixed appliance 3204 and a portable appliance 3208 is illustrated. The fixed appliance 3204 includes a non-battery backed auxiliary appliance such as an alarm clock 3212, which includes a visual indicator such as a human readable display and an audible indicator such as a beeper or a speaker. User interface/controls provide a user operable control(s) for adjusting the time, setting an alarm time, deactivating a sounding alarm, or otherwise operate the appliance. The fixed appliance 3204 also includes a receiving region 3216 having an electrical and a mechanical interface for electrically and mechanically engaging the portable appliance 3208. The fixed appliance 3204 further includes a battery charger and a wireless communication interface.

The portable appliance 3208 includes a light source(s) 3220 and an auxiliary appliance 3224. The auxiliary appliance 3224 includes one or more actuators that are activated to selectively move moveable structures such as appendages 3228 in response to events or stimuli such as an alarm condition. User interface/controls of the portable appliance 3208 allow a user to control operation of the light source(s) 3220 and the auxiliary appliance 3224 when the portable appliance 3208 is removed from the fixed appliance 3204. A mechanical interface 3232 mechanically engages the mechanical interface in the receiving region 3216. The mechanical interface 3232 can also be used to place the portable appliance 3208 in an ordinary upright position on a table or other surface. An electrical interface of the portable appliance 3208 electrically engages the electrical interface in the receiving region 3216. The portable appliance 3208 also includes a rechargeable battery(s) that power the light source(s) 3220 and the auxiliary appliance 3224. A wireless communication interface provides wireless communication, for example, with wireless interface of the fixed appliance 3204.

A user places the fixed based 3204 at a desired location such as a bedside table. The user may use the user interface/controls of the fixed appliance 3204 to adjust the time and/or set the alarm to sound at a particular time. If an alarm time is set, when the alarm time is reached the fixed appliance 3204 communicates a first or activation signal to the portable appliance 3208. If the portable appliance 3208 is engaged with the fixed appliance 3204, the signal may be communicated via respective electrical interfaces. Otherwise, the signal is communicated via respective wireless communication interfaces.

The signal causes the portable appliance 3208 to react or respond to the alarm condition. Examples of suitable responses include one or more of turning the light source(s) 3220, toggling the light source(s) 3220 on and off, outputting audio such as one or more beeps or a voice message, and/or activating one or more actuators to cause the moveable structures 3228 to move, or otherwise indicate the alarm condition. The user may use the user interface/controls of the fixed appliance 3204 to likewise send a second or deactivation signal to terminate such response. Alternatively, the user may use the user interface/controls of the portable appliance 3208 to likewise send a second or deactivation signal to terminate such response. The user may also employ the user interface/controls of the fixed appliance 3204 to invoke the fixed appliance 3204 to send the activation signal to the portable appliance 3208. Activating the portable appliance 3208 as such may facilitate locating an otherwise lost portable appliance.

The user may also use the portable appliance 3208 as a lamp. For example, the user can manually turn the light source 3220 on and off. The user may also remove the portable appliance 3208 from the fixed appliance 3204 and use the portable appliance 3202 as a light source.

Turning to FIG. 33, an alarm clock appliance 3300 includes a fixed appliance 3304 and a portable appliance 3308. The fixed appliance 3304 includes a non-battery backed light source 3312 disposed behind a translucent globe or lens 3316. The fixed appliance 3304 also includes a non-battery backed auxiliary appliance such as an alarm clock 3320, which is substantially as described above in connection with FIG. 32. The portable appliance 3208 includes a light source(s) 3324.

When an alarm time is reached, power is provided for continuously or periodically turning on the light source 3312 to indicate the alarm condition. If the portable appliance 3308 is engaged with the fixed appliance 3304, the power is also provided to the portable appliance 3308 for continuously or periodically turning on the light source(s) 3324. When the portable appliance 3302 is removed from the fixed appliance 3301, the portable appliance may be placed on or affixed to a structure and used a lamp or may be used as a hand-held flashlight as described above.

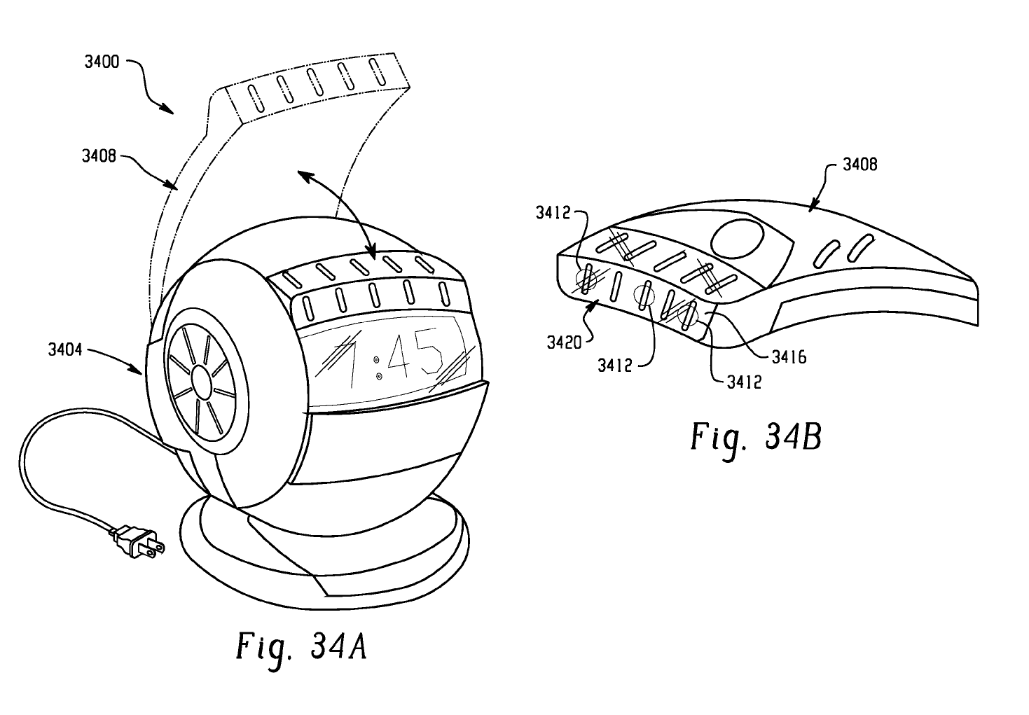

FIG. 34 illustrates an alarm clock appliance 3400, which includes a fixed appliance 3404 and a portable appliance 3408. In this example, the fixed appliance 3404 includes a mechanical interface that pivotably receives the portable appliance 3408. The portable appliance 3408 includes a complementary mechanical interface. The portable appliance 3408 also includes a light source(s) 3412 disposed behind a translucent optical element 3416 and a light management system 3420. When the portable appliance 3408 is engaged with the fixed appliance, a user may pivot the portable appliance 3402 to variously direct the light emitted by the light source(s) 3412.

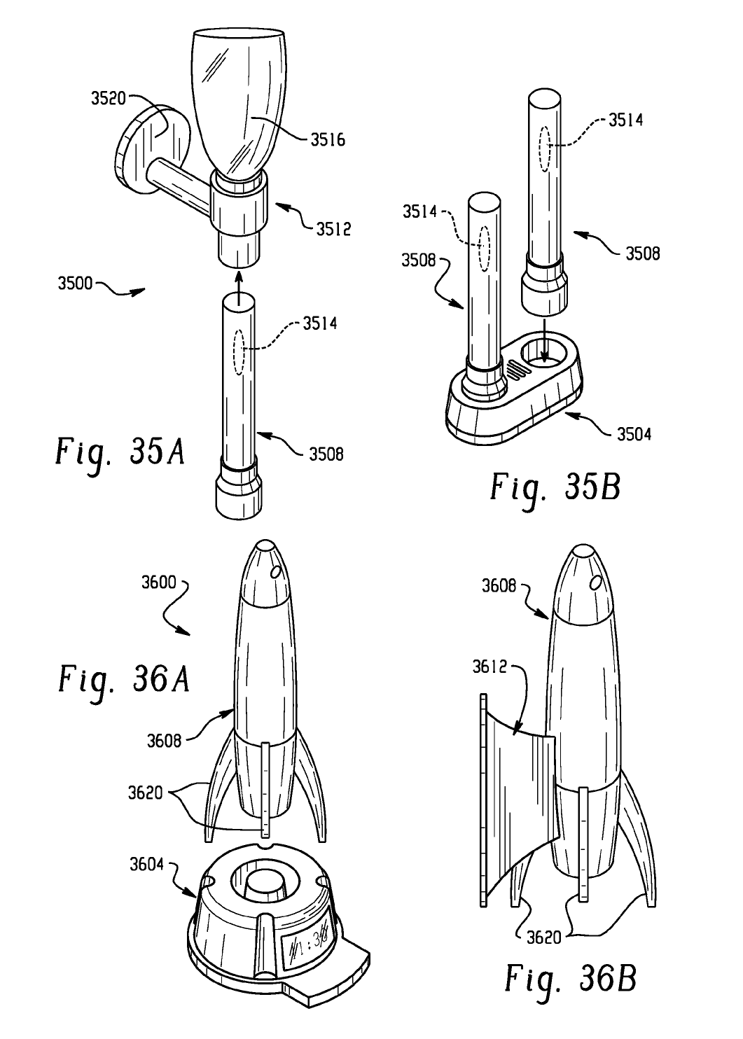

FIGS. 35-37 illustrate various wall or sconce lights. Initially referring to FIG. 35, a sconce light 3500 includes a portable appliance 3508 and a passive appliance 3512.

The portable appliance 3508 includes a light source(s) 3514, a wireless communication interface, and user interface/controls such as a switch. The passive appliance 3512 includes a complementary mechanical interface that mechanically engages the mechanical interface of the portable appliance 3508. The mechanical interface of the passive appliance 3512 includes a light management system 3516 and a mounting bracket 3520. The light management system 3516 is removable and can be replaced by a similar or different light management system. A fixed appliance 3504 receives the portable appliance 3508 and charges a rechargeable battery(s) of the portable appliance 3508 as described above.

A user affixes the passive appliance 3512, via the mounting bracket 3516, to another structure such as a mounting bracket affixed to a wall. For instance, the mounting bracket 3520 may include a material free region(s) such as a slot(s) or a hole(s) through which the user inserts a suitable screw to mechanically fasten the screw to a complementary threaded screw hole in the wall bracket. The user may change the light management system 3516 before or after installing the passive appliance 3512. A light source(s) of the portable appliance 3508 may then be operated by a signal transmitted to the wireless communication interface of the portable appliance 3508 by a wireless communication interface of a remote control or the wireless communication interface of the fixed appliance 3504. The user may alternatively manually operate the light source(s) 3514 via the user interface/controls. The portable appliance 3508 may also be automatically operated in the case of a power failure as described above. The user may remove the portable appliance 3508 from the passive appliance 3504 and place or affix it to an external surface or use it as a hand-held light as described above, or insert it in the fixed appliance 3504 to charge the batteries of the portable appliance 3504.

FIGS. 36A and B illustrate a sconce light 3600 configured as a children's fantasy spaceship. As shown in FIG. 36A, the sconce light 3600 includes a portable appliance 3608 which engages a fixed appliance 3604 for charging a rechargeable battery(s) of the portable appliance 3608 as described above. As shown in FIG. 36B, the portable appliance 3608 includes a mechanical interface having a mounting structure 3612 that can be mechanically engaged with a structure such as a mounting bracket affixed to a wall. FIGS. 36A and B show that the mechanical interface further includes a plurality of feet 3620 for placing the portable appliance 3608 on a surface or within the fixed appliance 3604 when the portable appliance is removed from the wall bracket.

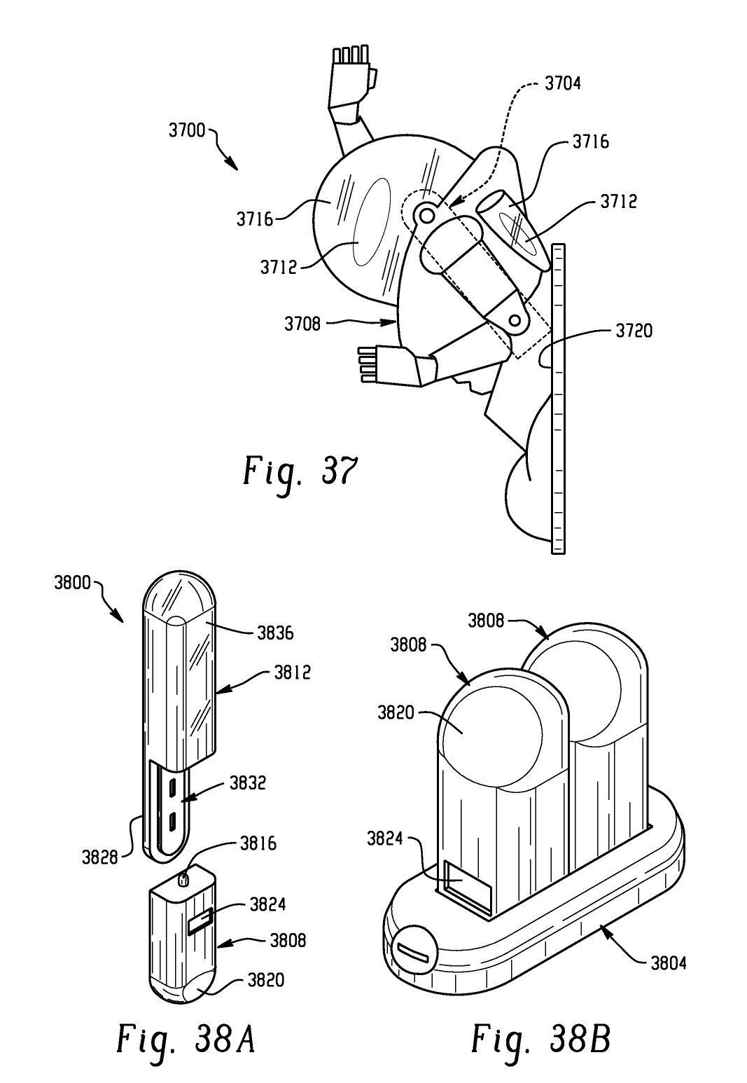

Referring now to FIG. 37, a sconce light 3700 includes a portable appliance 3704 and an active appliance 3708. The sconce light 3700 is shown as a children's fantasy character. The portable appliance 3704 includes a rechargeable battery(s) and an electrical interface as described above. The active appliance 3708 includes a light source(s) 3712, a light management system 3716, an auxiliary appliance such as an audible indicator, user interface/controls, an electrical interface, a portable appliance-receiving region, and a mechanical interface 3720 that can be mechanically affixed to a physical structure such as a mechanical holster affixed to a wall.

A user electrically and mechanically engages the portable appliance 3704 with the active appliance 3708. When engaged as such, respective electrical interfaces electrically communicate, and power from the rechargeable battery(s) provides power for powering the light source(s) 3712 and the auxiliary appliance. The user employs the user interface/controls to turn the light source(s) 3712 on and off. The user may remove the active appliance 3708 and hence portable appliance 3704 from the holster and user the active appliance 3708 and hence portable appliance 3704 as a hand-held light device. The rechargeable battery(s) removed from the active appliance 3708 and engaged with a suitable fixed appliance where the rechargeable battery(s) can be recharged. The rechargeable battery(s) may also be replace by another rechargeable battery(s).

FIG. 38 illustrates a motion light 3800 having a portable appliance 3808 and a passive appliance 3812. The portable appliance 3808 includes a rechargeable battery(s), a light source(s) 3816, user interface/controls 3820, and motion sensor 3824. The passive appliance 3812 includes a mechanical interface having a mounting region 3828 for physically affixing the passive appliance 3812 to a structure such as a wall and a portable appliance receiving region 3832 for mechanically and electrically receiving the portable appliance 3808. The passive appliance 3812 further includes a light management system 3836. The rechargeable battery(s) can be charged via a fixed appliance 3804 having a battery charger and a plurality of portable appliance receiving regions as described above.

When the portable appliance 3808 is engaged with the passive appliance 3812, the motion sensor 3824 senses motion and the light source(s) 3816 is operated based on the sensed motion. Light emitted by the light source(s) 3816 is diffused or otherwise influenced by the light management system 3836. The user may alternatively manually operate the light source(s) 3816 via the user interface/controls 3820 of the portable appliance 3808. In an alternative implementation, the portable appliance 3808 includes a one or two-way wireless communication interface. As such, the light source(s) 3816 of the portable appliance 3808 can be operated via a remote control wirelessly communicating with the wireless communication interface of the portable appliance 3808.

It is to be appreciated that the user may selectively install the passive appliance 3812 in various locations where the user desires to use the portable appliance 3808. For instance, the user may install the passive appliance 3812 outside, for example, next to an entrance/exit door of a house. The user may then operate the light source(s) 3812 via the remote, for example, when leaving or returning home. Additionally or alternatively, the sensor 3820 can operate the light source(s) 3812, for example, when someone approaches the door. Other suitable locations include a closet, a step in a stairwell, and other desirable locations. When installed in a closet, the motion sensor 3812 senses when the closet door opens and accordingly operates the light source(s) 3812.

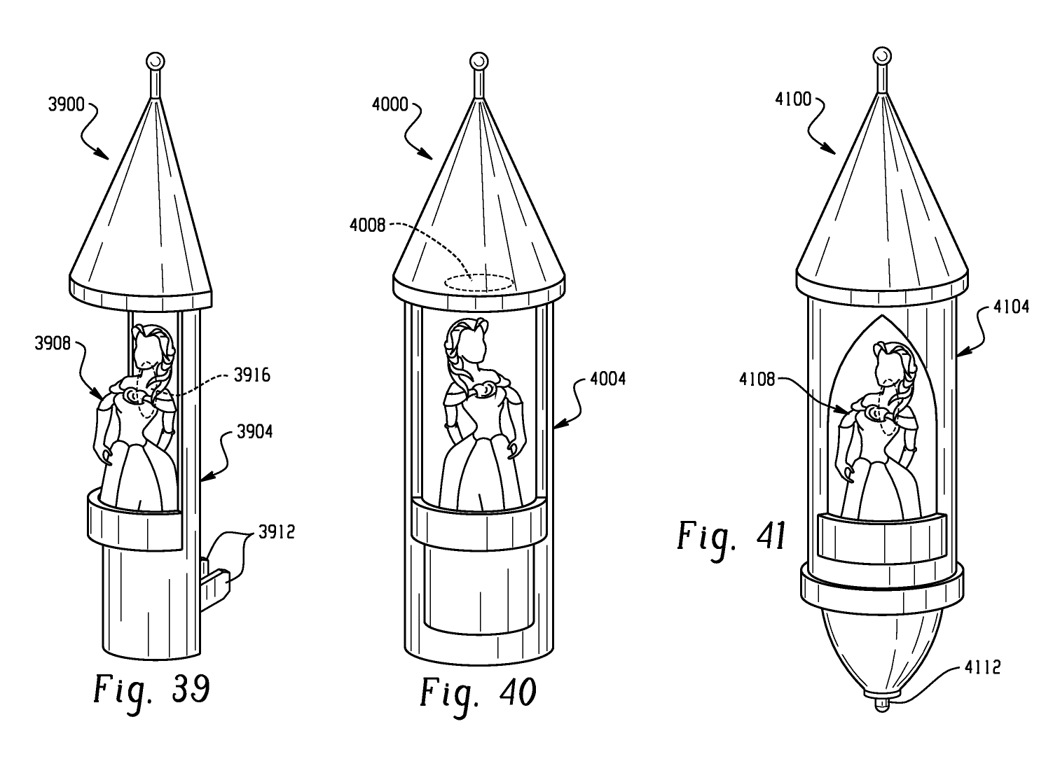

FIGS. 39-41 illustrate various nightlights shown as children's fantasy characters. FIG. 39 illustrates a nightlight 3900 that includes a fixed appliance 3904 and a portable appliance 3908. The fixed appliance 3904 includes an electrical interface having electrical contacts 3912 for physically and electrically engaging a standard AC receptacle and receiving AC power therefrom. Physically engaging the AC receptacle with the electrical contacts 3912 affixes the fixed appliance 3904 to the AC receptacle. The portable appliance 3908 includes a light source(s) 3912 and a rechargeable battery(s), and mechanically and electrically engages the fixed appliance 3904 via complementary mechanical and electrical interfaces as described above. When the portable appliance 3908 is engaged with the fixed appliance 3904 and the electrical contacts 3912 are engaged with the AC receptacle, AC power is received and provided to power the light source(s) 3916. When the portable appliance 3908 is removed from the fixed appliance 3904, the rechargeable battery(s) provides power for powering the light source(s) 3916.

FIG. 40 illustrates a nightlight 4000 having a fixed appliance 4004. The fixed appliance 4004 includes a rechargeable battery(s), a battery charger, and a battery-backed light source(s) 4008. When the fixed appliance is engaged with a standard AC receptacle, AC power received from the receptacle powers the light source(s) 4008 and is used by the battery charger to maintain the charge state of the rechargeable battery(s). In the case of an AC power failure, the rechargeable battery(s) provides power that powers the light source(s) 4008.

FIG. 41 illustrates a nightlight 4100 having a fixed appliance 4104 and a portable appliance 4108. The fixed appliance 4104 and portable appliance 4108 are as substantially described above in connection with the fixed appliance 3904 and the portable appliance 3908 in FIG. 39. The fixed appliance 4104 further includes a sensor 4112 such as a light or motion sensor that senses ambient light or motion. Power is provided to the light source(s) of the portable appliance 4104 based on the sensed light or motion.

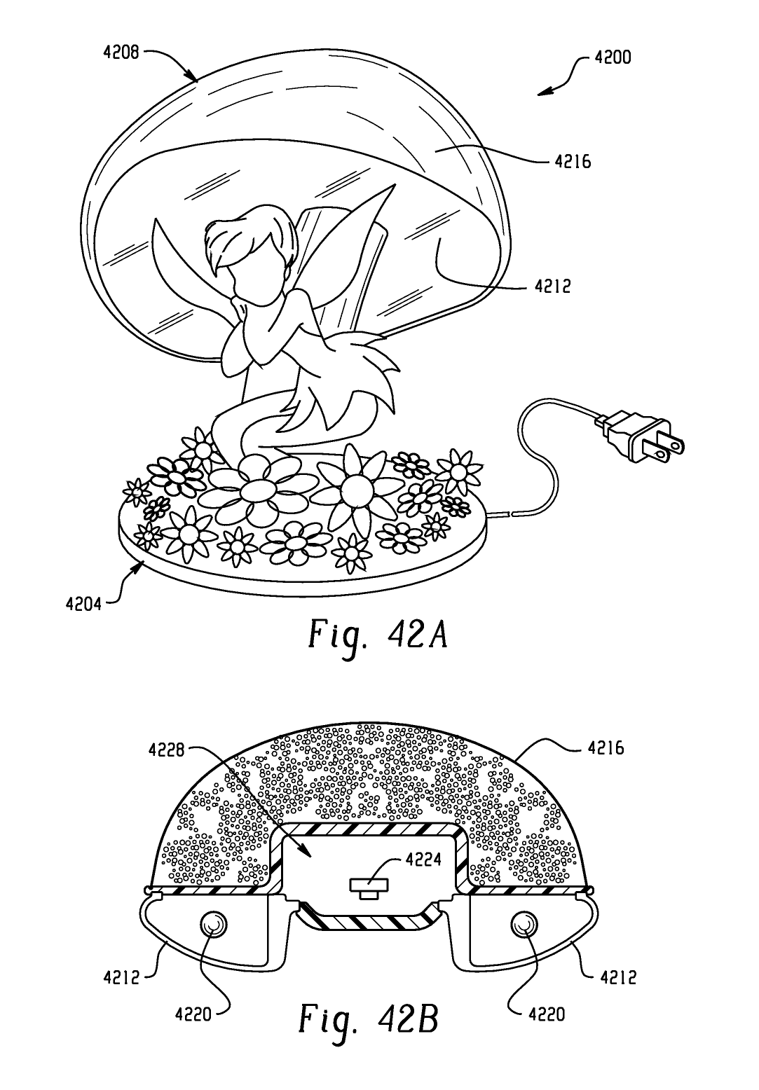

FIGS. 42-46 illustrate various bedside lighting appliances. Initially referring to FIG. 42, a bedside lighting appliance 4200 includes a fixed appliance 4204 and a portable appliance 4208. In this example, the portable appliance 4208 includes an optical surface such as a lens 4212 operatively coupled to a generally deformable body or portion 4216. A light source(s) 4220 is disposed behind the lens 4212. User interface/controls provide a user operable control such as a push-button switch 4224 for turning the light source(s) 4212 on and off. A battery-receiving region 4228 receives a rechargeable or non-rechargeable battery(s) that powers the light source(s) 4220. The generally deformable portion 4216 includes a beanbag, polymeric, or other deformable structure, which can be variously shaped to conform to a shape of a surface or otherwise direct light diffused by the lens 4212. A user may alternatively physically hold or otherwise engage the generally deformable portion 4216 to manually direct the emitted light.

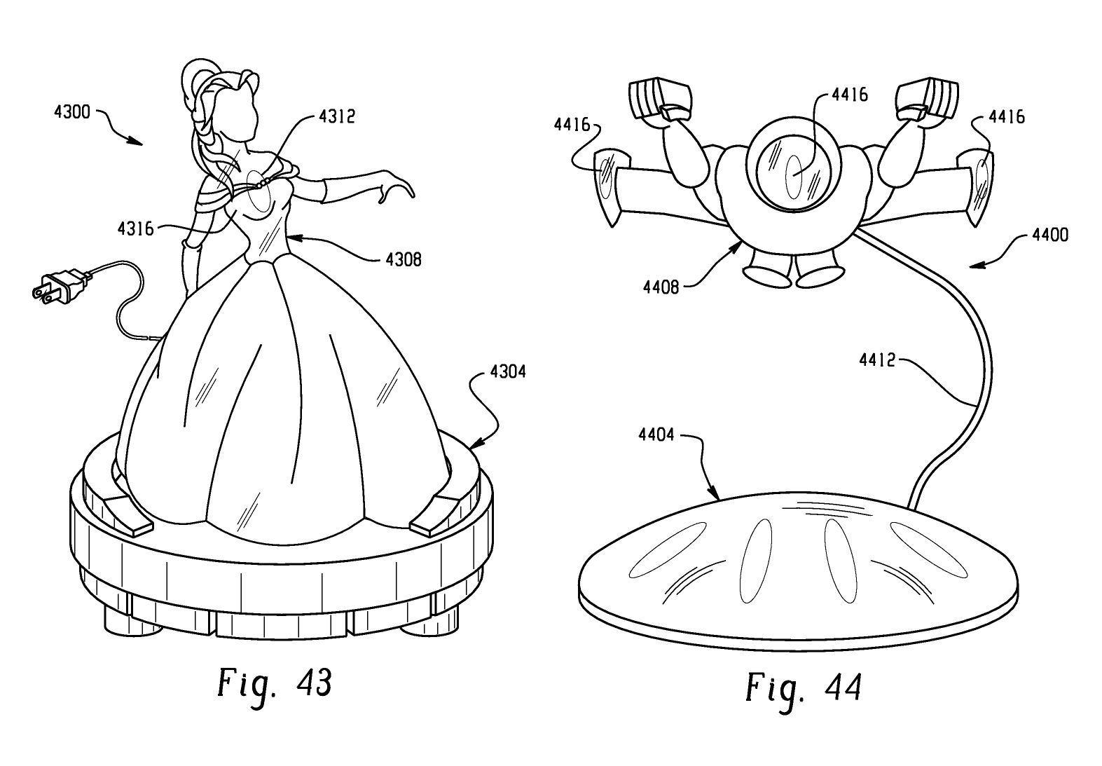

Turning to FIG. 43, a bedside lighting appliance 4300 includes a fixed appliance 4304 and a portable appliance 4308. In this example, the portable appliance 4308 includes a light source(s) 4312 disposed behind a translucent shell 4316. As described above, the portable appliance 4308 may be electrically and mechanically engaged with the fixed appliance 4304 or removed therefrom and placed on an external surface. In either instance, when the light source(s) 4312 is energized, the light source(s) 4312 emits light, and the translucent shell 4316 diffuses the emitted light to produce an area light.

FIG. 44 depicts a bedside lighting appliance 4400 that includes a fixed appliance 4404 and a portable appliance 4408. The fixed appliance 4404 includes a flexible mechanical interface 4412 that mechanically engages a mechanical interface of the portable appliance 4408. The fixed appliance 4404 further includes an electrical interface, which can be routed by the flexible mechanical interface 4412 that electrically engages an electrical interface of the portable appliance 4408. The portable appliance includes a light source(s) 4416 and a rechargeable battery(s). The user variously flexes the flexible mechanical interface 4412, which variously positions the directed light. For example, the user can bend or straighten various sections of the flexible mechanical interface 4412 to change the direction of emitted light. The portable appliance 4408 may be disengaged from the fixed appliance 4404 and used as a hand-held light device. When disengaged as such, the rechargeable battery(s) provides power for the light source(s) 4416.

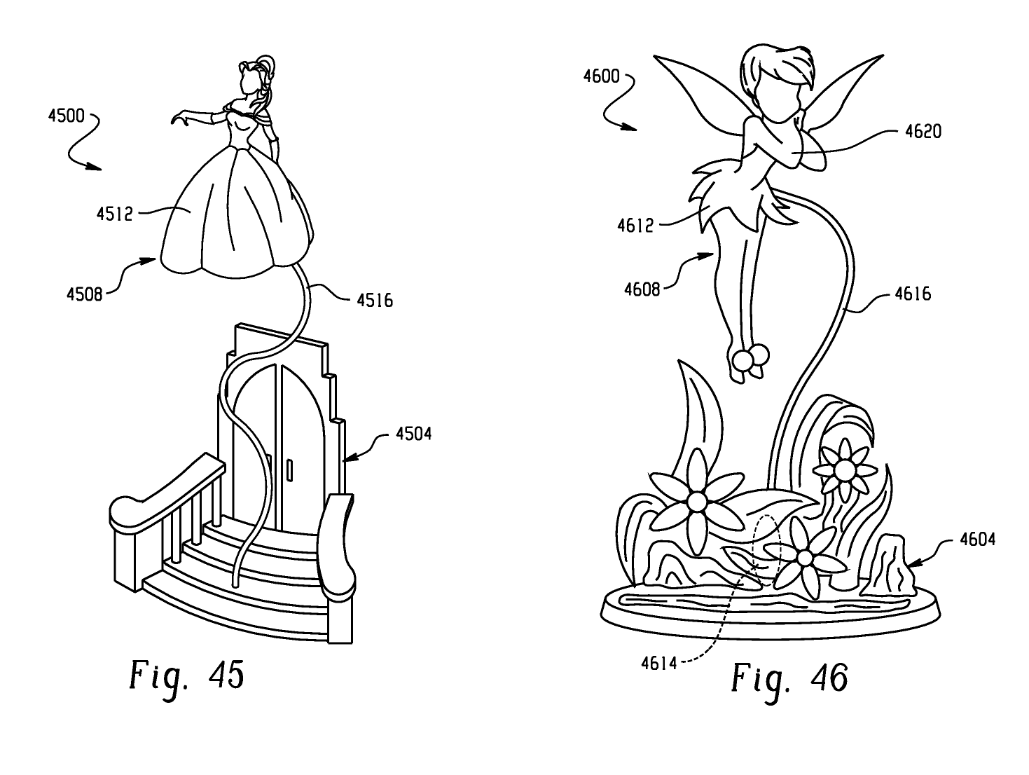

FIG. 45 illustrates a bedside lighting appliance 4500 having a fixed appliance 4504. The fixed appliance 4504 includes a non-battery backed light source(s) 4508 disposed within a light management system such as a translucent shell 4512. The fixed appliance 4504 further includes a flexible mechanical interface 4516, which is analogous to the flexible mechanical interface 4412 described above in FIG. 44. The user can variously flex the flexible mechanical interface 4412 as described above. The translucent shell 4512 diffuses light emitted by the light source(s) 4512 to produce an area light.

In FIG. 46, a bedside lighting appliance 4600 includes a fixed appliance 4604, a portable appliance 4608, and a passive appliance 4612. The fixed appliance 4604 includes non-battery backed light source(s) 4614 and a flexible mechanical interface 4616 to which the portable appliance 4608 mechanically and electrically engages as described above. The portable appliance 4608 includes a light source(s) and a rechargeable battery(s). The passive appliance 4612 includes a portable appliance-receiving region for receiving the portable appliance 4608 and a light management system 4620. AC power received by the fixed appliance provides power for powering the non-battery backed light source(s) 4614 and the light source(s) of the portable appliance 4608 and for charging the rechargeable battery(s).

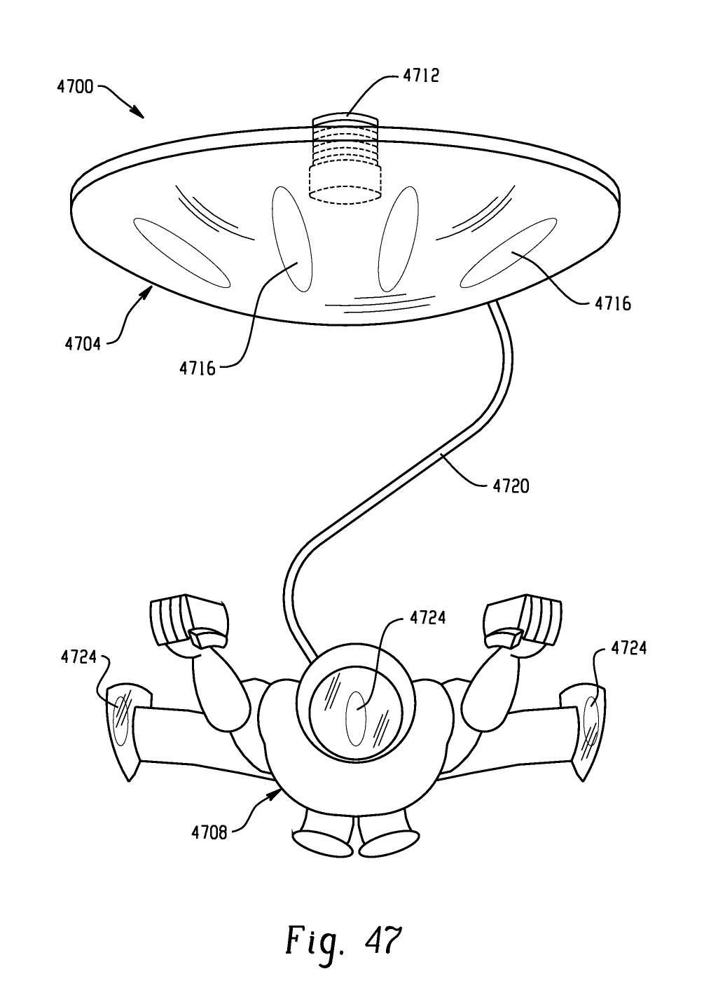

FIGS. 47-49 illustrate various pendant lights configured as children's fantasy characters. Initially referring to FIG. 47, a pendant light 4700 includes a fixed appliance 4704 and a portable appliance 4708. The fixed appliance 4704 includes an electrical interface such as an electrical adapter 4712 that is received in a light receptacle such as an incandescent light, light receptacle. The electrical interface includes an electrical contact that electrically engages and receives AC power from an electrical contact of the light receptacle. The fixed appliance 4704 further includes a non-battery back light source(s) 4016 that is powered by the power received by the electrical contact of the adapter 4712. The fixed appliance 4704 further includes a flexible mechanical interface 4720 that mechanically engages a mechanical interface of the portable appliance 4708. The portable appliance 4708 includes a light source(s) 4724 and a rechargeable battery(s).

A user mechanically connects the adapter 4712 to a light receptacle. The electrical contact of the adapter 4712 electrically contacts and electrically communicates with the electrical contact of the light receptacle. When AC power is provided to the light receptacle, for example, when a light switch in the electrical path to the light receptacle is placed in a closed position by a user, the electrical contact of the adapter 4712 receives AC power. The received AC power provides power for powering the non-battery backed light source(s) 4716 and the light source(s) 4724. The received AC power also provides power for maintaining the charge state of the rechargeable battery(s). When the portable appliance 4708 is disengaged from the flexible mechanical interface 4720, the rechargeable battery(s) provides power for powering the light source(s) 4724.

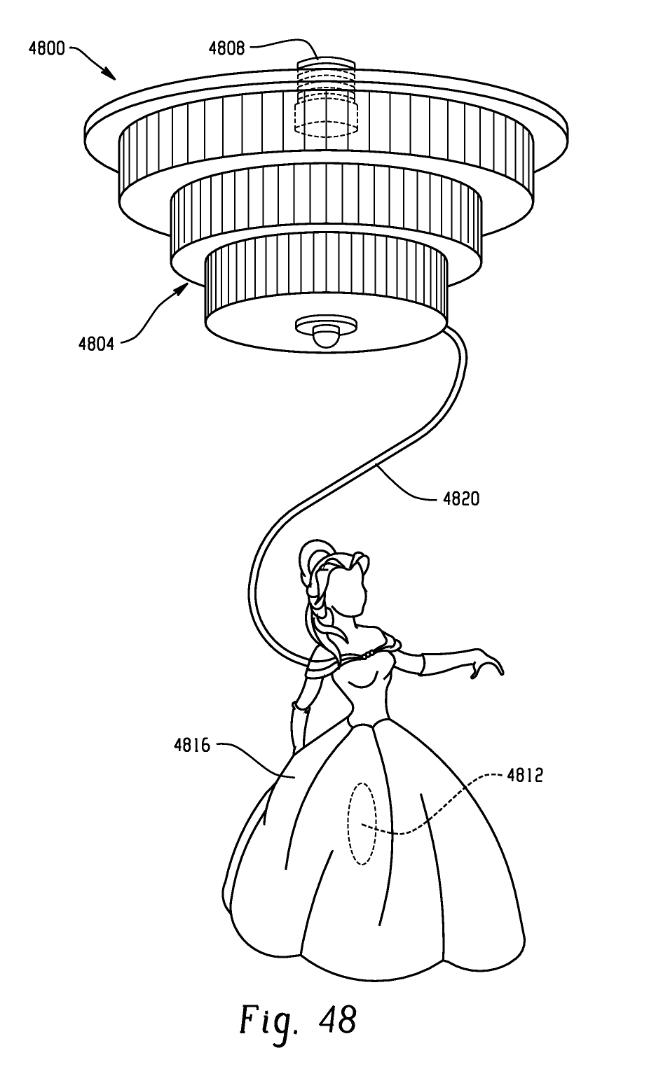

With respect to FIG. 48, a pendant light 4800 includes a fixed appliance 4804 having an adapter 4808 as substantially described above in connection with the adapter 4712 of FIG. 47. The fixed appliance 4804 also includes a non-battery backed light source(s) 4812 disposed within a light management system 4816 and a flexible mechanical interface 4820 as described above. The fixed appliance 4804 is affixed to the light receptacle via the adapter 4808 and receives AC power as described above. The light management system 4816 diffuses light emitted by the non-battery backed light source(s) 4812 to produce an area light.

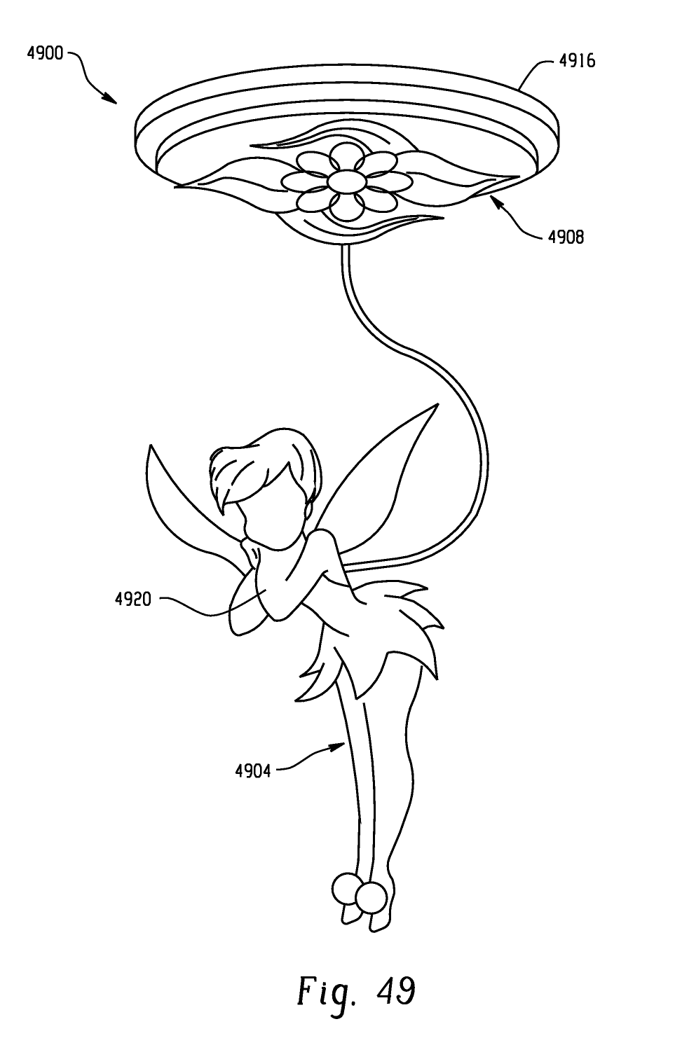

In FIG. 49, a pendant light 4900 includes a portable appliance 4904 and a passive appliance 4908. The portable appliance 4904 includes light source(s), a rechargeable battery(s), and a mechanical interface 4916 for attaching the portable appliance 4904 to a surface such as a ceiling or wall. The passive appliance 4908 includes a light management system 4920. The portable and passive appliances 4904 and 4908 electrically and mechanically engage as described above. The pendant light 4900 is well-suited for being affixed to ceiling that otherwise does not have a light receptacle.

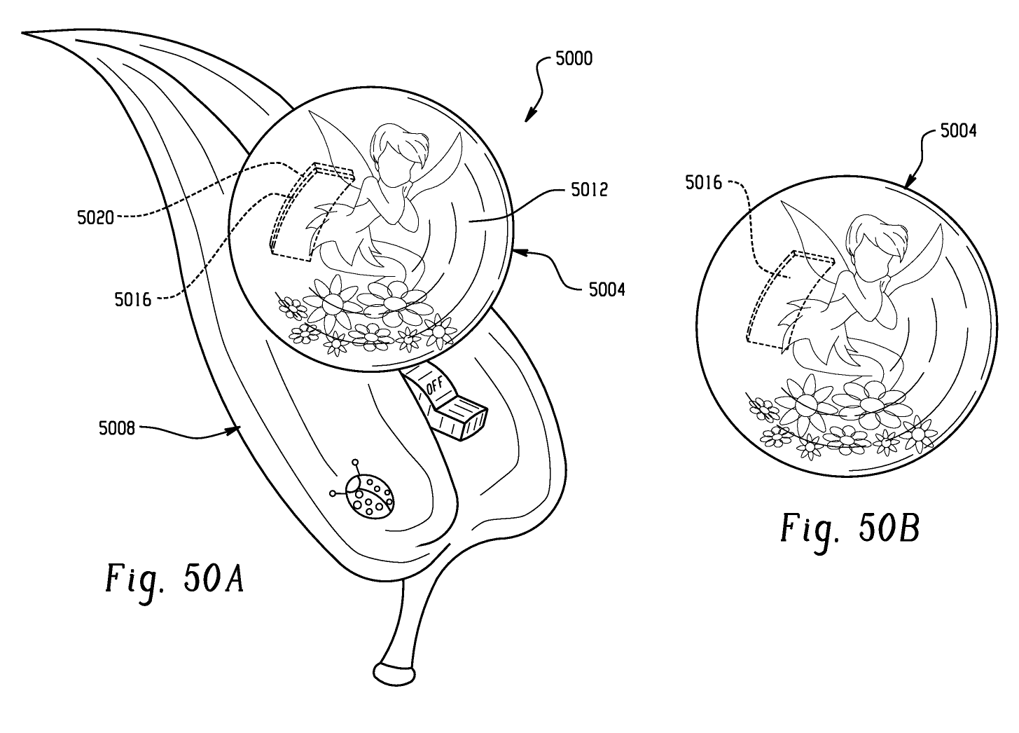

FIG. 50 illustrate a lighting appliance 5000 having a portable appliance 5004 and a passive appliance 5008. The portable appliance 5004 includes a rechargeable battery(s) and a light source(s) 5012. The portable appliance 5004 also has a mechanical interface such as a magnet 5016. The passive appliance 5008 includes a ferromagnetic region 5020 for magnetically engaging the magnet 5016. When the magnet 5016 of the portable appliance 5004 is engaged with the ferromagnetic region 5020, a switch such as a magnetic of the portable appliance 5004 turns off the light source(s) 5012. When the magnet 5016 of the portable appliance 5004 is removed from the ferromagnetic region 5020, the switch turns the light source(s) 5012 on. As such, the portable appliance 5004 can be removed from the passive appliance 5008 and used as a hand-held or other light device. The portable appliance 5004 can be adapted to engage a fixed appliance in order to charge the rechargeable battery(s).

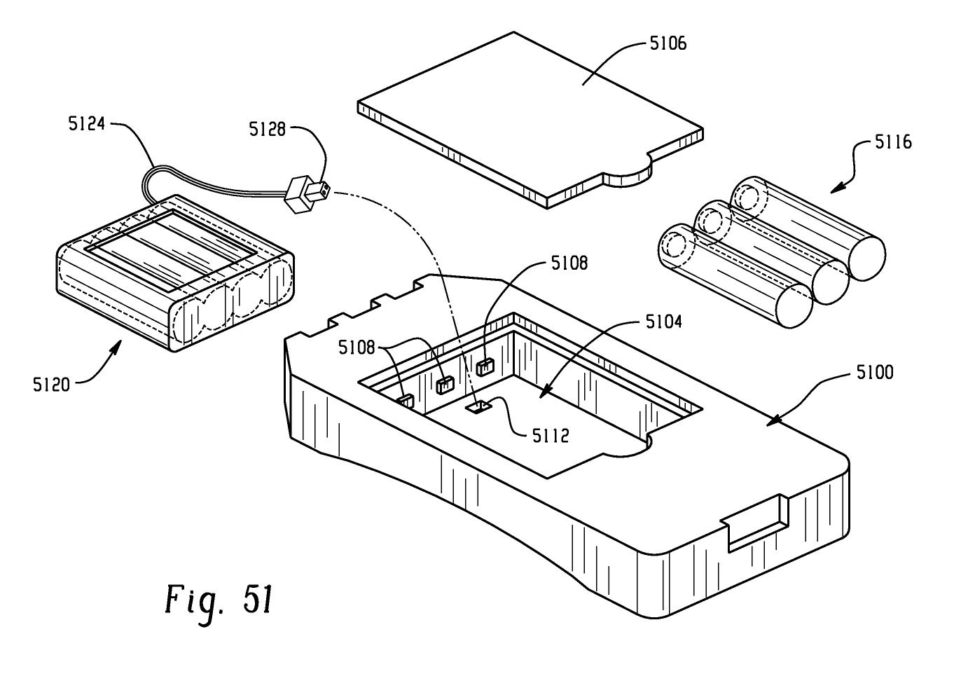

FIG. 51 illustrates a portable appliance 5100 having a battery-receiving region 5104. It is to be appreciated that a fixed appliance may also include the battery-receiving region 5104. First and second sets of electrical contacts 5108 and 5112 are disposed in the battery-receiving region 5104. It is to be appreciated that the illustrated positioning of the electrical contacts in the battery-receiving region 5104 is for explanatory purposes and is not limiting. The portable appliance 5100 also includes electrical and mechanical interfaces that electrically and mechanically engage electrical and mechanical interfaces of a fixed appliance as described above and a battery-receiving region cover 5104.

In one non-limiting implementation, the battery-receiving region 5104 is suitably dimensioned to receive AA sized batteries. As such, the battery-receiving region 5104 may receive three individual AA sized batteries such as those illustrated at 5116 using the first set of electrical contacts 5108. In one instance, the user may elect to insert three individual non-rechargeable AA sized batteries, while in another instance the user may elect to insert three individual rechargeable AA sized batteries. The first set of electrical contacts 5108 includes separate pairs of electrical contacts for electrically engaging the electrical contacts of the individual batteries.

In another example, the battery-receiving region 5104 may receive three AA sized batteries incorporated into a unitary battery pack using the first set of electrical contacts 5112. A suitable battery pack includes three AA sized rechargeable batteries electrically in series and two electrical contacts for electrical communication with complementary electrical contacts. Such a battery pack is shown at 5120 and includes two electrically conductive wires 5124 having first ends respectively connected to the two electrical contacts and second ends connected to a connector that electrically engages and communicates with the electrical contacts 5112 of the portable appliance 5100.

It is to be appreciated that the individual batteries 5116 and the battery pack 5120 occupy substantially the same volume within the battery-receiving region 5104. In addition, in other implementations the battery-receiving region 5104 is suitably dimensioned or adapted to receive other sized batteries and/or number of batteries.

A user installs the battery pack 5120 in the battery-receiving region 5104. This includes electrically engaging the electrical contacts of the battery-pack with the second set of electrical contacts 5112. The portable device 5100 can then be inserted into a fixed appliance such as the fixed appliances as described herein. When AC power is available to the fixed appliance, AC power received by the fixed appliance is used to power the portable appliance 5100. The AC power may also be used by a battery charger of the fixed appliance to maintain the charge state of the rechargeable batteries of the battery pack. When AC power is unavailable, for example, during an AC power outage, the batteries in the battery pack provide the power that powers the portable appliance 5100. Similarly, when the portable appliance 5100 is removed from the fixed appliance, the batteries in the battery pack provide the power that powers the portable appliance 5100.

Under conditions in which suitable power is unavailable from the fixed appliance and the batteries in the battery pack, the user may advantageously replace the battery pack as described next. In one instance, the user may physically and electrically remove the battery pack from the portable appliance 5100 and electrically engage a set of individual non-rechargeable batteries so that the electrical contacts of each non-rechargeable battery electrically engage corresponding electrical contacts from the first set of electrical contacts 5108. These non-rechargeable batteries provide the power that powers the portable appliance 5100. Alternatively, the user can insert individual rechargeable batteries as just described. Alternatively, the user may insert a second, charged battery pack via the second set of electrical contacts 5112. Thus, if the batteries in the battery pack drain to a level that produces an undesired light output, for example, when using the portable appliance 5100 outside of the fixed appliance for a relatively long time period, the user may remove the battery pack and use a set of individual non-rechargeable batteries, a set of individual rechargeable batteries, or a spare charged battery pack.

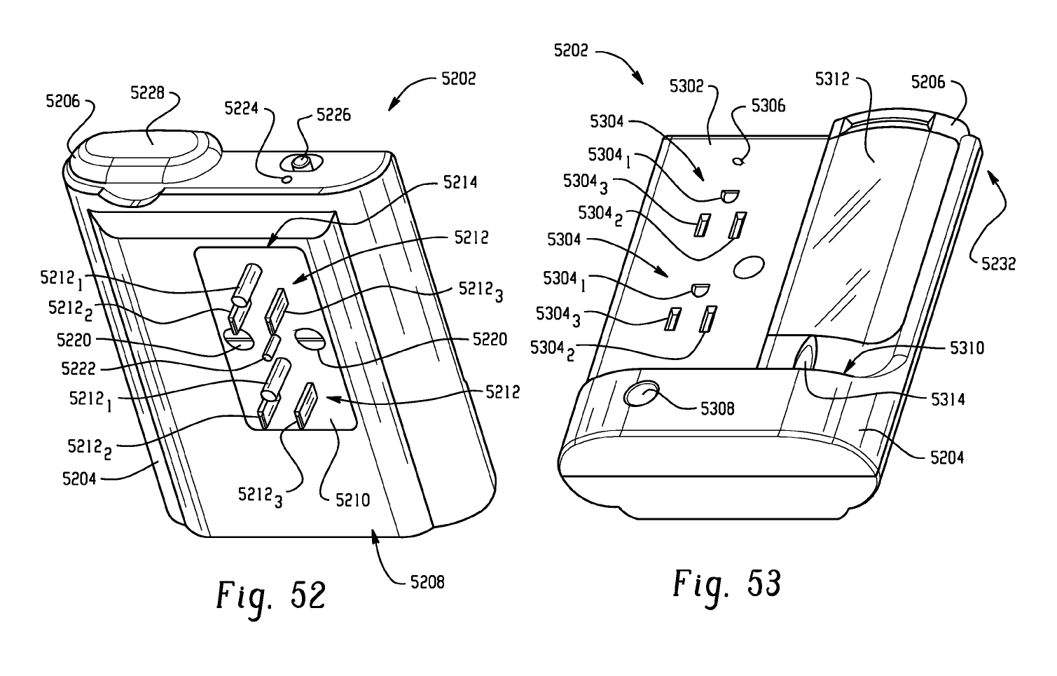

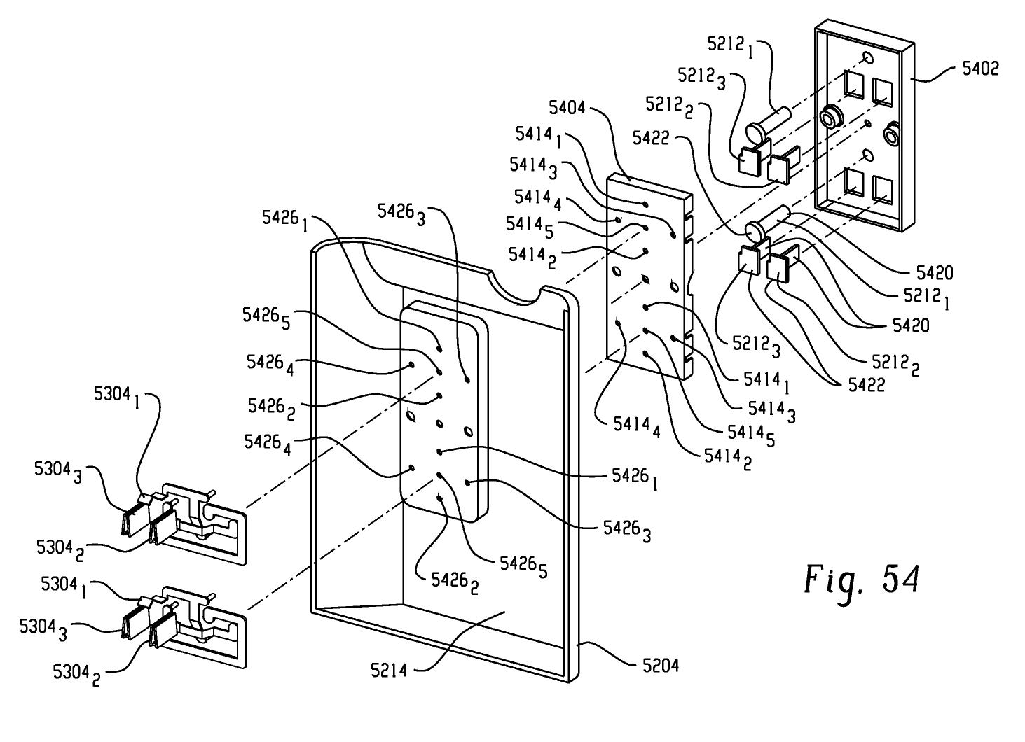

FIGS. 52 and 53 illustrate a direct plug-in, electrical pass-through lighting appliance 5202 having a fixed appliance 5204 and a portable lighting appliance 5206. Initially referring to FIG. 52, the fixed appliance 5204 includes a first major side 5208 with an electrical contact support apparatus 5210 that supports two sets of electrical contacts 5212 that insert into a standard AC power receptacle. Each set of electrical contacts 5212, in this example, includes a ground contact 5212₁, a neutral contact 5212₂, and a hot or live contact 5212₃. In other embodiments, the fixed appliance 5204 may include a different configuration of contacts such as a pair of non-grounded polarized electrical contacts, a pair of non-grounded unpolarized electrical contacts, and/or another contact configuration. In addition, the fixed appliance 5204 may have one or more than two sets of electrical contacts 5212.

The orientation of the electrical contact support apparatus 5210 and, thus, the sets of electrical contacts 5212 is configurable with respect to a recess 5214 in the fixed appliance 5204. In the illustrated embodiment, the electrical contact support apparatus 5210 is configurable between first and second positions. In the first position (shown), both sets of the electrical contacts 5212 are oriented for insertion into an AC receptacle installed with the ground socket at the top of the receptacle, when installing the fixed appliance 5204 in an ordinary upright position. As such, the ground contact 5212₁ is located nearer a top 5232 of the fixed appliance 5204 relative to the neutral and hot contacts 5212₂ and 5212₃. In the second position (not shown), both sets of electrical contacts 5212 are oriented for insertion into an AC receptacle installed with the ground socket at the bottom of the receptacle.

The electrical contact support apparatus 5210 maps the input configuration of the electrical contacts 5212 to first and second output configurations for conveyance of the received power to the fixed appliance 5204. The first output configuration provides a mapping of the electrical contacts 5212 when the electrical contacts 5212 are oriented with the ground contact 5212₁ at the top. The second output configuration provides a mapping of the electrical contacts 5212 when the electrical contacts 5212 are oriented with the ground contact 5212₁ at the bottom.

Fasteners 5220 are used to affix the electrical contact support apparatus 5210 in a recess 5214. A fastener 5222 extends through the electrical contact support apparatus 5210 for insertion into a hole such as a screw-hole located between the outlets in the AC receptacle. In one example, the fasteners 5222 comprise screws, however other types of fasteners that permit removal of the support apparatus 5210 can also be employed. Further, other suitable attachment mechanisms can be employed instead of the fasteners 5222 to removably attach the support apparatus 5210 to the appliance 5202.

Turning to FIG. 53, a second major side 5302 of the fixed appliance 5204 includes access to two electrical outlets, or two sets of electrical sockets 5304. In the illustrated example, each outlet includes a ground socket 5304₁, a neutral socket 5304₂, and a hot socket 5304₃. In other embodiments, the fixed appliance 5204 may include one or more than two sets of sockets 5304, a pair(s) of polarized electrical sockets, a pair(s) of unpolarized electrical sockets, and/or another socket configuration.

As shown, the sets of electrical sockets 5304 are oriented so that the ground sockets 5304₁ are above the neutral and hot sockets 5304₂ and 5304₃ and towards the top 5232 of the appliance 5202 when the fixed appliance 5204 is in the upright position, in this example. In other embodiments, the electrical outlets 5304 are otherwise oriented, for example, with the ground sockets 5304₁ below the neutral and hot sockets 5304₂ and 5304₃ and towards the bottom of the appliance 5202. In other examples, the ground sockets 5304₁ are to the left or right of the neutral and hot sockets 5304₂ and 5304₃. Additionally, in still other embodiments, the sets of electrical sockets 5304 can be individually and/or collectively rotated/oriented to a desired or selected orientation, such as, for example, rotating the ground sockets 53041 from being below the neutral and hot sockets to being above the neutral and hot sockets.

The electrical sockets 5304 receive power from one or both of the electrical contacts 5212. For example, the upper socket of 5304 is coupled to the upper contacts of 5212 and the lower socket of 5304 is coupled to the lower contacts of 5212. In this example, separate circuits can be passed through to the sockets 530 and allow individual socket control, such as, for example, by a wall switch. In another example, the sockets of 5304 are both coupled to either the upper or the lower contacts of 5212. The electrical sockets 5304 include electrically conductive pathways (not visible) and protrusions (not visible) for physically contacting and receiving power from the electrical contacts 5212.

A controllable switching circuit (not shown) can selectively control pathways between the sockets 5304 and the contacts 5212. For example, the switching circuit can be selected to provide a conductive pathway from one of the contacts 5212 to both sockets 5304, disconnect conductive pathways from the contacts 5212 to sockets 5304 for example, to conserve power consumption by devices connected to the sockets, reconnect conductive pathways from the contacts 5212 to sockets 5304, and the like.

An example of suitable conductive pathways is described below. The protrusions are arranged for electrical communication with the first and the second electrical output configurations provided by the electrical contact support apparatus 5210. In one instance, this ensures electrical communication between the sockets 5304 and the contacts 5212 when the electrical contact support apparatus 5210 is moved between its first and second positions. The pathways map the input electrical contact configuration to the configuration of the electrical sockets 5304.

The illustrated fixed appliance 5204 also includes two status indicators. A first indicator 5306 (FIG. 53) indicates when power is available, and a second indicator 5224 (FIG. 52) indicates a mode of the fixed application 5204. In an example, the status indicator 5306 is used to provide green light to indicate power is available, and the status indicator 5224 is used to provide amber light to indicate a particular mode of operation.

The fixed appliance 5204 further includes an environmental sensor 5308, such as a light sensor. In other embodiments, a different sensor such as a motion, temperature, or other sensor may be employed. The sensor 5308 senses a corresponding state of the environment, and this information is used by the fixed appliance 5204 to operate the inserted portable appliance 5206. The state of the environment includes, for example, light intensity, motion, temperature, and the like. The operation in response to the sensed state of the environment includes turning the portable appliance 5204 on or off based on the sensed environmental state.

The fixed appliance 5204 further includes a portable light receiving region 5310 that receives the portable lighting appliance 5206. The portable light receiving region 5310 may also receive one or more of the portable appliances 2204, 2608, 2708, 2808, 2900, 3000, and 3104 or other portable appliance. The portable light receiving region 5310 includes mechanical and electrical interfaces for mechanically and electrically interfacing with a portable lighting appliance, such as those described above in connection with the fixed appliances 2202, 2604, 2704, 2804, and 3104. For example, grooves on the portable lighting appliance can interact with slots within the receiving region 5310 to facilitate insertion and removal of the portable lighting appliance. Detents present within such grooves can mitigate unintended removal from the receiving region 5310 by providing resistance against removal.

The fixed appliance 5204 also includes battery-charging circuitry (not visible) such as that described in connection with the fixed appliances 2202, 2604, 2704, 2804, and 3104. Such battery charging circuitry charges a rechargeable battery installed into the inserted portable lighting appliance 5206 when AC power is available.

Returning to FIG. 52, an interface/control 5226 such as a multi-position switch is used to transition the fixed appliance from one mode to another mode. In one example, the interface/control 5226 switches the fixed appliance 5204 between an off mode and an auto mode. When in the off mode, the fixed appliance 5204 provides AC power for charging the portable lighting appliance 5206, and the sensor 5308 (FIG. 53) and the portable lighting appliance 5206 are inactive. When in auto mode, the fixed appliance 5204 again provides AC power for charging the portable lighting appliance 5206 and the sensor 5308 and the portable lighting appliance 5206 are active. In auto mode, the portable lighting appliance 5206 is turned on based on the state of the environment as determined from the signal from the sensor 5308 when power is available and is turned on when power becomes unavailable. In another example, the interface/control 5226 also controls operation of the pathways from the sets of contacts 5212 to the sockets 5304. For example, supply of power to the sockets 5304 can be turned off.

The portable lighting appliance 5206 includes a first light source 5228 (FIG. 52) and a second light source 5312 (FIG. 53). The first light source 5228 is disposed behind an optical element, and a reflector (not visible) or the like directs the emitted light to produce a light beam or spotlight similar to that of a conventional flashlight. The second light source 5312 is disposed behind an optical element, and a diffuser (not visible) or the like spreads the emitted light to form an area light.

An interface/control 5314 such as a multi-position switch allows a user to operate the portable lighting appliance 5206. In the illustrated embodiment, the interface/control 5314 is a three-position switch that moves between an off mode, an area light mode, and a spot light mode. When the portable appliance 5206 is inserted into the portable lighting appliance receiving region 5310, the interface/control 5314 of the fixed appliance 5204 operates the portable lighting appliance 5206.

In one instance, inserting the portable lighting appliance 5206 into the receiving region 5310 automatically moves the interface/control 5314 of the portable lighting appliance 5206 to the off position, and the interface/control 5226 of the fixed appliance 5204 communicates and operates the portable lighting appliance 5206 through the electrical contacts in the portable device receiving region 5310. In another example, inserting the portable lighting appliance 5206 into the receiving region 5310 transfers operation of the portable lighting appliance 5206 from the interface/control 5314 to the interface/control 5226 of the fixed appliance 5204.

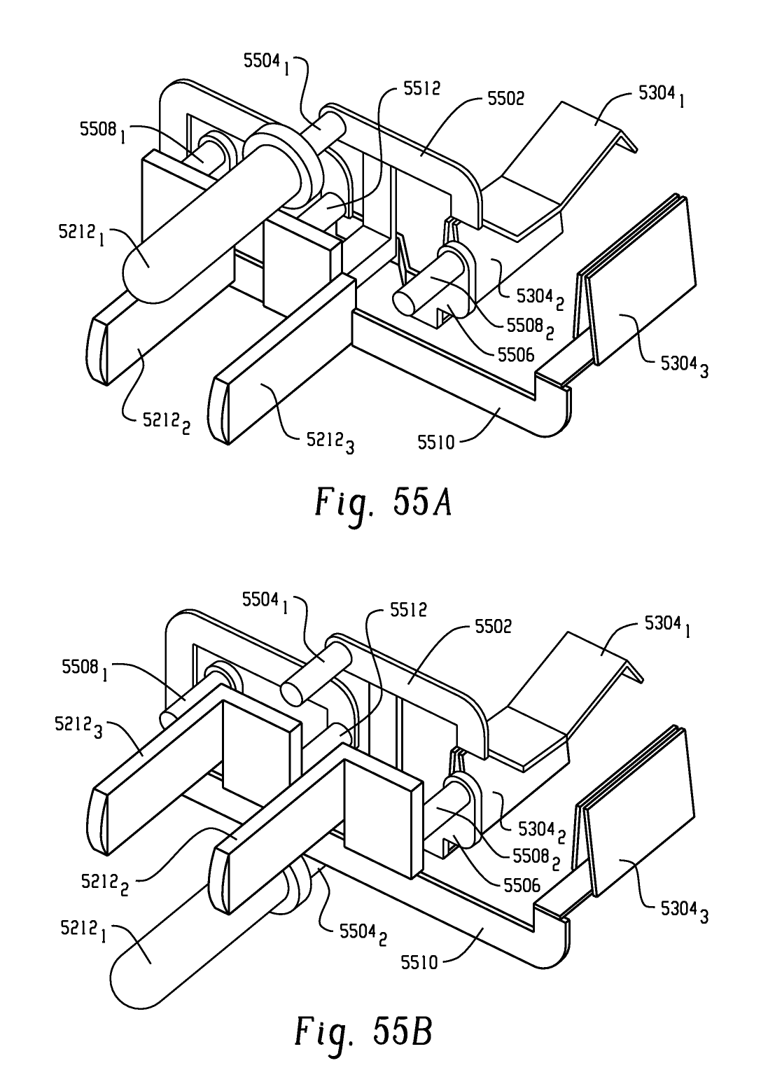

FIGS. 54, 55A, and 55B depict an example of the mapping between the electrical contacts 5212 in the electrical contact support apparatus 5210 and the sockets 5304 on the fixed appliance 5204. As shown in FIG. 54, the electrical contact support apparatus 5210 includes first and second housing portions 5402 and 5404. The housing portions 5402 and 5404 are shown separated for explanatory purposes.

The electrical contacts 5212 extend from inside of the electrical contact support apparatus 5210 through the first housing portion 5402. The electrical contacts 5212 have first end portions 5420 that are geometrically shaped so that they can extend through the material free regions 5414, and second end portions 5422 that are geometrically shaped otherwise, which inhibits the electrical contacts 5212 from falling out of the electrical contact support apparatus 5210.

The shape of the second end portions 5422 of the electrical contacts 5212 also physically maps the location of the electrical contacts 5212 to the second housing portion 5404 for the first and second output configurations. As shown, the second end portions 5422 of the neutral and hot contacts 5212₂ and 5212₃ extend substantially perpendicularly with respect to the first end portions 5420 in a common direction. This offsets the electrical contacts 5212 in the common direction. When the electrical contact support apparatus 5210 is moved to its other position, the second end portions 5422 extend substantially perpendicularly with respect to the first end portions 5420 in an opposing direction. Note that in the illustrated embodiment the second end portions 5422 of the hot contacts 5212₃ offset the hot contacts 5212₃ so that they are positioned in a common location regardless of the orientation of the electrical contact support apparatus 5210.

The second housing portion 5404 includes material free regions 5414₁, 5414₂, 5414₃, 5414₄, and 5414₅ (collectively referred to as material free regions 5414) that provide access to the second end portions 5422 of the electrical contacts 5212. The material free region 5414₁ provides access to the ground contact 5214₁ and the material free region 5414₃ provides access to the neutral contact 5214₃ when the electrical contact support apparatus 5210 is oriented, as illustrated, for an AC receptacle with the ground socket positioned at the top of the receptacle. The material free region 5414₂ provides access to the ground contact 5214₁ and the material free region 5414₄ provides access to the neutral contact 5214₃ when the electrical contact support apparatus 5210 is oriented for an AC receptacle with the ground socket positioned at the bottom of the receptacle. The material free region 5414₅ provides access to the hot contact 5214₂ for either orientation of the first housing portion 5402.

The recess 5214 in the fixed appliance 5204 includes material free regions 5426₁, 5426₂, 5426₃, 5426₄, and 5426₅ (collectively referred to as material free regions 5426) that are positionally complementary to the material free regions 5414 in the second housing portion 5404.

Turning to FIGS. 55A and 55B, the ground socket 5304₁ include an electrically conductive conduit 5502 and electrically conductive protrusions 5504₁ and 5504₂ (not visible in FIG. 55A). The neutral socket 5304₂ includes an electrically conductive conduit 5506 and electrically conductive protrusions 5508₁ and 5508₂. The hot socket 5304₃ includes an electrically conductive conduit 5510 and an electrically conductive protrusion 5512. The protrusions 5504, 5508, and 5512 extend through respective material free regions in the recess 5214 and the second housing portion 5404 (neither shown in FIGS. 55A and 55B) and physically contact respective ones of the electrical contacts 5212.

As shown in FIG. 55A, when the electrical contact support apparatus 5210 is oriented as depicted in FIG. 54, the ground protrusion 5504₁ physically maps to the ground contact 5412₁, the neutral protrusion 5508₂ physically maps to the neutral contact 5412₃, and the live protrusion 5512 physically maps to the live contact 5412₂. As shown in FIG. 55B, when the electrical contact support apparatus 5210 is oriented for an AC receptacle positioned so that the ground socket is at the bottom of the receptacle, the ground protrusion 5504₂ physically maps to the ground contact 5412₁, the neutral protrusion 5508₁ physically maps to the neutral contact 5412₃, and the live protrusion 5512 physically maps to the live contact 5412₂.

In operation, a user affixes the direct plug-in lighting appliance 5202 to an AC receptacle in the ordinary upright position so that an inserted portable lighting appliance 5206 sits upright in the inserted portable lighting appliance receiving region 5310. This allows the user to easily insert and remove the portable lighting appliance 5206 from the fixed appliance 5204. In addition, this facilitates keeping the portable lighting appliance 5206 inserted in the portable lighting appliance receiving region 5310.

Before inserting the appliance 5202, the user first determines whether electrical contacts 5212 are suitably oriented for the AC receptacle. This can be achieved by holding the fixed appliance 5204 in the upright position and observing the orientation of the electrical contacts 5212 and observing the orientation of the AC receptacle. If the electrical contacts 5212 are appropriately oriented, the electrical contacts 5212 are inserted into the AC receptacle, and the fastener 5222 is installed to secure the fixed appliance 5204 in place. If desired, the fastener 5222 does not have to be installed. The user may then independently use the portable lighting appliance 5206 or use the portable lighting appliance 5206 in connection with the fixed appliance 5204. For instance, the user may use the portable lighting appliance 5206 as a portable spot or area light. In another instance, the user may charge the portable lighting appliance 5206 in the fixed appliance and operate the fixed appliance 5202 via the fixed appliance.

If the electrical contacts 5212 are not suitably oriented, the user removes the fasteners 5222 and the electrical contact support apparatus 5210 from the fixed appliance 5204. The user then suitably rotates the electrical contact support apparatus 5210, for example, by about one hundred and eighty degrees, and re-attaches the electrical contact support apparatus 5210 to the fixed appliance 5204. The electrical contacts 5212 are then inserted into the AC receptacle, and the fastener 5222 is installed, if desired. The portable lighting appliance 5206 and/or fixed appliance 5202 can then be operated as described above.

The user can change the orientation of the electrical contacts 5212 as needed as the direct plug-in lighting appliance 5202 is moved from one AC receptacle to another AC receptacle.

It is to be appreciated that the electrical contact support apparatus 5210 can be used with other fixed appliances such as the fixed appliance described above. For example, other fixed appliance may be configured to receive the electrical contact support apparatus 5210 and/or the electrical contact support apparatus 5210 may be configured to be affixed to another fixed appliance. As such, the electrical contact support apparatus 5210 may be used to map the configuration of an external power source for the fixed appliance.

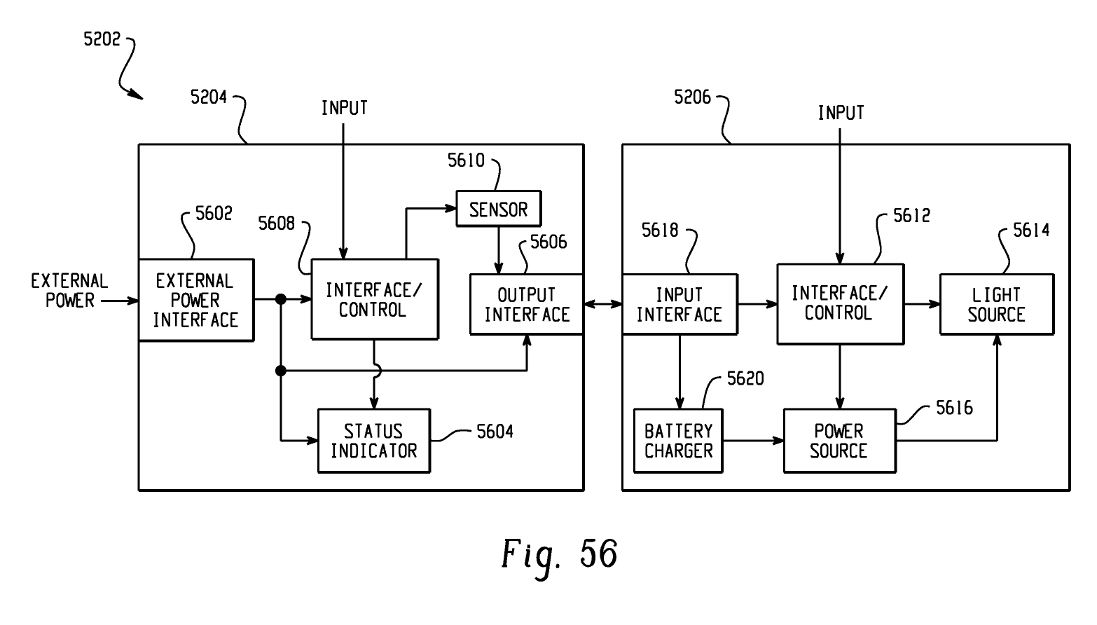

FIG. 56 illustrates a schematic block diagram for a lighting appliance, for example, the direct plug-in lighting appliance 5202 or other lighting appliance. As shown, the fixed appliance 5204 includes an external power interface 5602 for receiving power from an external power source such as an AC receptacle. A status indicator 5604 provides an indication of whether external power is being received.

The fixed appliance 5204 also includes an output interface 5606 for communicating with a received portable lighting appliance 5206. When external power is available and the portable lighting appliance 5206 is inserted into the fixed appliance 5204, the received power is conveyed to the portable lighting appliance 5206 via the output interface 5606.

An interface/control 5608 receives an input indicative of a desired mode of operation of the fixed appliance 5204. Non-limiting examples of suitable modes of operation include an off mode and an auto mode in which the fixed appliance 5204 operates based on factors such as the received external power and/or a state of the environment. The interface/control 5608 conveys a signal indicative of the mode of operation through the output interface 5606. The status indicator 5604 receives a signal indicative of mode of operation and indicates the mode of operation based on the signal.

The interface/control 5608 also receives a signal indicative of the received external power. Based on the mode of operation and this signal, the interface/control 5608 selectively activates environmental sensor 5610. When activated, the environmental sensor 5610 generates a signal indicative of a state of the environment and conveys the signal via the output interface 5606.

The portable lighting apparatus 5206 includes an interface/control 5612. When the portable lighting apparatus 5206 is removed from the fixed appliance 5204, the interface/control 5612 receives an input indicative of a mode of operation of the portable lighting appliance 5206. Non-limiting examples of suitable modes of operation include an off mode and one or more on modes in which a light source 5614 is activated to produce light such as a spot light or an area light. The particular mode determines when power from a power source 5616 is supplied to the light source 5614. The power source 5616 receives either a rechargeable battery(s) or a non-rechargeable battery(s).

When the portable lighting appliance 5206 is inserted into the fixed appliance 5204, the input to the mode selection circuitry 5612 is disabled or otherwise overridden by the fixed appliance 5204, and the mode selection circuitry 5612 operates the light source 5614 based on the input received at an input interface 5618 from the fixed appliance 5204. The portable lighting appliance 5206 further includes battery-charging circuitry 5620 that uses power received from the fixed appliance 5204 to charge an installed rechargeable battery(s).

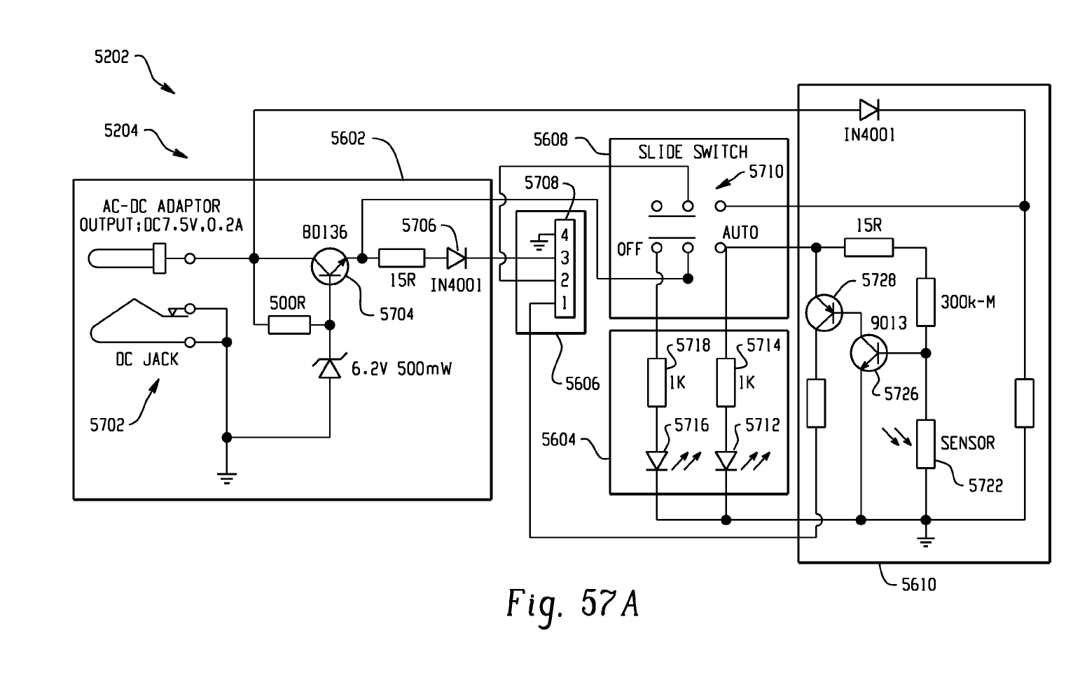

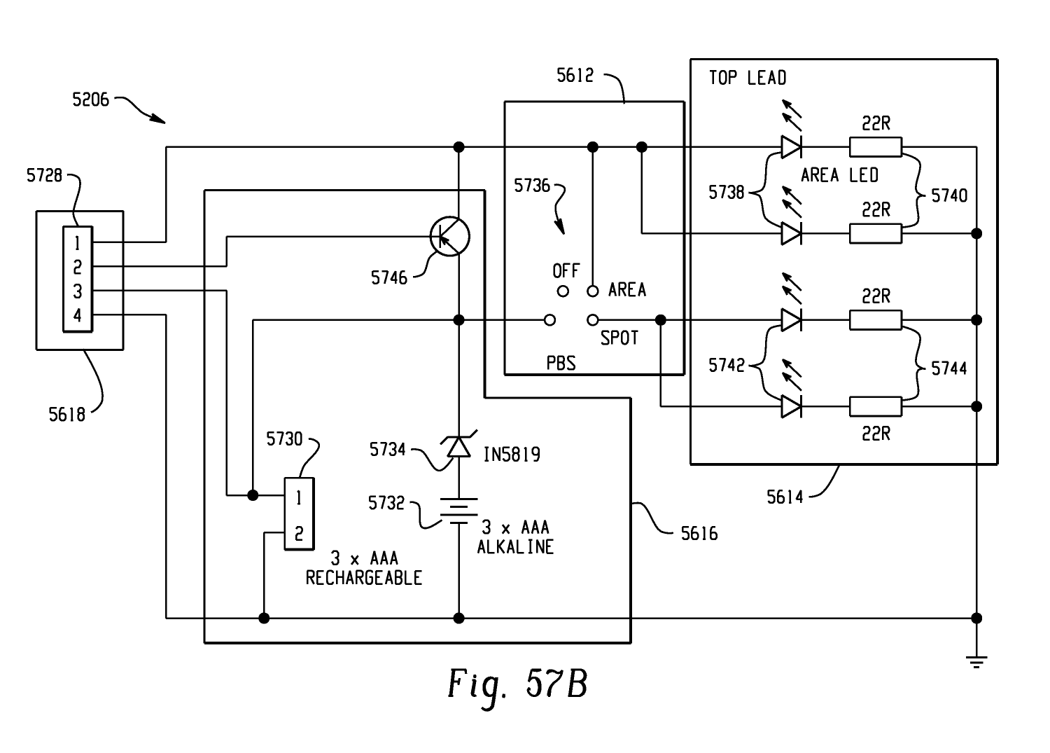

FIGS. 57A and B depict a circuit diagram for a lighting appliance, such as the direct plug-in lighting appliance 5202 described above or another lighting appliance. For illustrative purposes, the circuit diagram is discussed with reference to the above description and the diagram of FIG. 56. Initially referring to FIG. 57A, the external power interface includes circuitry 5702 for converting input power to suitable power for the lighting appliance 5202. For example, this may include converting 120 V AC to 7.5 V DC (0.2 A). When external power is received, the converted power biases a transistor 5704 and the converted power is passed through a diode 5706 to a four-pin connector 5708 of the output interface 5606. In this example, the converted output is provided to the connector 5708.

A switch 5710 of the interface/control 5608 such as a slide switch transitions the lighting appliance 5202 between a first position that places the lighting appliance 5202 in an off mode and a second position that places the lighting appliance 5202 in an auto mode. Other types of switches such as push button, toggle, etc. may also be used. When the switch 5710 is in auto mode and external power is received, the converted power is supplied to and illuminates an LED 5712 such as an indicator LED in series with a resistor 5714. When the switch 5710 is in off mode and external power is received, the converted power is supplied to and illuminates an LED 5716 such as an indicator LED in series with a resistor 5718. When external power is unavailable, neither LED 5712 nor LED 5718 is supplied with converted power.

The sensor 5610 includes a light sensor 5722 that biases a first transistor 5726, which biases a second transistor 5728 such that the converted power is passed through the connector 5708 in the absence of light. In the presence of light, the second transistor 5728 does not pass the converted power. In another example, a different sensor such as a motion, temperature, etc. may be used.

As noted above, the output interface 5606 includes the four pin connector 5708. In this example, converted power passed through the transistor 5704 is provided to pin 1. Converted power is provided to pins 2 and 3 when external power is received. Pin 4 is connected to ground. It is to be appreciated that other pin configuration may also be used.

Turning to FIG. 57B, the input interface 5618 of the portable appliance 5206 includes a complementary four pin connector 5728. In this example, pin 1 receives the converted power passed through the sensor circuitry, pins 2 and 3 receive the converted power when external power is available, and pin 4 is connected to ground.

The power source 5616 receives either rechargeable batteries 5730 such as three rechargeable NiMH batteries or non-rechargeable batteries 5732 such as three alkaline batteries. When the rechargeable batteries 5730 are installed and converted power is received via pin 3, the converted power may be used to charge installed rechargeable batteries 5730. When the non-rechargeable batteries 5732 are installed, a diode 5734 separates the converted power from the non-rechargeable batteries 5732.

The interface/control 5612 includes a switch 5736 such as a three position pushbutton switch for transitioning the portable lighting appliance 5206 between an off mode, a area light mode, and a spot light mode.

When the portable lighting appliance 5206 is not installed in the fixed appliance 5204 and the switch 5736 is in the area light mode, power from the installed batteries (5728 or 5730, whichever is installed) is supplied to a first pair of LEDs 5738 in series with a first pair of resistors 5740 through the switch 5736. When the portable lighting appliance 5206 is not installed in the fixed appliance 5204 and the switch 5736 is in the spot light mode, power from the installed battery is supplied to a second pair of LEDs 5742 in series with a second pair of resistors 5744 through the switch 5736. In off mode, power is not supplied to the either pair of LEDs 5738 or 5742.

When the portable lighting appliance 5206 is installed in the fixed appliance 5204 and the switch 5710 (FIG. 57A) may control the portable lighting appliance 5206. When the switch 5710 is in auto mode, converted power is received via pin 1 in the absence of light (due to the sensor 5610 as described above in connection with FIG. 57A), and the converted power is supplied to the first pair of LEDs 5738 of the area light. When external power is unavailable to the fixed appliance 5204 (FIG. 57A), a transistor 5746 is biased, and power from the installed batteries (5728 or 5730, whichever is installed) is supplied to the first pair of LEDs 5738 of the area light.

For illustrative purposes, an example operation of a direct plug-in lighting appliance 5202 with a photocell and/or a portable lighting appliance having a spot and area light are described with reference to Tables 2, 3, and 4.

TABLE 2
Fixed Appliance

| External Power | Present | |
|---|---|---|
| Photocell | Day | Night |

| | | | | |
|---|---|---|---|---|
| Mode | Off | Auto | Off | Auto |
| Status Indicator | Power | Auto | Power | Auto |

Portable Lighting Appliance

| | |
|---|---|
| Secondary battery(s) | Charging |
| Primary battery(s) | X |

| | | | | |
|---|---|---|---|---|
| Spot Light | Off | Off | Off | Off |
| Area Light | Off | Off | Off | On |

Table 2 depicts the operation of the portable lighting appliance 5206 inserted into the direct plug-in lighting appliance 5202 when external power is available to the fixed appliance 5204. When the mode of the fixed appliance 5204 is set to off, during the day or at night, the light source 5614 is off and the status indicator 5604 indicates that power is being received. If a rechargeable battery(s) is installed in the portable lighting appliance 5206, the received power can be used to charge a rechargeable battery(s). When the mode is in auto mode, the status indicator 5604 indicates that the direct plug-in lighting appliance 5202 is in auto mode. For example, during the day, the light source 5614 is off, and at night, the light source 5614 is illuminated. As such, the direct plug-in lighting appliance 5202, in one example, can operate as a night light.

TABLE 3
Fixed Appliance

| External Power | Absent | | | |
|---|---|---|---|---|
| Photocell | Inactive | | | |
| Mode | Off | Auto | Off | Auto |
| Status Indicator(s) | Off | Off | Off | Off |

Portable Lighting Appliance

| | | | | |
|---|---|---|---|---|
| Battery(s) | Inactive | Discharging | Inactive | Discharging |
| Spot Light | Off | Off | Off | Off |
| Area Light | Off | On | Off | On |

Table 3 depicts the operation of a portable lighting appliance inserted into the direct plug-in lighting appliance when external power is unavailable. When external power is not available, the photocell 5611 and status indicator 5604 are not activated. With the fixed appliance 5204 in off mode, the battery(s) and the light source 5614 respectively are inactive and off. In auto mode and external power being unavailable, power from the battery(ies) is provided to illuminate the area light of the portable lighting appliance 5204. As such, the direct plug-in lighting appliance 5202 can, for example, be used as an emergency light in that it senses when power becomes unavailable and automatically turns on the light source of the portable lighting appliance 5206.

TABLE 4
Portable Lighting Appliance

| | | | |
|---|---|---|---|
| Mode | Off | Spot | Area |
| Battery(s) | Inactive | Discharging | Discharging |
| Spot Light | Off | On | Off |
| Area Light | Off | Off | On |

Table 4 depicts the operation of the portable lighting appliance 5206 when removed from the fixed appliance 5204. From Table 4, when the mode of operation is set to off, the installed battery(s) is inactive in that it is not used to power a light source 5614, for example, and the light source 5614 is off. When the mode of operation of the portable lighting device 5206 is set to spot or area, the installed battery(s) is used to illuminate the respective light source 5614.

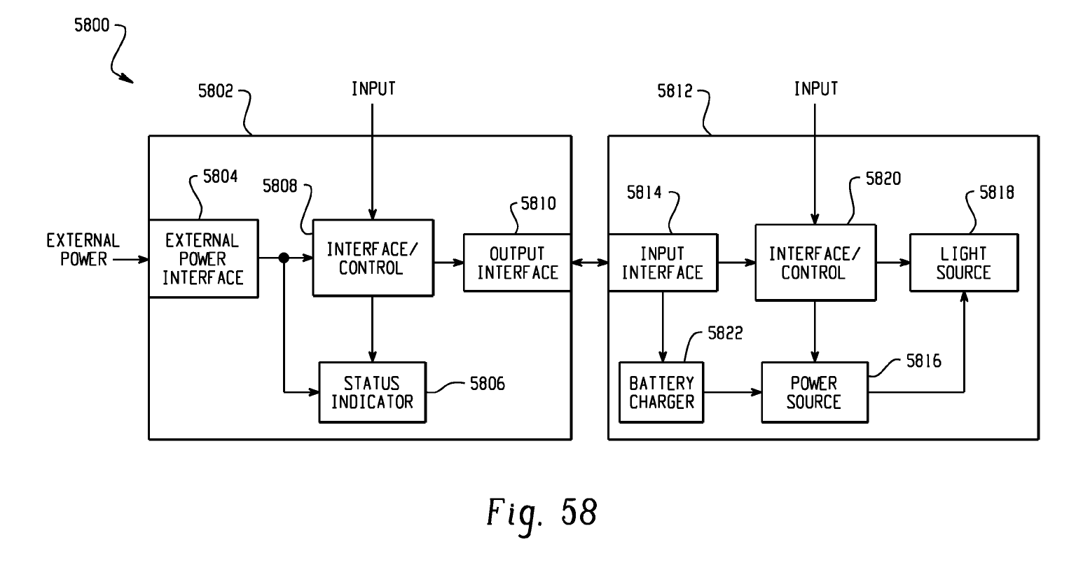

FIG. 58 depicts a schematic block diagram of a lighting device 5800. The lighting device can be, for example, a desk lamp 5800 such as the desk lamp 3100 described above or other desk lamp or other types of lighting devices. The lighting device 5800 includes a fixed appliance 5802 and a portable lighting appliance 5812. The fixed appliance 5802 includes an external power interface 5804, a status indicator 5806, a mode interface/control 5808, and an output interface 5810. The external power interface 5804 receives power from an external power source, such as 120 Volt AC power, DC power, and the like. The external power interface 5804 can perform power regulation, conditioning, or conversion on the external power to provide power to other components of the appliance 5802 at a selected type. The status indicator 5806 indicates whether external power is being received.

The interface/control 5808 receives input, for example, an input indicative of a desired mode of operation of the desk lamp 5800 and generates a signal indicative of or in response to the input. Non-limiting examples of suitable modes of operation include an off mode, a low illumination mode, a high illumination mode, an auto mode, and the like. The status indicator 5806 also indicates the mode of operation. The interface/control 5808 also routes the received external power based on the mode of operation. It is appreciated that the interface/control 5808 can also receive inputs from other sources, for example, other devices, processors, and the like.

The fixed appliance 5802 communicates with external devices such as a portable lighting appliance via an output interface 5810. Such communication may include conveying the received power and/or the signal indicative of the mode of operation to an inserted external device.

The portable lighting appliance 5812 includes an input interface 5814, a power source 5816, a light source 5818, an interface/control 5820, and optionally, charger circuitry 5822. The portable lighting appliance 5812 removably inserts into the fixed appliance 5802 and communicates therewith via the input interface 5814. The input interface 5814 includes electrical contacts for electrical communication with the fixed appliance 5802 such as receiving power, commands, etc. from the fixed appliance 5802, and a mechanical interface such as slots, grooves, and the like for mechanically installing the portable lighting appliance 5812 in the fixed appliance 5802. The light source 5818 may include one or more LEDs or other light sources. In an example, the light source 5818 may be used to produce an area and/or a spot light. The power source 5816 can include for example a rechargeable/secondary battery, such as a NiMh battery or Lithium Ion battery, a non-rechargeable or primary battery, and the like. The charger circuitry 5802 may be used to charge an installed rechargeable battery via power received from the fixed appliance 5802 through the input interface 5814.

When removed from the fixed appliance 5802, the interface/control 5820 receives an input indicative of a desired operation of the portable lighting appliance 5812, including an operation of the light source 5818. Non-limiting examples of selectable modes of operation include an off mode, a low illumination mode, and a high illumination mode. Power from the power source 5816 is used to illuminate the light source 5818.

When the portable lighting appliance 5812 is inserted in the fixed appliance 5802, the interface/control 5820 operates the portable lighting appliance 5812 based on the input received from the fixed appliance 5802. By way of example, the mode of operation of the portable lighting appliance 5812 is determined by the mode of operation of the fixed appliance 5802 received from the fixed appliance 5802. The input to the interface/control 5820 may be disabled or otherwise overridden by the input from the fixed appliance 5802. When the input received from the fixed appliance 5802 includes external power and a rechargeable battery(s) is installed, a battery charger 5822 uses the power to charge the rechargeable battery(s).

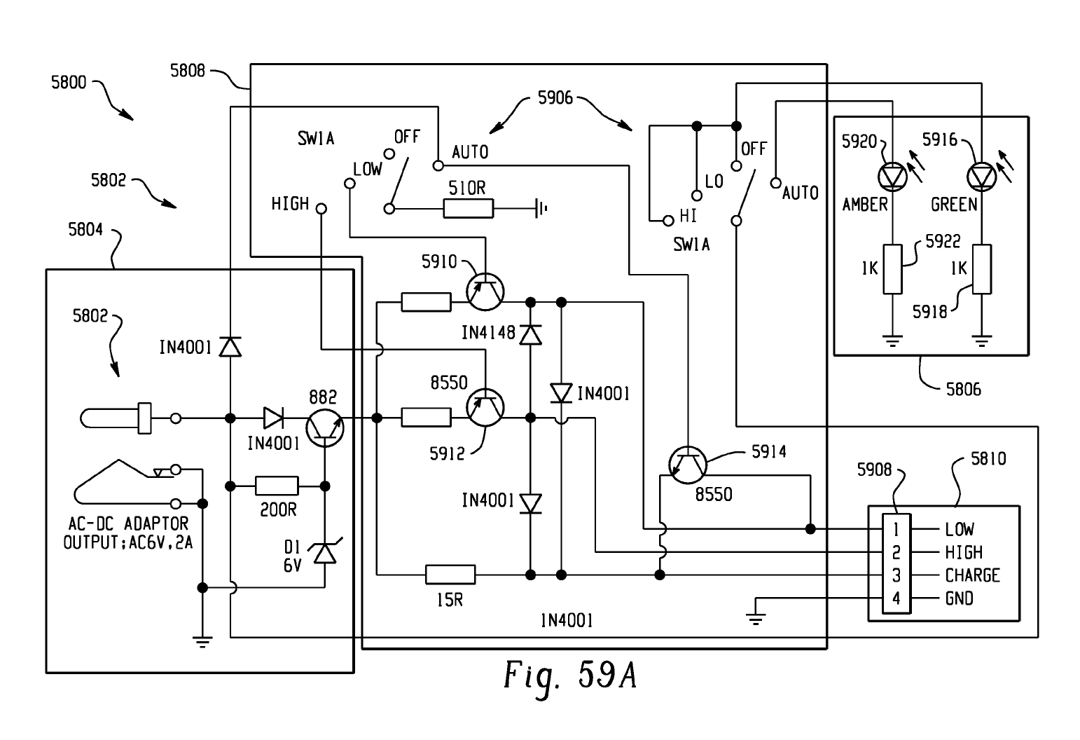

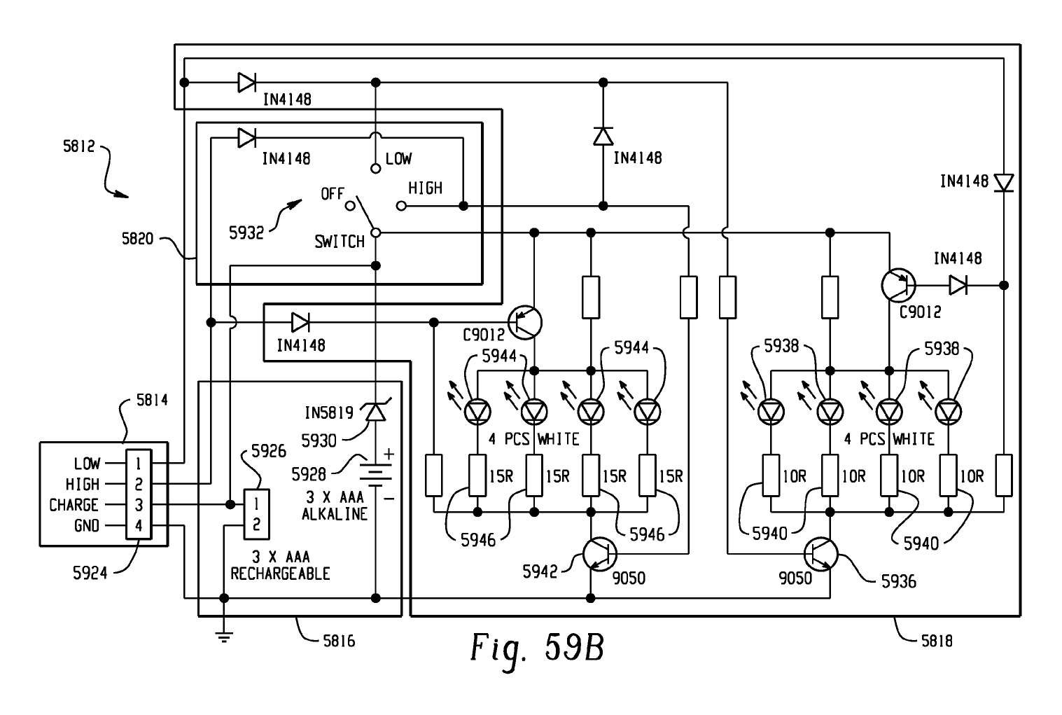

FIGS. 59A and B depict a circuit diagram for a lighting appliance, such as the lighting appliance 5800 described above or another lighting appliance. For illustrative purposes, the circuit diagram is discussed with reference to the above description and the diagram of FIG. 58. Initially referring to FIG. 59A, the external power interface includes circuitry 5902 for converting input power to suitable power for the lighting appliance 5800. For example, this may include converting 120 V AC to 6 V DC (0.2 A).

The interface/control 5808 includes a switch 5906 such as a four position switch for transitioning the fixed appliance 5802 between off, low, high and auto modes. When the switch is in low mode, converted power is provided to a connector 5908 of the output interface 5810 through a transistor 5910. When the switch is in high mode, converted power is provided to the connector 5908 through a transistor 5912. When the switch is in auto mode, converted power is provided to the connector 5908 through a transistor 5914. In this example, the connector 5908 is a four pin connector, and pin 1 receives converted power when the switch 5906 is in low or auto mode, and pin 2 receives converted power when the switch 5906 is in high mode. Pin receives converted power when external power is available. Pin 4 is connected to ground. It is to be appreciated that other pin configuration may also be used.

An LED 5916 in series with a resistor 5918 is illuminated with converted power when external power is available and the switch is in off, low or high mode. An LED 5920 in series with a resistor 5922 is illuminated with converted power when external power is available and the switch is in auto mode.

Turning to FIG. 59B, the input interface 5814 of the portable appliance 5812 includes a complementary four-pin connector 5924. In this example, pin 1 receives the converted power passed through when the fixed appliance 5802 (FIG. 59A) is in low or auto mode, pin 2 receives the converted power passed through when the fixed appliance 5802 is in high mode, pin 3 receives the converted power passed through when external power is available to the fixed appliance, and pin 4 is connected to ground.

The power source 5816 receives either rechargeable batteries 5926 such as three rechargeable NiMH batteries or non-rechargeable batteries 5928 such as three alkaline batteries. When the rechargeable batteries 5926 are installed and converted power is received via pin 3, the converted power may be used to charge installed rechargeable batteries 5926. When the non-rechargeable batteries 5928 are installed, a diode 5930 separates the converted power from the non-rechargeable batteries 5928.

The interface/control 5820 includes a switch 5932 such as a three position pushbutton switch for transitioning the portable lighting appliance 5206 between an off mode, a low mode, and a high mode.

When the portable lighting appliance 5812 is not installed in the fixed appliance 5802 and the switch 5932 is in the low mode, a first transistor 5936 is biased and power from the installed batteries (5926 or 5928, whichever is installed) is supplied to a first set of LEDs 5938 in series with a first set of resistors 5940 through the switch 5736. When the switch 5932 is in the high mode, the first transistor 5936 and a second transistor 5942 are biased and power from the installed batteries (5926 or 5928, whichever is installed) is supplied to the first set of LEDs 5938 in series with the first set of resistors 5940 and a second set of LEDs 5944 in series with the first set of resistors 5946.

For illustrative purposes, an example operation of the desk lamp 5800 is described with reference to Tables 5, 6, and 7.

TABLE 5
Fixed Appliance

| | |
|---|---|
| External Power | Present |

| | | | | |
|---|---|---|---|---|
| Mode | Off | Low | High | Auto |

| | | |
|---|---|---|
| Status Indicator | Power | Auto |

Portable Lighting Appliance

| | |
|---|---|
| Secondary Battery(s) | Charging |
| Primary Battery(s) | X |

| | | | | |
|---|---|---|---|---|
| Light Source | Off | Low | High | Off |

Table 5 depicts operation of the portable lighting appliance 5812 by the fixed appliance 5802 when external power is available to the fixed appliance 5802. From Table 5, if a secondary battery(s) is installed in the portable lighting appliance 5812, the external power is used to charge the secondary battery(s). When the fixed appliance 5802 is off or in auto mode, the light source 5822 is off. When the fixed appliance 5802 is in low mode, the light source 5822 is operated in low mode. In one instance, a sub-set of lights such as half of the lights of the light source 5818 are illuminated in low mode. When the fixed appliance 5802 is in high mode, the light source 5818 is operated in high mode. When in off, low and high mode, the status indicator 5806 indicates whether external power is available, and when in auto mode, the status indicator 5806 indicates that the fixed appliance 5802 is in auto mode.

TABLE 6
Fixed Appliance

| | |
|---|---|
| External Power | Absent |

| | | | | |
|---|---|---|---|---|
| Mode | Off | Low | High | Auto |

| | |
|---|---|
| Status Indicator | Inactive |

Portable Lighting Appliance

| Battery(s) | Inactive | Discharging | | |
|---|---|---|---|---|
| Light Source | Off | Low | High | Low |

Table 6 depicts operation of the portable lighting appliance 5812 by the fixed appliance 5802 when external power is unavailable. From Table 6, when the fixed appliance 5802 is off, the light source 5818 is off and the battery(s), whether secondary or primary, is inactive. When the fixed appliance 5802 is in low or auto mode, the light source 5818 is operated in low mode, using power supplied by the battery(s). When the fixed appliance 5802 is in high mode, the light source 5818 is operated in high mode using power supplied by the battery(s). For off, low, high, and auto mode, the status indicator 5806 is inactive.

TABLE 7
Portable Lighting Appliance

| | | | |
|---|---|---|---|
| Mode | Off | Low | High |

| | | |
|---|---|---|
| Battery(s) | Inactive | Discharging |

| | | | |
|---|---|---|---|
| Light Source | Off | Low | High |

Table 7 depicts operation of the portable lighting appliance 5812 when removed from the fixed appliance 5802. From Table 7, when the portable lighting appliance 5802 is off, the light source 5818 is off and the battery(s), whether secondary or primary, is inactive. When the portable lighting appliance 5812 is in low mode, the light source 5818 is operated in low mode using power supplied by the battery(s), and the portable lighting appliance 5812 is in high mode, the light source 5818 is operated in high mode using power supplied by the battery(s).

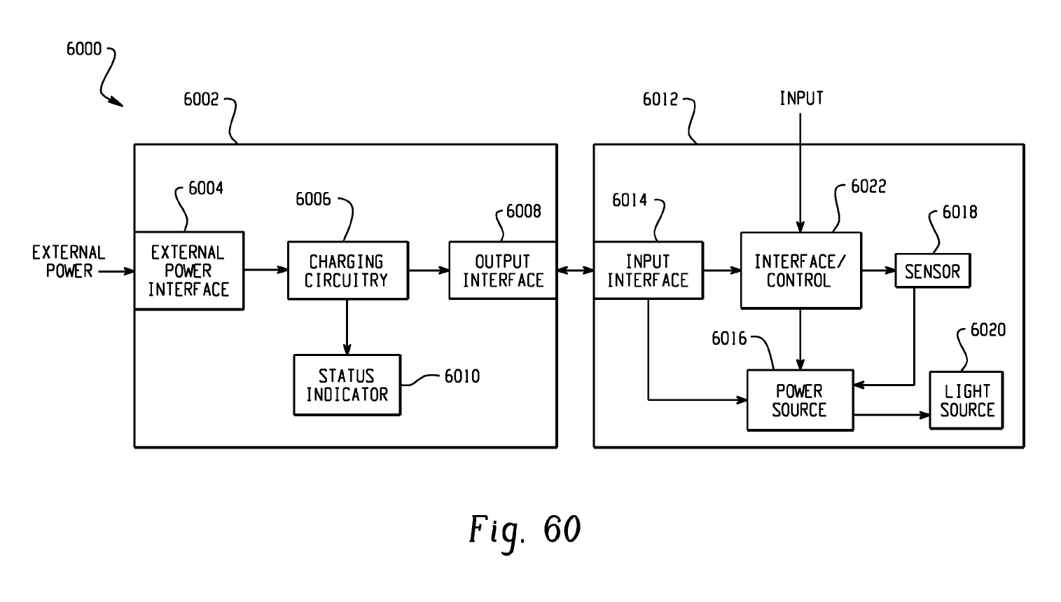

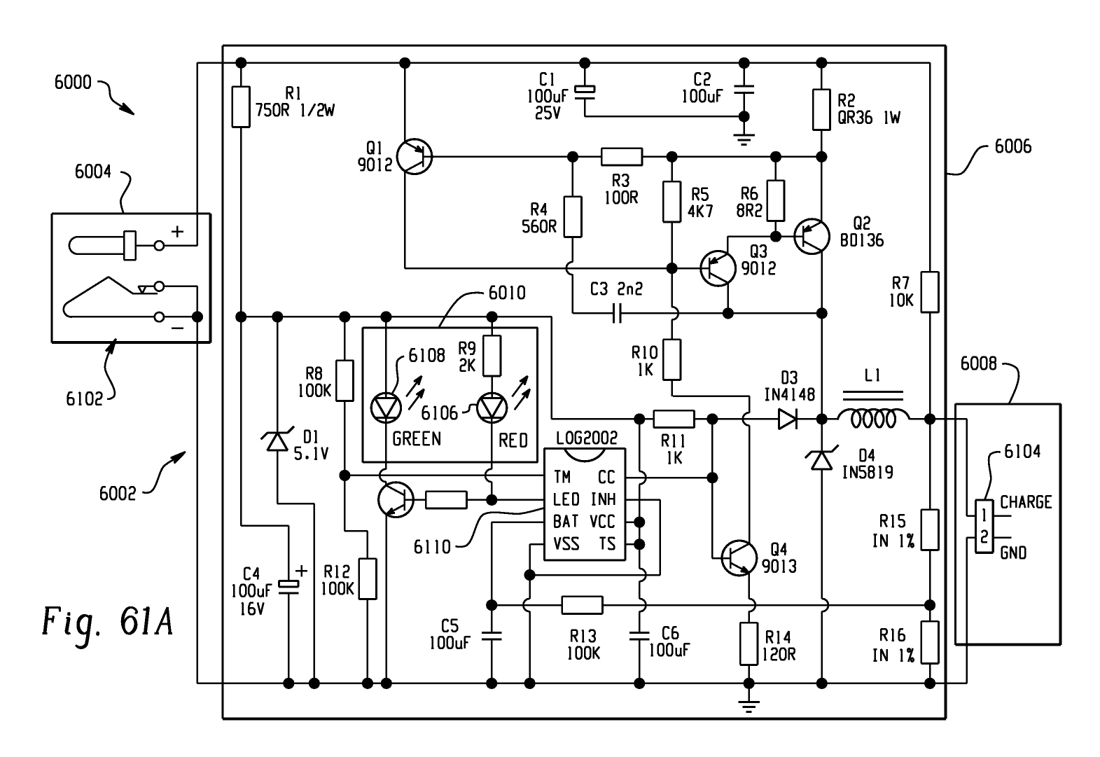

FIG. 60 depicts a schematic block diagram a motion light 6000 such as the motion light 3800 described above or other motion light. The motion light 6000 includes a charging base or fixed appliance 6002 having an external power interface 6004 for receiving power from an external power source. Battery charging circuitry 6006 uses the received power to charge a rechargeable battery of an external appliance such as a portable lighting appliance inserted into the fixed appliance 6002 via an output interface 6008. A status indicator 6010 indicates a charge state of a rechargeable battery being charge by the battery charging circuitry 6006.

A portable lighting appliance 6012 removably inserts into the fixed appliance 6002 and communicates therewith via an input interface 6014. The portable lighting appliance 6012 includes a removable power source 6016, which may be a rechargeable battery(s) or a non-rechargeable battery(s). When inserted in the fixed appliance 6002, external power from the fixed appliance 6002 is used to charge a rechargeable battery(s) installed in the portable lighting appliance 6012. When removed from the fixed appliance 6002, an interface/control 6022 receives an input indicative of a desired operation of the portable lighting appliance 6012. An environmental sensor 6018 senses one or more environmental states and a light source 6020. A light source 6020 is operated based on the desired operation or the desired operation and the state(s) of the environment. The portable lighting appliance 6012 may be removably coupled to a passive appliance such as a diffuser mounted to a wall in a closet or other surface.

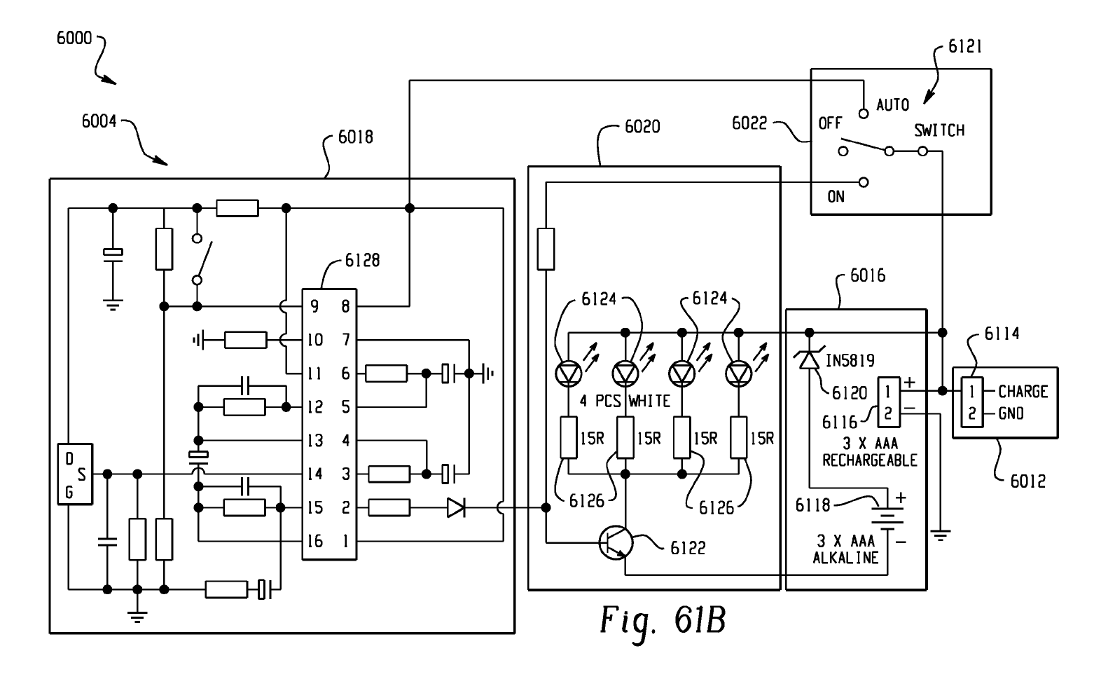

FIGS. 61A and B depict a circuit diagram for a lighting appliance, such as the lighting appliance 6000 described above or another lighting appliance. For illustrative purposes, the circuit diagram is discussed with reference to the above description and the diagram of FIG. 60. Initially referring to FIG. 61A, the external power interface includes circuitry 6102 for converting input power to suitable power for the lighting appliance 6000. When external power is received, the converted power is provided to pin 1 of a connector 6104 of the output interface 6008. pin 2 is connected to ground.

In one instance, the converted power provided to pin 1 is used to charge a portable lighting appliance. In such an instance, a LED 6106 such as a red or other colored LED may be used to indicate when a rechargeable battery of the portable lighting appliance is charging, and a LED 6108 such as a green or other colored LED may be used to indicate when the rechargeable battery of the portable lighting appliance is charged. An integrated chip 6110 may be used to selectively operate the LEDs based on the charge state of the rechargeable battery.

Turning to FIG. 61B, the input interface 6014 of the portable appliance 6004 includes a complementary two pin connector 6112. In this example, pin 1 receives the converted power and pin 2 is connected to ground.

The power source 6016 receives either rechargeable batteries 6114 such as three rechargeable NiMH batteries or non-rechargeable batteries 6116 such as three alkaline batteries. When the rechargeable batteries 6116 are installed and converted power is received via pin 1, the converted power may be used to charge installed rechargeable batteries 6116. When the non-rechargeable batteries 6118 are installed, a diode 6120 separates the converted power from the non-rechargeable batteries 6118.

The interface/control 6022 includes a switch 6120 such as a three position switch for transitioning the portable lighting appliance 6004 between an off mode, an on mode, and an auto mode. The switch 6120 is used to operate the portable lighting appliance 6004 when the portable lighting appliance 6004 is removed from the fixed appliance 6002. When the portable lighting appliance 6004 is inserted into the fixed appliance 6002, the switch 6120 may be deactivated or otherwise disabled. Alternatively, the switch 6120 may be operable when the portable lighting appliance 6004 is inserted into the fixed appliance 6002.

When the switch 6120 is in the on mode, converted power received from pin 1 is used to bias a transistor 6122, and converted power illuminates a set of LEDs 6124 in series with a set of resistors 6126. When the switch 6120 is in auto mode, the sensor chip 6018 is activated with the converted power. In this example, the sensor includes an integrated chip 6128, which includes a photo sensor, a motion sensor, and timing circuitry. In other example, an integrated chip with more or less and/or different sensor is used. When in auto mode, the integrated chip 6128 biases the transistor 6122 based on the sensed environmental conditions. For example, when motion is sensed in the absence of light and a preset time period has not lapsed, the integrated chip 6128 biases the transistor 6122 and converted power illuminates the set of LEDs 6124. Once the motion ceases, the LEDs 6124 remain illuminated until timer period lapses.

For illustrative purposes, an example operation of the motion light 6000 is described with reference to Tables 8 and 9.

TABLE 8
Fixed Appliance

| External Power | Present | | Absent |
|---|---|---|---|
| Charger Indicator | Charging | Charged | Inactive |

| | |
|---|---|
| Mode | X |

Portable Lighting Appliance

| | | | | |
|---|---|---|---|---|
| Secondary Battery(s) | Charging | Charged | X | Inactive |
| Primary Battery(s) | X | X | Inactive | X |

| | |
|---|---|
| Light Source | Off |

Table 8 depicts operation of the portable lighting appliance 6004 when inserted in the fixed appliance 6002. As indicated in Table 8, the light source 6020 remains off. When external power is available and a rechargeable battery(s) is installed in the portable lighting appliance 6004, the external power is used to charge a discharged rechargeable battery(s). A charger indicator 6010 indicates that charge state of the rechargeable battery(s). When external power is unavailable, the status indicator 6010 and the installed battery(s) are inactive. The mode of the portable lighting appliance 6004 does not affect the operation of the portable lighting appliance 6004.

TABLE 9
Portable Lighting Appliance

| Mode | Off | On | Motion/Photo | | |
|---|---|---|---|---|---|
| | X | X | Night | | Day |
| | X | X | No Motion | Motion | X |
| Battery(s) | Inactive | Discharging | Inactive | Discharging | Inactive |
| Light | Off | On | Off | On | Off |
| Source | | | | | |

Table 9 depicts operation of the portable lighting appliance 6004 when removed from the fixed appliance 6002. When the portable lighting appliance 6004 is turned off, the light 6020 is off and the installed battery(s), whether primary or secondary, is inactive. When the portable lighting appliance 6004 is turned on, the light 6020 is illuminated using power from the installed battery(s). When in motion/photo mode, the light 6020 is illuminated at night when motion is present. When motion is absent or during the day, the light 6020 is off and the installed battery(s) is inactive.

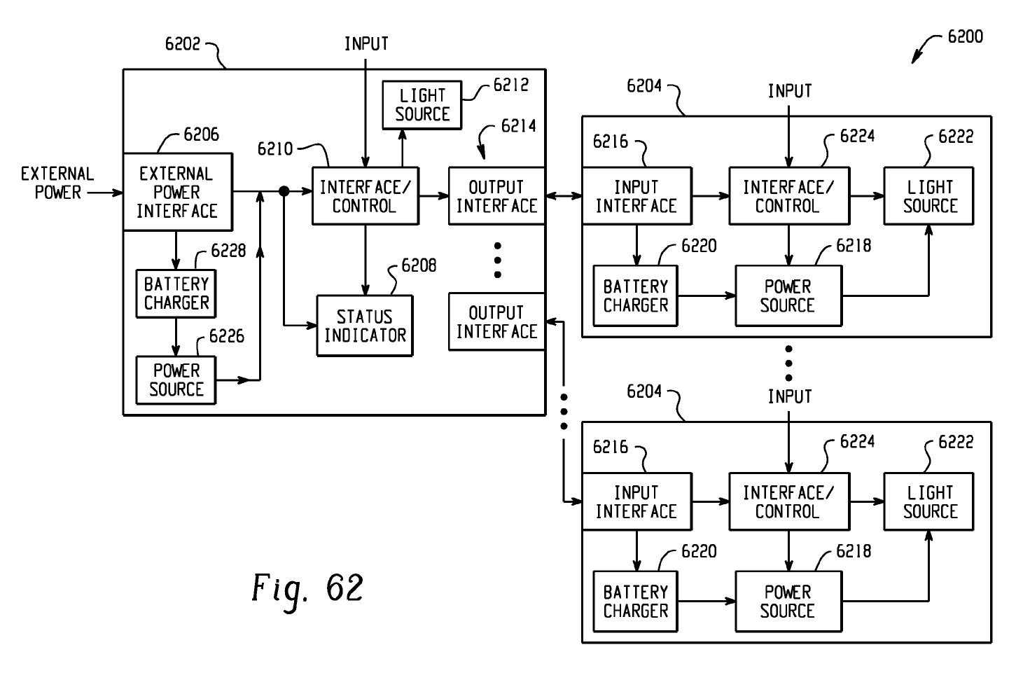

FIG. 62 depicts a schematic block diagram of a lighting device 6200. The lighting device can be, for example, an under counter, under cabinet or other type of lighting device. The lighting device 6200 includes a fixed appliance 6202 and a portable lighting appliance 6204. The fixed appliance 6202 includes an external power interface 6206. The external power interface 6206 receives power from an external power source, such as 120 Volt AC power, DC power, and the like. The external power interface 6206 can perform power regulation, conditioning, or conversion on the external power to provide power to other components of the appliance 6206. A status indicator 6208 indicates whether external power is being received. A power source 6226 includes, for example, a rechargeable/secondary battery, such as a NiMh battery or Lithium Ion battery, a non-rechargeable or primary battery, and the like. Charger circuitry 6228 may be used to charge an installed rechargeable battery.

An interface/control 6210 receives input, for example, an input indicative of a desired mode of operation and generates a signal indicative of or in response to the input. Non-limiting examples of suitable modes of operation include an off mode, a low illumination mode, a high illumination mode, an auto mode, and the like. The status indicator 6206 also indicates the current mode of operation. The interface/control 6210 can also be used to illuminate a light source 6212, which may be, for example, a night light, an emergency light, an area, a spot, and the like. The interface/control 6210 also routes the received external power based on the mode of operation. It is appreciated that the interface/control 6206 can also receive inputs from other sources, for example, other devices, processors, and the like. The power from the external source, the power from the power source 6226, and/or power from another source may be used to illuminate the light source 6222 and/or be conveyed to one or more portable lighting appliances 6204 via the output interfaces 6214. An example of another type of communication that can be conveyed over the output interface 6214 includes a signal indicative of the mode of operation and/or other information.

Each portable lighting appliance 6204 may include an input interface 6216 and removably inserts into the fixed appliance 6202 and communicates therewith via an input interface 6216. The input interface 6216 includes electrical contacts for electrical communication with the fixed appliance 6202 such as receiving power, commands, etc. from the fixed appliance 6202, and a mechanical interface such as slots, grooves, and the like for mechanically installing the portable lighting appliance 6204 in the fixed appliance 6202. A power source 6218 includes, for example, a rechargeable/secondary battery, such as a NiMh battery or Lithium Ion battery, a non-rechargeable or primary battery, and the like. Charger circuitry 6220 may be used to charge an installed rechargeable battery via power received from the fixed appliance 6202 through the input interface 6216.

The portable lighting appliances 6204 further include a light source 6222 such as one or more LEDs or other light sources. The light source 6222 may be used to produce an area, a spot light, and/or other type of light. In one example, the one or more LEDs are tuned on and off via an interface/control 6224. In another example, the interface/control 6222 automatically turns the one or more LEDs on when external power becomes unavailable. In yet in other examples, the interface/control 6224 or other control or input operates the light source 6222.

For a portable lighting appliance 6204 not inserted into the fixed appliance 6202, the interface/control 6224 receives an input indicative of a desired operation of the particular portable lighting appliance 6204, including an operation of the light source 6222. Non-limiting examples of selectable modes of operation include an off mode, an on mode, and the like. Power from the power source 6218 is used to illuminate the light source 6222.

For a portable lighting appliance 6204 inserted into the fixed appliance 6202, the interface/control 6210 may be used to operate the portable lighting appliance. By way of example, the interface/control 6210 may be used to transition the light 6222 between an on mode, an off mode, etc. Power from the power source 6218 or power received via the input interface 6216 is used to illuminate the light source 6222. In one example, input to the interface/control 6224 may be disabled or otherwise overridden by the input from the fixed appliance 6202 or other component or device. When the input received from the fixed appliance 6202 includes external power and a rechargeable battery(s) is installed, the battery charger 5822 uses the power to charge the rechargeable battery(s).

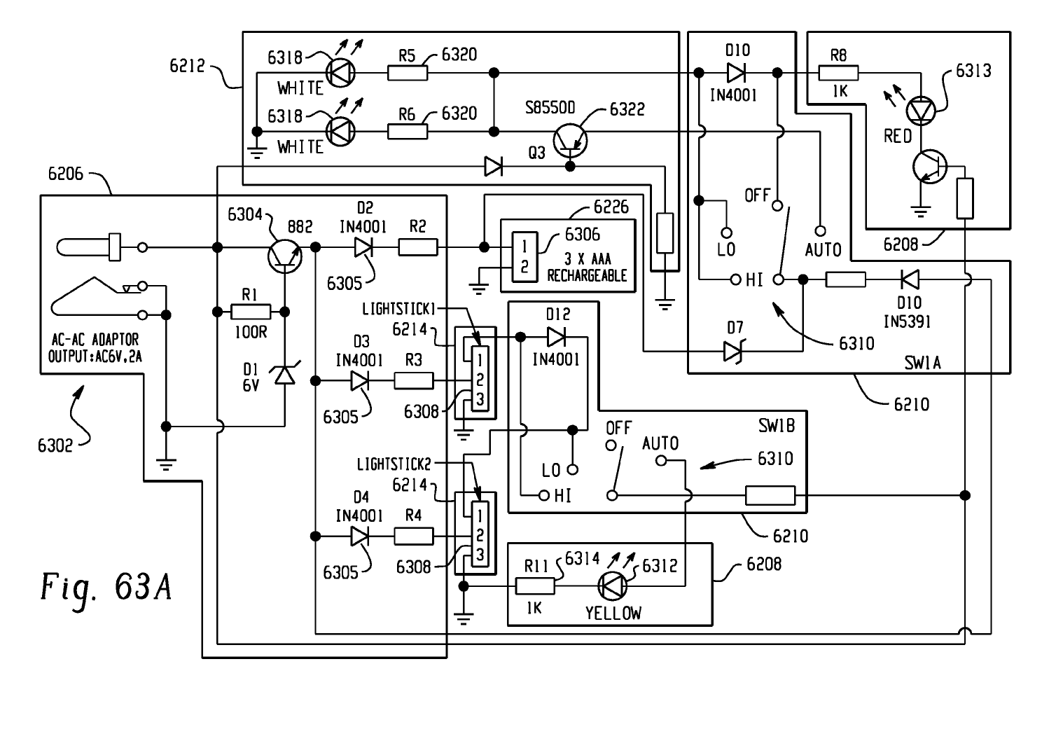

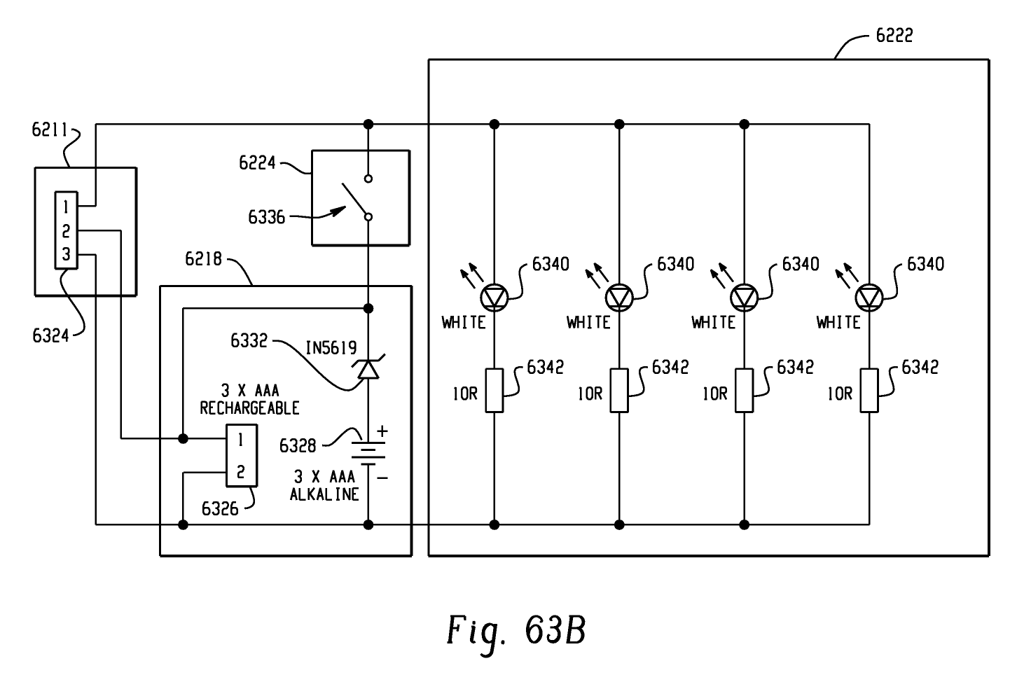

FIGS. 63A and B depict a circuit diagram for a lighting appliance, such as the lighting appliance 6300 or another lighting appliance. For illustrative purposes, the circuit diagram is discussed with reference to the above description and the diagram of FIG. 63. Initially referring to FIG. 63A, the external power interface includes circuitry 6302 for converting input power to suitable power for the lighting appliance 6200. For example, this may include converting 120 V AC to 6 7.5 V AC at 0.2 A. When external power is received, the converted power biases a transistor 6304, and the converted power is passed through diodes 6305 and provided to pin 1 of a connector 6306 for charging the rechargeable battery of the power source 6226 and pin 2 of connectors 6308 of the output interfaces 6124. Pin 2 of the connector 6306 and pin 3 of the connectors 6308 is connected to ground.

A switch 6310 of the interface/control 6210 transitions the lighting appliance 6200 between an off mode, an auto mode, and a HI mode, and a LO mod. The light source 6212 includes a pair of LEDs 6318 in series with resistor 6320. When the switch 6310 is in the HI or LO mode, the converted power is used to illuminate the LEDs 6318. When the switch 6310 is in the auto mode and external power is unavailable, a transistor 6322 is biased such that the converted power is supplied to the LEDs 6318. The converted power is routed through the LED 6316 when in HI, LO or auto mode. In one example, the LED 6316 is used to indicate when power is being received.

Turning to FIG. 63B, the input interface 6216 of the portable appliance 6204 includes a complementary three pin connector 6224. In this example, pin 1 receives the converted power passed through the mode switch 6310, pin 2 receives the converted power when external power is available, and pin 3 is connected to ground.

The power source 6218 receives either rechargeable batteries 6326 such as three rechargeable NiMH batteries or non-rechargeable batteries 6228 such as three alkaline batteries. When the rechargeable batteries 6326 are installed and converted power is received via pin 2, the converted power may be used to charge installed rechargeable batteries 6326. When the non-rechargeable batteries 6228 are installed, a diode 6232 separates the converted power from the non-rechargeable batteries 6228.

The interface/control 6224 includes a switch 6236 such as a two position switch for transitioning the portable lighting appliance 6304 between an off mode and an on mode. When the portable lighting appliance 6304 is not installed in the fixed appliance 6304 and the switch 6336 is in the on mode, power from the installed batteries (6326 or 6328, whichever is installed) is supplied to a set of LEDs 6340 in series with a set of resistors 6342 through the switch 6336.

When the portable lighting appliance 6304 is installed in the fixed appliance 6302, the switch 6310 of the fixed appliance 6302 may control the portable lighting appliance 6304. In one example, when the switch is in the HI mode, the converted power is routed to pin 1 of both of the connectors 6308, and the light source 6222 of both installed portable lighting appliances 6204 is illuminated. In LO mode, the converted power is routed to pin 1 of one of the connectors 6308, and the corresponding light source 6222 is illuminated. In auto mode, the converted power is routed through a LED 6312 in series with a resistor 6314. In one example, the LED 6312 is used to indicate when the appliance 6200 is in auto mode.

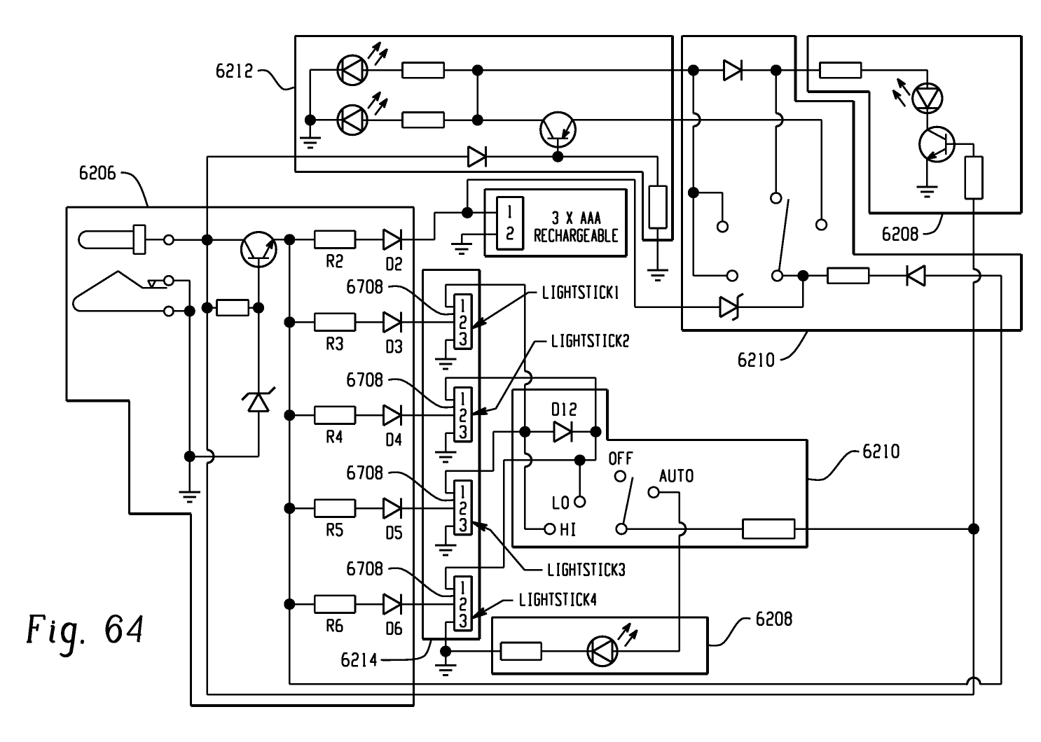

FIG. 64 depicts a circuit diagram for a lighting appliance 6400 that is substantially similar to the lighting appliance 6300. As such, the differences between the lighting appliances 6300 and 6400 are discussed next. Whereas the fixed base of the lighting appliance 6300 included two connectors 6308, the fixed based of the lighting appliance 6400 includes four connectors 6308. As such, four portable lighting appliances 6204 may be inserted into the lighting appliance 6400 at any given time. In other examples, the lighting appliance may be configured to receive one, three, or more than four portable lighting appliances 6204. In this example, when the switch is in the HI mode, the light source 6222 for all installed portable lighting appliances 6204 is illuminated. In LO mode, a subset such as one or two or three of the light sources 622 for corresponding portable lighting appliances 6204 are illuminated.

For illustrative purposes, an example operation of the motion light 6000 is described with reference to Tables 10, 11, and 12.

TABLE 10
Fixed Appliance

| External Power | Present | | | |
|---|---|---|---|---|
| Mode | Off | On | Auto | Night |
| Status Indicator | Power | | Mode | |
| Secondary battery(s) | Charging | | | |
| Night Light | Off | On | Off | On |

Portable Lighting Appliance(s)

| Secondary battery(s) | Charging | | | |
|---|---|---|---|---|
| Primary battery(s) | X | | | |
| Area/Spot and Area Light | Off/Off | On/Area | Off/Off | On/Area |

Table 10 depicts operation of the hybrid battery powered lighting appliance 6200 when external power is available. From Table 10, received external power is used to charge the secondary battery(s) installed in the fixed appliance 6202. If a secondary battery(s) is installed in the portable lighting appliance(s) 6204, then the received external power is also used to charge the secondary battery(s) installed in the portable lighting appliance(s) 6204. When the fixed appliance 6202 is off or in auto mode, the night light X and the light source(s) of the portable lighting appliance(s) X are off. When the fixed appliance X is on or in night mode, the night light on and the light source(s) of the portable lighting appliance(s) X are on. If an inserted portable lighting appliance X includes a spot light and an area light, only the area light is turned on. When the fixed appliance X is off or on, the status indicator X indicates that power is available. When the fixed appliance X is in auto or night mode, the status indicator X indicates that the fixed appliance X is in one of these modes.

TABLE 11
Fixed Appliance

| External Power | Absent | | | |
|---|---|---|---|---|
| Mode | Off | On | Auto | Night |
| Status Indicator | Inactive | | | |
| Secondary battery(s) | Inactive | Discharging | | |
| Night Light | Off | On | On | On |

Portable Lighting Appliance(s)

| Secondary battery(s) | Inactive | Discharging | Inactive | |
|---|---|---|---|---|
| Primary battery(s) | X | | | |
| Area/Spot Light and | Off/Off | On/Area | Off/Off | On/Area |
| Area Light | | | | |

Table 11 depicts operation of the hybrid battery powered lighting appliance 6200 when external power is unavailable. From Table 11, when the fixed appliance X is off, the night light X and the light source(s) of the portable lighting appliance(s) X are off, and the secondary batteries are inactive. When the fixed appliance X is on, in auto mode, or in night mode, the night light and the light source(s) of the portable lighting appliance(s) X are on. In auto mode, the night light X is also on. When any of the lights are on, the corresponding secondary battery(s) powers the light.

TABLE 12
Portable Lighting Appliance
Spot light only

| | | |
|---|---|---|
| Mode | Off | On |
| Battery(s) | Inactive | Discharging |
| Area Light | Off | On |

Spot and Area light

| | | | |
|---|---|---|---|
| Mode | Off | Spot | Area |
| Battery(s) | Inactive | Discharging | Discharging |
| Spot Light | Off | On | Off |
| Area Light | Off | Off | On |

Table 12 depicts operation of the portable lighting appliance X removed from the fixed appliance X of the hybrid battery powered lighting appliance 6200. From Table 12, when the portable lighting appliance has an area light and the mode of operation is set to off, the installed battery(s) is inactive and the light source is off. When the mode is set to on, the installed battery(s) is used to illuminate the light source. When the portable lighting appliance also has a spot light and the mode of operation is set to off, the installed battery(s) is inactive and the spot and area lights are off. When the mode is set to spot light, the installed battery(s) is used to illuminate the spot light source, and when the mode is set to area light, the installed battery(s) is used to illuminate the area light source.

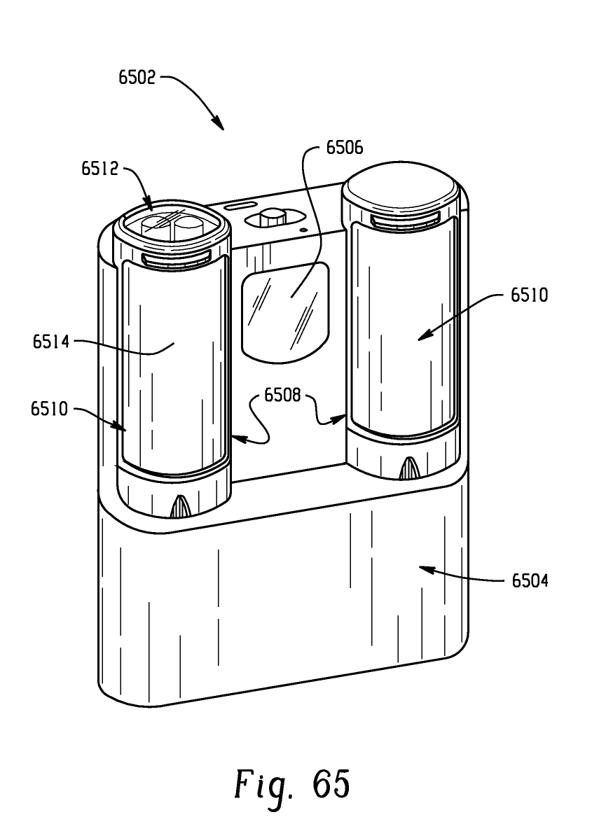

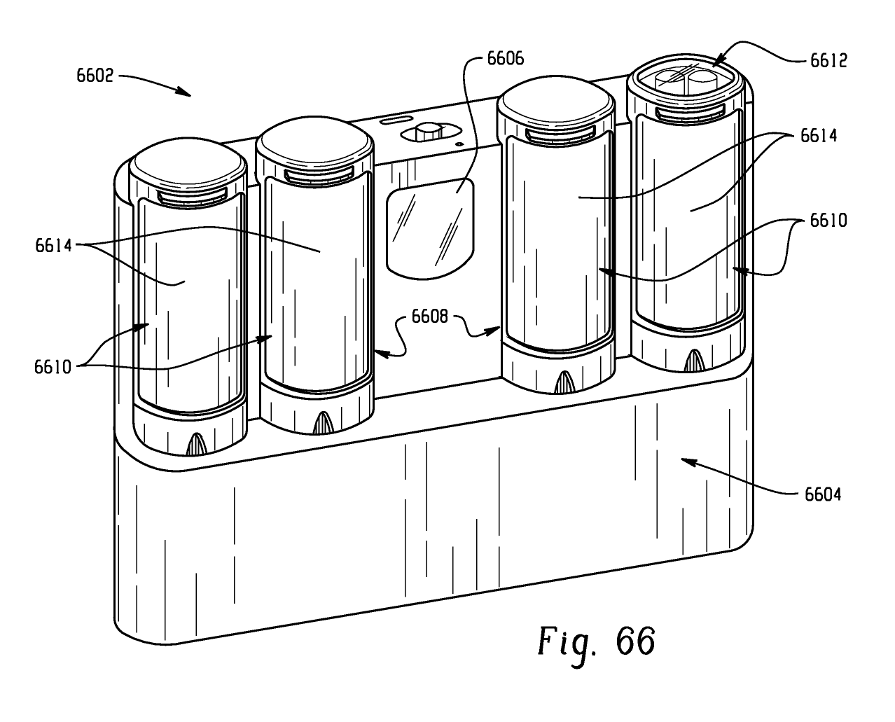

As noted above, the hybrid battery-powered lighting appliance 6200 is substantially as described above in connection with the fixed appliances 2202 and 2600. FIGS. 65 and 66 further illustrate exemplary embodiments of the hybrid battery powered lighting appliance 6200. FIG. 65 shows a two-port hybrid battery powered lighting appliance 6502 and FIG. 66 shows a four-port hybrid battery powered lighting appliance 6602. As illustrated, fixed appliances 6504 and 6604 are configured so that battery backed night lights 6506 and 6606 are between portable lighting appliance receiving regions 6508 and 6608. In additions, each of the hybrid battery powered lighting appliances 6502 and 6602 includes a portable lighting appliance 6510 and 6610 that includes a spot light 6512 and 6610 and an area light 6514 and 6614. The feet shown with fixed appliances 2202 and 2600 have also been omitted.

Various auxiliary appliances are contemplated. For example, the auxiliary appliance may include radios, battery chargers, clocks, powered USB ports, desired domestic or other appliances, and the like.

It is to be appreciated that the lighting appliance described herein can also be used in a motorized vehicle such as a car, a boat, a RV, and the like. For instance, the lighting appliance can be used in connection with a glove compartment light. In this instance, the glove compartment light includes a battery backed light source and a secondary battery. The vehicle's battery provides power for charging the secondary battery and illuminating the light source. The secondary battery powers the light source of the glove compartment light when the vehicle's battery is unable to provide such power. This includes situations in which the vehicle's battery no longer holds a suitable charge or is removed from the vehicle and/or when the glove compartment light is configured as a removable light source and is removed from its holder, and/or in other situations.

The invention has been described with reference to the preferred embodiments. Of course, modifications and alterations will occur to others upon reading and understanding the preceding description. It is intended that the invention be construed as including all such modifications and alterations insofar as they come within the scope of the appended claims.

What is claimed is:

1. A lighting appliance, comprising:
a first electrical contact that receives external power;
a first electrical socket that provides access to the received external power;
an electrical contact support component for configuring the orientation of the first electrical contact with respect to the first electrical socket and connecting the first electrical contact and the first electrical socket;
a portable lighting appliance receiving region for receiving and providing power to a received portable lighting appliance; and
an interface that receives an input indicative of a first operation of the received portable lighting device when the power is available and a second operation of a received portable lighting device when the power is unavailable.

2. The lighting appliance of claim 1, wherein the first electrical contact is an electrical plug having a ground contact, a neutral contact, and a hot contact, and wherein the electrical contact support component is configurable with respect to the lighting apparatus between a first position in which the ground contact is positioned above the neutral and hot contacts and a second position in which the ground contact is positioned below the neutral and hot contacts;
wherein the first electrical socket is an electrical outlet having a ground socket, a neutral socket, and a hot socket, and wherein the ground, neutral, and hot sockets respectively receive power from the ground, neutral, and hot contacts when the electrical contact support component is in either the first or the second position; and wherein the neutral contact and the hot contact each have a perpendicularly extending end portion that offsets the neutral and hot contacts to map the electrical contacts in a first output configuration when the ground contact is positioned above the neutral and hot contacts and to a second output configuration when the ground contact is positioned below the neutral and hot contacts.

3. The lighting appliance of claim 1, further including a third electrical contact, wherein the third electrical contact receives second external power from a second external power sources.

4. The lighting appliance of claim 3, further including a fourth electrical contact that provides access to the received second external power.

5. The lighting appliance of claim 1, wherein the received portable lighting appliance includes:
a first light source used to produce an area light;
a second light source used to produce a spot light; and
a interface for receiving an input for transitioning the lighting apparatus between an area light mode, a spot light mode, and off mode.

6. The lighting appliance of claim 5, wherein the portable light receiving region provides an input to the interface that places the portable lighting appliance in the off mode when the portable lighting appliance is inserted into the portable light receiving region.

7. The lighting appliance of claim 1, wherein the first desired operation includes charging an inserted portable lighting appliance.

8. The lighting appliance of claim 1, wherein the second desired operation includes turning on an inserted portable lighting appliance.

9. The lighting appliance of claim 1, further including an environmental sensor that senses a state of the environment, wherein the second desired operation includes turning on an inserted portable lighting appliance based on the state of the environment.

10. The lighting appliance of claim 1, wherein the second desired operation includes turning on an inserted portable lighting appliance when external power is unavailable.

11. The lighting appliance of claim 1, further including battery charging circuitry for charging a rechargeable battery installed in a portable lighting appliance (5206) inserted into the portable lighting appliance receiving region.

12. The lighting appliance of claim 1, further including an indicator that indicates a mode of operation of the fixed appliance.

13. The lighting appliance of claim 1, further including a second electrical contact, wherein the orientation of the first and second electrical contacts are independently configurable.

14. The lighting appliance of claim 1, further including a controllable switching circuit that selectively controls a pathway between the first electrical contact and the first electrical socket.

15. A method, comprising:
receiving power from an external power source;
providing access to the received external power to an external device, wherein the orientation of a first contact used to receive the external power is configurable with respect to the external power source;
using the received power to charge and power a portable lighting appliance;
operating a light source of the portable lighting apparatus using the external power; and
using internal power local to the portable lighting apparatus to operate the light source when the external power becomes unavailable.

16. The method of claim 15, further including sensing a state of the environment and operating the light source of the portable lighting apparatus based on the state of the environment.

17. The method of claim 15, wherein the contact is configurable for insertion into an AC receptacle oriented such that a ground socket is at a top of the receptacle.

18. The method of claim 15, wherein the contact is configurable for insertion into an AC receptacle oriented such that a ground socket is at a bottom of the receptacle.

19. The method of claim 15, furthering including receiving external power from different electrical circuits and concurrently providing access to the external power from both circuits.

20. The method of claim 16, furthering a second contact for receiving power from the second circuit, wherein the orientation of the first and second contacts are independently configurable.
